(19) United States
(12) Patent Application Publication
(10) Pub. No.: US 2004/0235542 A1
(43) Pub. Date: Nov. 25, 2004

(54) Pari-mutuel terminal wagering system and process

(76) Inventors: Andrew Stronach, Aurora (CA); John Jay Richard O'Neal, Welland (CA); Mark A. Litman, Edina, MN (US)

Correspondence Address: Mark A. Litman & Associates, P.A., York Business Center, Suite 205, 3209 West 76th St., Edina, MN, 55435, US

(21) Appl. No.: 10/761,799

(22) Filed: Jan. 21, 2004

Related U.S. Application Data
(60) Provisional application No. 60/441,714, filed on Jan. 21, 2003.

(30) Foreign Application Priority Data
Nov. 30, 2002 (WO) PCT/CA02/01832
May 1, 2000 (WO) PCT/CA00/00443

(51) Int. Cl. G06F 17/00; G06F 19/00

(52) U.S. Cl. 463/6

(57) ABSTRACT

A wagering terminal that also allows for account set-up has a display, a reader to accept account wagering applications, a user interface to capture user input and user identification, and a processor to process the identification, user input and account set-up. The terminal may communicate directly with wagering pools for entry into the pools and facilitates wagering on race events by providing and even analyzing race event information. A rotating slot-type image format can supply information on actual race contestants wagered upon and symbols can be used to identify multiple contestant wagering events.

### RELATED APPLICATIONS

This application claims priority from PCT Application No. PCT CA02/01832 filed Nov. 30, 2002, which in turn claims priority from U.S. application Ser. No. 09/997,288, filed Nov. 30, 2001, the entire disclosure of which is hereby incorporated by reference into this application as if set forth fully herein. U.S. application Ser. No. 09/997,288 filed Nov. 30, 2001, is a continuation-in-part of PCT Application No. PCT/CA 00/00443 filed May 1, 2000, which claims the benefit of U.S. Provisional App. No. 60/131,806 filed Apr. 30, 1999.

### BACKGROUND OF THE INVENTION

1. Field of the Invention

The present invention relates to the field of pari-mutuel wagering, pari-mutuel wagering through terminals, pari-mutuel wagering through terminals that give an appearance of being slot-type or video wagering systems, wagering systems that use private or commingled wagering pools, wagering systems that enable partial or split wagers, and systems for the automatic selection of race locations, race events, and race contestants.

2. Background of the Art

The sport of racing is one of the oldest engaged in by humans, and racing events were one of the first sports on which wagers were placed. Racing events now take place in such a wide diversity of formats as horse racing (including harness racing and derbies), dog racing, vehicle racing, and the like. Horse racing (in its three primary forms of conventional track racing, harness racing and derbies) and dog racing are today the primary wagering vehicles for races. Although the history of racing has been almost legendary, with jockeys and animals of nearly legendary proportions, a number of factors have caused the sport to diminish in recent years. There are numerous reasons for these changes.

Race wagering has much greater competition available to it. There are lotteries that are common in many States and countries, and the ease of purchasing lottery tickets is quite attractive. Gambling is available in many more forms and locations because of the expansion of casino gambling, card clubs, reservation gambling, and internet wagering. Additionally, race wagering can be fairly complex, with the ability to decipher race wagering forms, analysis and handicap data, and selecting from among the many different wagers available. For example, as opposed to the traditional Win, Place and Show wagers, Exacta wagers, Perfecta wagers, Trifecta wagers, Quinella wagers, Pick-Five and Pick-Six wagers (among those available) require much more significant knowledge and ability to place and on which to make decisions. Although some of these wagers have been successful in increasing the size of possible awards, these more exotic wagers require more analytic skill, or at least give the appearance of requiring greater skill. As the learning process for attaining a high level of comfort with horse wagering can be much greater then that for conventional casino wagering and even as compared to many table games, new wagering customers have been more quickly attracted to the newer and apparently more accessible than race wagering.

The Racing industry has contributed to its own limitation in growth because of internal competition for a smaller market and the excessive control exercised by a few of the more popular institutions and race tracks. Even with simulcasting, tracks must work diligently to “sell” their races into the system. The larger and better known tracks with larger race fields have a significant advantage in selling their races into the system because of their well known names and the greater comfort level players may have in wagering on races at established and well known tracks throughout the U.S. and Canada and elsewhere throughout the world. The larger racetracks have been able to package their signals together to provide in essence a portfolio of race events on a regular basis. As the rate of base placement has its own established rhythm with most players, the use of such packages from established tracks can also provide races at an acceptable frequency, without overloading the player.

It has become desirable to create a crossover function between conventional race wagering, particularly race wagering at tracks and simulcasting and more modern casino-style wagering. At present, there has been no successful commercial introduction of any crossover technology. The most successful effort to stimulate attendance at race tracks has been the establishment of “racinos” or casino-type facilities at race tracks. Some of these facilities may be restricted by local regulations and statutes as to the type of games that may be played (e.g., Canterbury Downs in Prior Lake, Minn. is allowed poker games and other table card games, but has not been allowed to place reel slots or video wagering games by State Law). These racinos do not necessarily add money to pari-mutuel pools or add directly to race attendance, but tend to provide a different audience to a different area of the facility. Horse racing players attend the race track and casino players attend the racino portion of the facility. The additional revenues are beneficial to the facility and to local authorities, but do not necessarily and directly add revenue to the racing system. This is why some form of crossover technology is highly desirable.

Another series of problems with the racing industry revolves around the issues of the physical restraints on a player having to not only watch the race, but also deal with “dead time” between races. The fact that races are run only every fifteen minutes or so at a track, and that such dead time may be present even when multiple tracks are accessed by simulcasting, creates not only a dead time for the player if bets have been predetermined by earlier handicapping work, but more importantly to the track facility, creates a dead time in wagering. These events may be exacerbated when there is waiting for official results to be posted which can vary depending upon whether a more precise picture of the finish line is required in order to determine which horse either won, placed, showed or finished fourth. Where two or more race contestants finished very close together and the photo finish stewards require a more exact photo in order to determine the order of the finish. Once the official order of finish is determined, more “dead time” is added through the racing stewards reviewing the race via a recorded replay system. If the stewards find no altercations or fraudulent actions in the race, the race is determined as official. If a racing altercation or fraudulent act is committed in the race, an inquiry sign is posted which can result in more “dead time” between races due to more investigations of the race via the recorded race tape. Once the tape has been more extensively reviewed, the stewards will either post the race officially or alter the order of finish by disqualifying horses by “moving them down” and “moving up” the horses next in line according to the official order of finish. After the procedures as just mentioned above, are executed, the race is then official. Another source of “dead time” between races is the lack of product available in a continental or geographical market where no double bouncing of signals between geographical markets is done since it is cost prohibitive to do this on wagers where the racetrack management is only roughly receiving 7% of every betting dollar after the deduction of state taxes, H.B.P.A. fees, etc.

Also, many racetracks do not want to buy extra decoders, in order to downlink the satellite feed into an earth station. For instance take 100 racetracks that have conflicting post times within 20 minutes, the racetrack or O.T.B. would require a decoder for each simulcast signal which would require a capital investment of 100 decoders versus 40 decoders that are used today in a typical O.T.B. or racetrack which is cost prohibitive.

Since the double bouncing of intercontinental satellite signals is cost prohibitive, each geographical satellite market can only use whatever racetrack simulcast signals are available that do not require double bouncing in order for decoder to downlink the signal into an earth station, such as a racetrack or O.T.B. (off track betting) location. For example, a racetrack located in the U.S. could only use racetrack simulcast signals from Canada, Mexico and the U.S. Since Asian, European, Australian, and South American simulcast product (and additional national origin product) requires double bouncing of the simulcast signal in order to view the race. This is unfortunate for a player that would like to wager on races worldwide. The more races a player has to choose from, the more likely his total play will increase due to the fact that the player can sort through various races and choose the races that fit his psychological profile. For example, the player might like races where there are race contestants in the race that never ran on the grass or turf before and were trying this surface for the first time instead of running on a dirt course. The more races carried on the simulcast menu or agenda, the more likelihood of finding such a race with race contestants containing the handicapping variables to produce a handicapping angle. Studies in simulcasting have shown that more race events that are broadcast, the more the total handle will increase. Very rarely will the provision of smaller numbers of races lead to more handle unless the fewer races taken are of extreme quality such as the Kentucky Derby or Breeders Cup races, whereby a limited race event card is featured in order to spotlight these featured events. However, such featured race events are not an every day occurrence and on less featured race days greater numbers of lesser quality races are required in order to increase handle and speed of play in between races.

By having worldwide simulcast through a special network that does not have high communication costs associated with the network (the network will be explained in greater detail later on), the system decreases dead time between the races especially in certain time zones. For example, at 12 midnight on the west coast of North America (Pacific time zone) there are no North American races to be shown due to lack of availability. In this situation, it is 3 a.m. in the Eastern Time zone, 2 a.m. in the Central Time zone, 1 a.m. in the Mountain Time zone. It would be beneficial to show Australian and Asian races to fill the void in the simulcast agenda or menu such it is day time or afternoon time in these jurisdictions which is an ideal time to race. However, today's simulcast procedures are too cost prohibitive to import these races and networks, therefore, it would be ideal to have a new procedure and network in order to have worldwide simulcast. The capital costs of pari-mutuel wagering racetracks are hard to cover with a race on average every (1440 min at 400 races per day) four to five minute versus slot machines where one can play every four to five seconds. Therefore, it would be ideal to have a network or system that had no “dead time” and one could play every four to five seconds to increase the throughput of races and dollars through the wagering terminals and in turn increasing gross margins to cover the extra costs. (Grandstand barns, racetrack oval, stables, wagering terminals, etc.) For example, a retail store that sells an item every four to five seconds would have higher sales than a store that sold the same item every four to five minutes. Today, the world is a faster-paced society or more impulsive society, whereby the player does not want to wait 20 minutes between races or even five minutes between races because the player may only have two hours leisure time after work whereby five minutes between races would only result to 12 races an hour. Most players today like to make a $1 superfecta wager for a large payoff every four to five seconds just like the speed of play like a standard slot machine whereby a superfecta represents a jackpot payoff or the highest paying prize on a paytable.

If a pari-mutuel race contestant player were to increase the total play by wagering on 1000 races versus 50 races whereby 1000 races could represent similar play of 1000 spins on a slot machine, in order to achieve this certain procedures of pari-mutuel race contestant wagering must change such as having the pari-mutuel race contestant terminal setting to the next race in the simulcast menu via a race event selector and not making the player choose an abbreviated track code, since searching through 100 track codes would involve scrolling through a directory and the player would not know which the next race was even though post times were shown, due to the inaccuracy of estimated post times whereby a race event selector would update post times and could also manually override the pari-mutuel betting terminal interface to the most current or next race available in the simulcast program.

Another feature that would be beneficial to a pari-mutuel race contestant terminal that requires worldwide simulcast via 500 track codes or 5000 races would be to have a pari-mutuel race contestant terminal that did not print tickets in order to reduce paper costs and the time required to process winning tickets. For example, to check 5000 tickets for 500 racetracks over the course of the day would pre-occupy a pari-mutuel race contestant terminal by players cashing tickets via a voucher reader or would require increase in tellers or clerks to manually cash these tickets. A “slot” machine does not require a ticket to be processed for every play or spin since a slot player can immediately compare results of a payline against a paytable above the machine. Therefore in order for a pari-mutuel race contestant terminal to compete with a slot machine “dead time” between races must be eliminated, also a payline with a corresponding paytable must be implemented in the pari-mutuel race contestant terminal whereby pari-mutuel race event tickets that contained race number race contestants, amount of wager, bet type track code would be eliminated. By eliminating dead time through increased amount of race track events (for example, 5000 races versus 500 races and using “dead time” to rebate players whereby the player is incentivized and honoured via a loyalty program that is key to customer branding and customer retention in many slot machines player and programs today such as used by Harrah's entertainment. A pari-mutuel race contestant terminal must also be able to debit and credit a win meter or credit meter immediately whereby the player does not have to leave the pari-mutuel race contestant terminal to allow other pari-mutuel race contestant players to play such as walk-up units used today in many racetracks and O.T.B. ” whereby no chair is stationed in front of the pari-mutuel race contestant terminal. Every time there is a player “changeover” a player must insert credits or players card and pin number versus a stationed player who can continuously play and does not have to re-orientate himself such as a player who uses a walk-up unit repeatedly. Therefore, a stationery unit would have more throughput due to less user interface functions and player changeovers than a multi-user walk-up unit whereby players shared a terminal by logging in and out. However, a walk-up unit does not make sense where there is too much dead time between races whereby players want to walk up to the unit and make a wager and not wait at a unit while there is dead time between races is over, nor do they want multiple tickets on the same race event since this form of betting tends to automatically eliminate tickets where there can be only one winner. For example, by choosing every horse to win in a five horse field the player will most likely lose since a, for example, 18% win takeout is applied to each race contestant whereby an extreme longshot must win in order to cover the takeout rate. In this example, the takeout rate and the investment in losing tickets (There will be four losing tickets, five ticket—one winning tickets=4 losing tickets) is eating away the pari-mutuel gain of the winning ticket. In other words, the player is shooting himself in the foot or betting against himself, but he does this in order to bypass the boring, non action dead time between races. Dead time between races can also make a player wager on races that have short fields, unbalanced pools where a player's selected race contestant are over bet thereby providing no value for the player versus the risk, and races where there is no handicapping angle that suits the psychological profile of the respective player. However, if there is 10 minutes dead time between races, the player would rather play more wagers on the same race event since there is no immediate future races or no “rebate mode” to pre-occupy or entertain the player, so the player either chooses races that have no value or makes multiple bets that cannibilizes him or her.

U.S. Pat. Nos. 5,830,068; 6,004,211; 6,089,981; and 6,099,409 describe terminals and systems for placing wagers on racing events, particularly through the internet or other on-line connections. These patents do not appear to disclose any novel hardware or software, but provide a system that provides direct connection to a source of racing data and other racing information, live video of the race on which you a player is wagering, and enables the player to place wagers at many different tracks throughout the world. The system of these patents fundamentally sets up a networked system that allows a player to do essentially everything at a terminal that one could do at a race track betting booth (except possibly look at the horse up close). The system provides ways of accessing horse data (e.g., past race results, handicap weight, etc.), totalisator information, odds, jockey information, weather conditions, etc.). After collecting and reviewing that information, the player then places a wager which is added to the wagering pool. This is a relatively convenient concept that enables only distal wagering. The racing industry requires greater player-friendly access that enables newer players to enter the racing system, without requiring years of study or learning the complex nuances of handicapping and form reading and use.

### SUMMARY OF THE INVENTION

The present invention relates to a complete system for entry into commingling pari-mutuel pools or providing private pari-mutuel pools for race events, providing software and hardware for such systems, providing novel bet entry structures for pari-mutuel wagering, novel gaming apparatus that enables entry into the pari-mutuel pools, and other related and enabling technology for entry into the novel system. The complete system may be provided in structural modules that may be transported from location to location and readily connected to provide a complete wagering facility that need be connected with only the race provider systems.

### BRIEF DESCRIPTION OF THE DRAWINGS

Embodiments of the invention will now be described, by way of example only, with reference to the drawings, in which:

FIG. 1 is a schematic view of the wagering network, according to an embodiment of the present invention;

FIG. 2 is a schematic diagram of the race providing system, according to an embodiment of the present invention, shown in FIG. 1;

FIG. 3 is a schematic diagram of the at least one wagering terminal, according to an embodiment of the present invention, shown in FIG. 1;

FIG. 4 is a perspective view of the stand-up type at least one wagering terminal, according to an embodiment of the present invention, shown in FIGS. 1 and 3;

FIG. 5 is a perspective view of the tabletop type at least one wagering terminal, according to another embodiment of the present invention, shown in FIGS. 1 and 3;

FIG. 6 is an example screenshot of the information presented on a display of the stand-up type at least one wagering terminal, according to an embodiment of the present invention, shown in FIGS. 1, 3 and 4;

FIG. 7 is an example screenshot of the information presented on a display of the tabletop type at least one wagering terminal, according to an embodiment of the present invention, shown in FIGS. 1, 3 and 5;

FIG. 8 is a payout table for a “Win” wager type of an at least one wagering terminal, according to an embodiment of the present invention;

FIGS. 9(a), 9(b), 97(c) and 9(d) comprise a flow chart of the wagering facilitated by the wagering system, according to an embodiment of the present invention;

FIG. 10 is another example screenshot of the information presented on a display of the tabletop type at least one wagering terminal, according to an embodiment of the present invention, shown in FIGS. 1, 3 and 5;

FIG. 11 is a schematic diagram of an account wagering clearing service according to an embodiment of the present invention in relation to other aspects of a wagering system, including a VPN concentrator, wagering terminals, other race providing systems, and other account wagering suppliers;

FIG. 12 is an example payout table of a win wager including a single bonus pick according to at least one embodiment of the present invention;

FIG. 13 is an example payout table of a win wager including two bonus picks according to at least one embodiment of the present invention;

FIG. 14 is an example payout table of a win wager including three bonus picks according to at least one embodiment of the present invention;

FIG. 15 is an example payout table of a win wager including four bonus picks according to at least one embodiment of the present invention;

FIG. 16 is an example payout table of an exacta wager including two bonus picks according to at least one embodiment of the present invention;

FIG. 17 is an example payout table of a trifecta wager including two bonus picks according to at least one embodiment of the present invention;

FIG. 18 is an example payout table of a superfecta wager including four bonus picks according to at least one embodiment of the present invention;

FIG. 19 is an example ticket showing a code name according to an embodiment of he present invention;

FIG. 20 is an example results board scrolling and flashing code names of winners and amounts won according to an embodiment of the present invention;

FIG. 21 is a schematic diagram of a wagering account/card set-up kiosk according to an embodiment of the present invention; and

FIG. 22 is a schematic diagram of a VPN concentrator according to an embodiment of the present invention.

FIG. 23 is an example payout table for a multi-wager type machine where by the wager processor selects the Race, Bet type and wager type with a Bonus Game representing 6 levels with variable prizes for each level according to at least one embodiment of the present invention.

FIG. 24 is an example screenshot of the Show Machine embodiment of the present invention where by the Race Selector and Wager Processor determines the Race, and Wager type.

FIG. 25 is an example screenshot of at least one embodiment of the present invention where by the player can select the bet type by using the Change Game button.

FIG. 26 is an example screenshot of at least one embodiment of the present invention where by the player can select the Race and Bet Type.

FIG. 27 is an example screenshot of at least one embodiment of the present invention where by the player can select the Race and Bet type similar to FIG. 26 but does not contain extra themed icons and has an expanded Change game feature to go directly to the Bet type instead of scrolling.

FIG. 28 is an example screenshot of at least one embodiment of the current invention where by all betting terminology is removed from the user interface and the Race Selector and Wager Processor are configured to select the Race, Wager, and runners for any given race.

FIG. 29 is an example ticket layout related to FIG. 28 embodiment of the current invention which describes the wager in common English with minimal wagering terminology.

FIG. 30 is an example results layout which relates to FIG. 28 embodiment of the current invention where by the results are displayed in a simplistic manner.

FIG. 31 shows a mobile module of a trailer that contains terminal units that can be used for pari-mutuel wagering upon communication connection to a race provider or other race information source.

### DETAILED DESCRIPTION OF THE INVENTION

The systems of the present invention provide terminals, stationary devices that may look like a console, upright gaming apparatus, video gaming table or gaming apparatus, keyboard-monitor combination, or any other physical structure that enables electronic communication with a race provider and either contains or connects to intelligence that can drive the system. The underlying concept of the system is that the terminal can be used to place wagers on racing events, and preferably provide a visual format that gives the appearance of gaming equipment (has the appearance of a video gaming machine, reel-type slot machine, poker machine, or other gaming device that indicates winning play by the provision of symbols or images that are related to wins or awards).

The pari-mutuel system, which will be described in greater detail herein, can be provided at conventional casinos (with information connection to race events), at equipments set up at race tracks, or at mobile facilities that can be transported to various sites (Fairs, carnivals, events such as trade shows or conferences) and readily set up and then taken down at the end of the event or the end of the season. For example, modules such as mobile vans, mobile trailers or the like may be fitted with the terminal equipments, the modules may have electronic fittings and physical structure to assist in interconnection of the modules and enabling a temporary mobile unit to be constructed, the interconnected modules being capable of being communicatively connected to a server, hub, or system that provides race events (the connection being by phone lines, cables, optical network, wireless connection, radio connection, or any other form of communication connection). The mobile units (e.g., trailers or flatbed systems with wheels or carriages to enable long distance travel of the entire unit) may be moved from storage or a location where they have been used, interconnected to form a structure, the communication connection established, and the pari-mutuel system is immediately operative. As the security for the system is built into the server or hardware, the seemingly temporary and rapid setup still provides great system security.

Of significant importance in the mobility is the fact that when the system has been placed in a wagering jurisdiction, the local authorities will have less ability to alter underlying relations and governmental-business interests in the operation. When hard and permanent structures are constructed for gaming establishments, there has been significant capital investment by the operators, with some facilities costing over 100 millions dollars (US$100,000,000). After the system has been in operation, profitability established, and the financial operation monitored by local authority, it has become too common for local governments to desire a renegotiation of the original licensing provisions as greater revenues are desired by the government. Because the operation is fixed, the management of the wagering operation has little leverage and can be forced to meet the new demands or cease operations. By providing a completely mobile operation that costs less than one million dollars for 1000 terminals, the operators can literally pack-up and move if they are overly pressured by local authorities. Additionally, by not needed to build permanent structures, building permits may be avoided and other significant bureaucratic complications can be avoided. To that end, the present invention contemplates modular units having the physical support for at least 10 (ten) pari-mutuel wagering terminals and the physical hardware enabling communication with race event providers (e.g., tote systems, servers, hubs, networks) that can be accessed by the wagering terminals, the modular units being capable of being interconnected to form larger wagering establishments. It is preferable that the modules have openable segments on walls (e.g., door ways in trailers, or openings on frames on a flatbed system) that can be used to convey foot traffic between modules so that the completed and connected system of modules will have the appearance of a substantial structure. By having interconnecting modules, the effective size of the final constructed mobile system is essentially unlimited. Once local permits have been established (not necessarily requiring building permits, but rather only placement or use permits) the entire modular structure can be driven or delivered to a site and can be interconnected and running in less than 24 hours. This enables movement of the modular system between fairs, conventions, events, and gatherings so that the systems will not be idle during different times of the year where local racing activity may be reduced.

It is also contemplated that the terminals may also contain software for conventional reel-type wagering games, video wagering games, keno, blackjack, poker or other terminal wagering games for use in locations that allow such wagering.

A terminal (which may be a fixed terminal or a personal computer that accesses the system described herein) is used to engage in the practice of the invention. The system contains hardware and software that enables player to enter a race wagering system and place a wager easily and with minimum of required skill, while still providing the excitement of race wagering. The system allows players to either select their choices for races based on the information provided, or more importantly, allow the software to select a wager based on handicapping parameters and/or tote odds or wager odds. There are unique attributes of the system that provide unique capabilities that enhance the player's enjoyment and the game performance. These benefits are discussed below.

The system provides a function wherein the gaming system selects races at least on the basis of time availability of the race. Because the limitations at a track for wagering are primarily limited by the times between races, and because wandering across the list of tracks and races is time consuming, the number of potential wagers that can be placed from a distal source such as is envisoned and enabled in the practice of the present invention is potentially reduced by significant amounts. This reduces the number of wagers and thereby reduces the take by the tracks and intermediates. By providing automatic race selection of the reasonably soonest to be run or soon to be run races, and by enabling automated wagering (with automatic wagering including a) at a track, b) in a particular race, and optionally automatically c) in a particular pool, d) at a particular wager amount, and e) what runners to select), the speed of placing a wager is dramatically increased, the number of wagers/hour are multiplied, and the take by the track and/or intermediaries is significantly increased.

Specific machines for specific entry into the wagering system from a personal computer (PC) or off-track betting (OTB) system enabled to practice in the system of the invention may be designed or established to even further reduce time or player input/consideration required. That is, individual systems/machines may be enabled for specific pools, such as for only win pools, place pools, show pools, exactas, perfectas, trifectas, etc. as a preferred method, as explained in greater detail herein is the use of automatic selection of the wager, with as much of the wager components and wagering activity being automatically selected. By the wager components are included at least components selected from the group of track, race, pool (e.g., win, place, show, exacta, trifecta, superfecta, combination wagers, daily doubles, etc.), wager mount, runner(s), and the like. The wagering system may also enable the partial selection of a wager (e.g., track race and pool) and enable the system software to automatically complete the wager. Any number of the many wager elements may be selected (least preferably even 0 of the total wager components), and the system will automatically complete the wager, either by truly random selection or pseudo random selection, or by enabling actual handicapping software to select the remaining elements of the wager, or by partial random selection and partial handicapping selection. This could be effected, for example, by the player selecting the track and race from among choices provided by the wagering data source in the race wagering system, the software/hardware system randomly selecting the wager amount (within guidelines and limits for example) and pool, and then the system software handicapping the runner selection. The handicapping may also be influenced by information, software, algorithm or events beyond normal handicapping data, such as pool leveling, selection wagering style (conservative wagering, long-shot wagering, variable wagering, etc.). The handicapping may also be influenced by user input such as player desired tendencies, player instructions, player history, player entered profile, etc. For example, the player may limit wagers by limiting the range of wagers that may be placed on his/her behalf by instructions that wagers may be placed on individual racers with odds only inside the range of 1:1>odds>15:1, or any other player identified range of minimum odds and maximum odds on an individual racer. Combination wagers (e.g., exactas) may be similarly limited by player defined limiting ranges of odds on the total wager, the odds on the first (winning racer), the odds on the second racer (Place horse), or the odds on any individual racers in the combination wager. This player profile may be used in the software program to weight, influence or modify the automated selection process.

Because this is a complete system, additional style and function features may be added into the system. Some unique performance characteristics that have already been designed include, for example:

a) automatic arrangement and optionally display of odds and picks (e.g., a vertical or horizontal list from highest odds to lowest odds or lowest odds to highest odds {favorites to long shots]),

b) color-coding the odds, especially when arranged and displayed, so that players can see the odds in a color scheme both on the odds board and/or on images of the runners used to assist in or enable runner election. For example, the odds board may show the odds on rows that are, in order, red, white, blue, orange, pink, purple, green, etc. The odds would, by way of non-limiting example, be on the display red 5-7, white 2-1, blue 4-1, orange 6-1, pink 7-1, purple 9-1, green 12-1. Whatever the odds on a particular race, the same order of color would be used to display the order of the odds. As the odds shift during wagering, the colors on the odds of a particular runner may shift, but the order of the odds on the racers remain the same, from highest to lowest or lowest to highest. This enables players to select runners (e.g., horses, dogs, etc.) by their colors based on a player' inclination to select horses according to their odds or even by color preferences.

c) similarly to b), payouts can be simultaneously or later displayed in the reverse order of color scheme as the odds, as the potential payouts are relatively inverse in order to the odds, so the color scale will be reversed from the odds scale. This allows the players to maintain a semblance of cognizance about wagers.

d) the runner being wagered on may be shown in a series of rows and columns with representative images (not actual pictures or images of the horses, but symbolic representations of the racers, although the actual names of the runners may be present with the symbolic images to simplify user reading of the displayed material) of the runners, with the odds or payout colors shown associated with the images of the runners (e.g., the ‘color’ on the runner image re the colors of the odds arrangement, not the actual colors of the runner on the track). The original display of the images my be by runner number or randomly on the display, or alphabetically (by runner name or jockey name or stable name) or by any arrangement that is designed into the system. When the wagers are placed by the player or automatically selected or automatically completed by the software, the columns and rows spin (giving the appearance of reels on a reel-type video slot machine), the spinning stopping, and the selection(s) are positioned on a predefined position on the final display of the reels. For example, the winner wagered upon may be shown in column 1, row 1, or column 1, row 2 as a predetermined selection. If a trifecta were wagered upon, the three runners in the selection may be displayed as column 1, rows 1, 2 and 3; columns 1, 2 and 3 row 1; columns 2, 3 and 4 in row 1 or row 2, etc. The final display of the runners wagered upon may also and preferably highlight the runners wagered on, as by screen highlights, overlay of numbers on the runners (e.g., an image saying 1^{st}, 2^{nd} and 3^{rd} overlaying each of the runners wagered on in a trifecta, and any other visual indication of the actual runners that a wager has been placed. When an automatic select function has been made or elected, the ‘reels’ may spin until the decision is displayed. Also, the wheels or reels spin while the system is having its wager entered into a pari-mutuel pool to provide marginal entertainment time or indication or machine operation. Similarly, the winning runners or horses may be displayed on the same or separate ‘reels’ for comparison with the wager display or to follow the wager display.

e) It is important to be able to provide a workable system in the practice of the invention. To have a workable system, at least some of software, hardware, algorithms, displays, etc. must be provided to enable handicapping. The preferred system uses handicapping techniques that incorporate tote odds, pool odds, HCW, odds dropping, standard handicapping functions and parameters, singly or in combination. Alternative or additional; features, such as the player profiling indicated above, may also be used in the handicapping techniques. The preferred method combines tote odds and HCW information.

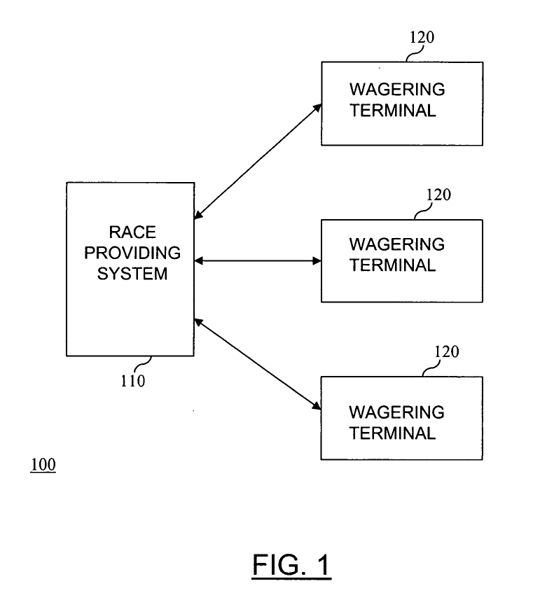

In an embodiment of the invention, referring to FIG. 1, a wagering network, denoted generally as 100, is shown comprising at least one wagering terminal 120 and a race providing system 110 in communication with the at least one wagering terminal. In an embodiment, the communications connection or network between the race providing system and the at least one wagering terminal comprises a closed connection or network. However, the communications connection or network may instead comprise an open connection or network, such as the Internet, if the open connection or network has sufficient bandwidth for adequately servicing the at least one wagering terminal. Additionally, security safeguards such as signatures, user identification requirements, encryption of signals and trails, hash values, pin numbers, passwords, and the like are desirable security attributes of various embodiments of the invention. Moreover, such a connection or network may be of any form including without limitation wire, cable or wireless or any further developed system. Each of these formats is merely a communication system for transmission of signals used in the practice of the invention.

A wagering account set-up facility, such as a booth, stand, kiosk, counter, tent, building or the like may be used [kiosk] to register and/or communicate with a wagering account holder. Non-limiting examples of the content of the facility include, but are not limited to:

a display identifying capability to accept one or more information requests to establish a wagering account (for example, a box with a question, an icon, voice stream, any image which conveys this information to a user);

an optical recognition character reader to read (including scanning and parsing) a wagering account application form;

a user interface and preferably a digitizing system to capture a signature of a holder of the wagering account and to capture input from the user in response to the one or more information requests on the display; and

a processor to process the wagering account holder's signature, the input and, where an application form has been submitted to the optical character recognition reader, information from the wagering account form and to set-up the wagering account. The account set-up facility is preferably a kiosk having a wagering card dispenser to issue a wagering card on the set-up wagering account.

A card reader may be provided to read a card that enables at least one interaction with the processor selected from the group consisting of identifying the wagering account holder and reading a card that can deposit value into the wagering account. The card reader may also or alternatively read a card that can deposit value into the wagering account. The system should provide a connection to a credit database to validate set-up of the wagering account. The processor should have hardware or software available that can instruct a wagering account set-up confirmation to be sent to the wagering account holder.

The invention also includes a wagering terminal in communication connection with a race providing system that facilitates wagering on race events and provides information regarding the race events. The wagering terminal may comprise, by way of non-limiting examples, a display to present information regarding selected race events; a user interface enabling a user to place a wager on an elected race event of selected race events displayed; a card reader to receive a card having information pertaining to a user account and to enable identification of available wager amounts for at least one or more wagers on the elected race event; at least one currency receiver or credit receiver to receive currency or credit, respectively, wherein currency or credit provided to the currency receiver or credit receiver may be deposited to the user account. There may also be a currency dispensing device to dispense currency and wherein currency dispensed is withdrawn from the user account. The wagering terminal may be in communication access to a race event selector to select race events, wherein the selected race events are next race events for wagering.

An alternative aspect of the present invention includes a wagering terminal in communication with a race providing system that facilitates wagering on race events and provides information regarding the race events. The terminal includes a race event selector to select next race events for wagering, the race event selector using an algorithm to select next race events by analyzing one or more factors from the group comprising estimated start of race event; estimated duration of race event; nature of the race event; actual start of the race event as affected by delays; spacing among other race events; and other attributes affecting the playability of particular races; a display to present information regarding the selected race events; a user interface by which a user may place a wager on an elected race event of the selected race events displayed; and a wagering value mechanism, such as a wagering value selector to provide a wager amount for the wager on the elected race event. The attributes of the wagering value selector are described in further detail herein, but may include random selection, handicapped selection, pool flattening selection (that is selection that attempts to minimize differences among the amounts of wagers and odds among each and all of the total possible selections), and combinations of these. The factors used in the selection of a particular race are weighted and can be adjusted automatically to configure selection of the next race event. The selector may be configured to enable either player selection of wagering amounts or automatic selection of wager amounts.

Another alternative aspect of the invention includes a wagering terminal in communication with a race providing system that facilitates wagering on race events and provides information regarding the race events. The terminal may comprise a display to present information regarding selected race events, the information including race contestant wagering information displayed according to a profile of a user of the wagering terminal; a user interface enabling placement of a wager on an elected race event of the selected race events displayed; and a wagering value selector to provide a wager amount for the wager on the elected race event. The profile may be a risk/reward profile and optionally the user can select the profile using a button/icon or other manual control on the wagering terminal through which a user may select a profile. Race contestant wagering information may be generated from matching handicapping data showing estimated probability of race contestants finishing in specific positions against current odds to find wagering opportunities. This is preferably accomplished according to at least one algorithm using the handicapping data and the current odds.

The user interface may display icons corresponding to race contestants in a race event and a color or other indicator of the icons represents the race contestant wagering information. This aspect has been further described according to other elements of the invention and will not be repeated here, except to note that colors may be uniform or in a uniform for all races or the colors may be rearranged for each race. The race contestant wagering information for a particular wager may comprise at least one of a specific wager, a race contestant selection and a wager amount selected in accordance with the user profile.

Another useful aspect of a wagering terminal in communication with one or more race providing systems that facilitates wagering on race events and provides information regarding the race events may comprise a display to present information regarding selected race events; a user interface to place a wager on an elected race event of the selected race events displayed; a wagering value mechanism to provide a wager amount for the wager on the elected race event; and a module, preferably a portable module providing a library of at least two protocols for accessing different API's for different tote-providers to support interoperability of the wagering terminal with more than one race providing systems. As is known in the art, each totalisator has at least one API (Application Program Interface) that is necessary to be communicated with or be bridged in order to interact with the programs and hardware of a host computer. Each totalisator system has its own API, and different functions within each totalisator (which may be a race information provider in the practice of this invention) may have separate API windows to traverse for communication. A module may be provided with the system of the invention that is embedded in a terminal or which may be connected (on line or physically) with a terminal or directly to the totalisator from a computer with terminal system functions according to the present invention which has the capability of communicating with different API's from different totalisators and different API windows within a single totalisator system to enable use of the practice of the invention. The system module may interrogate the distal API to determine which protocol or key to the API is needed for communication, or the user may select a specific protocol or key when the user is aware of the specific API to which communication is to be directed.

The module may define an application programming interface for the wagering that is facilitated by the wagering terminal and an application programming interface for the networking services of the race providing systems. The optionally portable module may be adapted to accept one or more plug-in modules, each defining the interoperability to a specific race providing system.

Another format of wagering terminal or another feature that can be incorporated into a wagering terminal in communication with a race providing system that facilitates wagering on race events and provides information regarding the race events may comprise a display to present information regarding selected race events; a processor in communication with the wagering terminal; a user interface to place a wager on an elected race event of the selected race events displayed; and a wagering value mechanism to provide a wager amount for the wager on the elected race event, wherein software executed by the processor requires a key phrase to be provided in association with the wager to limit access to wagering or credit accounts so as to protect the identity of a user that made the wager when winning wagers are disclosed. When the wager is a winning wager, a results board displays the key phrase associated with the wager or a results board displays a winning amount associated with the wager. Another alternative or additional feature would be where, if the wager was a winning wager, a bell or audio signal is activated at the end of a selected race event depending on at least one of a number of winning wagers played on the wagering terminal and an amount of money won on the wagering terminal.

A user interface for a wagering terminal for practice of certain aspects of the invention may comprise a spinning reel animation; selection system for selecting at least one race contestant in a race event; communicative connection to a race information provider that carries information of the at least one race contestant selected to the race information provider to enter a wager on the at least one selected contestant on a wager in the race event; and when the spinning reel animation is completed, a screen presenting the at least one race contestant in the race event selected for a wager. One or more race contestants may comprise one or more quick pick race contestants, as explained in greater detail elsewhere in the specification. For example, one or more race contestants may comprise one or more quick pick race contestants in which quick pick selection is based on handicap data, odds, pool leveling considerations, or literal even wager distribution. Pool leveling is a process that is used or occurs where wagering is heavily weighted towards a few or even one horse, and the odds on other horses are unreasonable. An automated program will distribute additional wagers on other horses (e.g., specially when including handicapping considerations of only the contestants with higher odds, thereby eliminating the wagering/odds/totalisator influence of an over-wagered contestant. This process may be automatically initiated when the distribution of odds in a pool or pools exceeds predefined conditions or ranges. For example, a look-up table or algorithm may be predefined where limits are established on the relative range of pool wagers, the range of odds, etc. It must be recalled that the automatic selection of wagers need not, and usually is not based solely upon selecting a winner in a race, but is aimed at creating a reasonable return on wagers and this may be performed by wagering on middle-odds and long-shot contestants.

Another aspect of the invention may be described as a wagering terminal in communication with a race providing system that facilitates wagering on race events and provides information regarding the race events, the terminal comprising a display to present information regarding selected race events; a user interface to place a wager on an elected race event of the selected race events displayed; a wagering value mechanism to provide a wager amount for the wager on the elected race event; and a wagering processor to provide one or more bonus picks in association with the wager. The wagering processor may provide bonus picks when a wager results in a predetermined event. For example, bonus payouts may be provided when any wager returns at least a 30:1, 40:1, or 50:1 payout. Any particular level (absolute amount, so as to stimulate higher dollar amount wagers) of return or rate of return on a wager may be used as the predetermined event. A preferred event is when the predetermined event comprises a payout equal to or in excess of a predetermined amount or predetermined rate.

The bonus pick is preferably an automatic selection of a race contestant from remaining race contestants in a race event not included in the wager or other bonus picks. Bonus picks may also initiate a progression (not progressive jackpot) of bonus events, wherein when a first bonus is won, a second bonus is then automatically entered (without risking previously won amounts). For example, each successive bonus presents higher odds for winning. The first bonus pick wager, for example might be a long-shot show wager, a second bonus may be a long-shot place wager, a third bonus may be a long-shot win wager, a fourth bonus may be an exacta or double, a fifth bonus may be a long-shot trifecta, etc., with the most difficult wager being the most difficult wager available from the races available in the order of play. Each bonus wager in the progression of events may be selected from successive events (e.g., different races), or to speed up the process, when the bonus round is entered, the selector system for the bonus will independently select all of the selections from a single race prior to the running of the race, and as each bonus is won, the next bonus is examined to see if the player has won. Preferably the selection of the race contestant for the bonus pick is random, although the randomness may be weighted, as by requiring all wagers to have in excess of certain odds for each wager type. For example, all show wagers to be selected must exceed 3:1, all place wagers must exceed 5:1, all win wagers must exceed 8:1, etc. Each wager in the progression must exceed the odds of the previous selection up to the final bonus selection. There may be a potential succession of at least 4 bonus events, at least 5 bonus events, at least 6 bonus events, at least 7 bonus events, and the like.

The wagering terminal may provide a pool out of which the bonus prize(s) for a winning bonus pick(s) is paid out may be funded by a one or more of a set aside of a percentage of wagering handle; an additional contribution by one or more race event tracks and a wager surcharge. The pool for the bonus event may be underwritten by an insurance policy to ensure that a bonus prize can be paid. A payout of a bonus prize for a winning bonus pick may be determined by one or more of a size of the entire bonus pool; straight odds of winning the bonus pick; an effective payout or odds of winning the wager; an actuarial determination of the bonus prize; and a pari-mutuel determination with a jackpot and reserve similar to a lottery system. Where ticket printing is used on the terminal, a separate ticket may be issued from a ticket for the wager, the separate ticket incorporating details of the wager and providing the one or more bonus picks.

The separate ticket may be provided with a bar code to track and facilitate payout of a bonus prize for a winning bonus pick. One or more bonus picks may be provided on a same ticket of the wager in association with which the one or more bonus picks are provided.

The Bonus Game in one embodiment may be configured to issue a bonus ticket if the player wins on a long shot wager i.e., 50:1. The player would then be issued a free ticket for the next available race and would then qualify for the next bonus level. If the player wins on that ticket, he/she moves up to the next bonus level (level 3) and will receive another ticket for an upcoming race. This process will continue as long as the player continues winning in the bonus event until the player reaches a maximum level, e.g., level 4, 5, 6 or 7 (or more or less), at which point the player qualifies to win a grand prize such as a car, vacation or cash. The above process can be described as a bonus game which adds an extra entertaining element to the game similar to Slot Machine bonus Games. Adding bonus features keeps the games fresh and exciting for the players. Casino industry publications such as IGWB (International Gaming and Wagering Business) have recently published articles on the movement by major Slot machines manufacturers to add Bonus Games to their traditional slot games. The goal is to award players for playing a particular game. The August 2002 edition of IGWB in “The Bonus Game” article contains testimony from industry experts on the effectiveness of bonus games and new ways to reward players. The horse racing industry is severely lacking in new ways to retain and reward players. The horse racing industry publication The Blood Horse Dec. 22, 2001 article “Improving the Experience of Racing” speaks to the issue of the horse racing industries inability to add new exciting elements for the players.

The wagering terminal may have both speakers and video monitors to display events and provide signals. A time for display of the audio or video of a next race event may be determined by estimating a run time of the next race event and adding extra time for delayed starts and slow race events.

The race providing system generally manages and processes various racing information, particularly wagering information associated with race events held at various race event tracks. An example race providing system is Amtote International, Inc.'s totalisator system which processes racing information from or related to not only race events at which Amtote provides wagering transaction services but also race events unassociated with Amtote but for which racing information is provided through the Amtote totalisator system (e.g., racing information from or related to simulcast race events, known as open events). The racing information that may be provided in accordance with the invention may include race event information, such as the names and start positions of the race contestants (e.g., horses, dogs) running (or competitors involved, Jai Lai, athletic events such as football, basketball, baseball, soccer, and the like) in each race event for which the race providing system has information, the distance of each such race event, the race event track name of each such race event, the start time of each such race event, etc. The racing information may also include odds information for each race contestant, betting pool information on the betting pool associated with each race event, handicapping information, such as the weather conditions, and the jockey name, race contestant age, win record, and number of days since the last race event for each race contestant, and/or race result information such as the race results at the end of each race event. The racing information may be any combination of the race event information, odds information, betting pool information, handicapping information, race result information and/or other information as needed for the effective operation of the at least one wagering terminal. Optionally, the racing information may also include audio and video data corresponding to some or all of the race events for which the race providing system has information. It is to be noted that even though this information may be available to the user by requested access to this information, the automatic selection system enabled in the present invention can access this information or parts of this information can be automatically accessed and used in the automatic handicapping function of the quick picking function of the invention. This use of actual handicapping data or information in the execution of an automatic pick or quick pick selection is significant. In existing off-track wagering systems, the selector for Quik Picks is believed to be only a random selection. The use of handicapping information in a quick-pick is itself an advance in the art. The quick picking function of the invention may also use pool balancing, pool equalization or pool smoothing functions and considerations in making quick pick selections. These balancing, equalization or smoothing function can influence the actual wager selected, even though the handicapping considerations are integral to certain selections.

The nature of handicapping is only minimally understood by the general public, and even by those presumed to be skilled in the art. The objective is more to balance the best statistical return on a wager, and not merely to select the runner (e.g., horse) that is most likely to win that particular wager. Rather an objective is to select runners that will, statistically, return the highest amount in the long-run based on the information available. For example, odds and probability of events must be considered at the same time. Even if there were a 60% chance (based on handicapping information) that a particular runner is likely to finish in the top three finishers, but the runner would pay only $2.10 to Show, it would be statistically preferred to make the wager on a runner that has only a 20% chance to finish in the top three finishers, if the pool presently shows a potential payout of $7.20 to Show. Given those values, the statistical return per wager would be $1.26 on the first runner and $1.44 on the second runner. Handicapping may also be influenced by player selection or program content to lean towards favorites, middle odds or long-shots wagers. This influence may be player selected or automatic, or varied automatically within the handicapping program.

Any race providing system is useful, with live feed or at least immediate feed (with minimal delay that does not compromise the wagering system) from the race providing system being preferred. In a typical race providing system, the racing information is generated internally within the race providing system and/or obtained from associated race event tracks and, if applicable, off-track betting locations/devices and other race providing systems (not shown in FIG. 1). Commercial information providing systems may be accessed, or a private information providing system constructed. A race providing system may also receive racing information from an information provider, unassociated with a particular race event track, supplying racing information (e.g., information services provided by Equibase Company LLC) (not shown in FIG. 1). Furthermore, the at least one wagering terminal provides racing information to the race providing system, particularly betting pool information. In an embodiment, the race providing system may include information related to a number of race events at one or more race event tracks so as to provide the at least one wagering terminal with information regarding a substantially continuous succession of race events. As will be apparent to those skilled in the art (but not shown in FIG. 1), each race event track or other information provider may instead of or in addition to providing their racing information to or through the intermediate race providing system, provide the racing information directly to the at least one wagering terminal over a connection or network. However, in at least one embodiment, a race providing system is used, and preferably a horse race system, a dog race system, or most preferably a combination of horse race and dog race access system is provided.

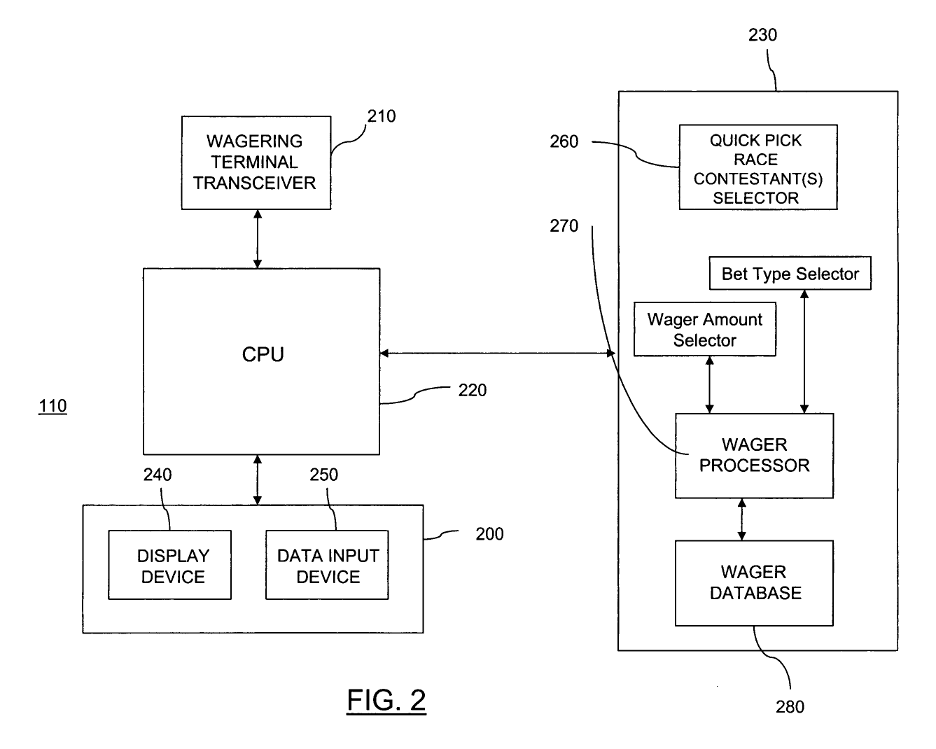

As shown in FIG. 2, in an embodiment, the race providing system 110 comprises a system operator interface 200, a wagering terminal transceiver 210 for communicating with the at least one wagering terminal 120, a central processing unit (CPU) 220 in communication with the system operator interface and the wagering terminal transceiver, and memory 230 in communication with the CPU.

The system operator interface comprises a data display device 240, typically comprising at least one CRT display (although any visual display, such as plasma screen, LED screen, liquid crystal screen, or the like), for allowing a system operator to view, among other things, the racing information. The system operator interface also includes a data input device 250, such as a keyboard and/or mouse, for allowing the system operator to enter control commands through the system operator interface. The control commands include commands for configuring racing information to be transmitted to the at least one wagering terminal, commands for configuring the wager processing of the race providing system, and where applicable, commands for configuring the wager type of the at least one wagering terminal. These will be discussed in greater detail in the further description of the invention.

The wagering terminal transceiver 210 for communicating with the at least one wagering terminal is one or more mechanisms to send all or some of the racing information to the at least one wagering terminal and, where applicable, to send any other information to the at least one wagering terminal. The wagering terminal transceiver 210 for communicating with the at least one wagering terminal is also configured to receive wagering information from the at least one wagering terminal for provision to the wagering processor. Such mechanisms may be typical communication interfaces. In an embodiment, the racing information is manipulated and formatted for sending to the at least one wagering terminal. Further, the other information sent to the at least one wagering terminal may include one or more sets of quick pick race contestant(s) and one or more least chosen race contestants for a wager type, particularly the one or more race contestants for a wager type that may yield a payout of the entire pool, both as described in more detail below. The wagering terminal may be specific to only a single wager type (e.g., only Win, only Place, or only Show) or may enable the user to select from among the different wagers or automatically select from among the different wagers.

The memory 230 may include processor instructions for the CPU 220 to define a quick pick race contestant(s) selector 260 and a wager processor 270. The memory 230 may also include a wager database 280 in communication with the wager processor 270. As will be apparent to those skilled in the art, the memory 230 may be non-volatile or volatile (e.g., RAM) memory or both. The wager database 280 may include one or more wagering records that identify the network address of the at least one wagering terminal from which a wager has been placed and information regarding the wager transmitted from that at least one wagering terminal. Any operating system (OS) may be used for the software as long as it is capable of executing the programs and accepting/converting the data from the race providing system/source. Such operating systems as Microsoft® Word, Word Perfect™, Linux, UNIX, MAC operating systems, specially designed operating systems, derivatives of these operating systems, and the like may be used.

The wager processor 270 may be configured to receive wager information from the at least one wagering terminal (typically via the wagering terminal transceiver), to maintain the wager database 280 with the received wager information and where applicable, to signal the appropriate at least one wagering terminal to initiate payout of winning wagers to the user of the at least one wagering terminal. Where the at least one wagering terminal is used to place pari-mutuel wagers, the wager processor is also configured to include the received wager information into the appropriate pari-mutuel pool and where applicable, obtain information on the size of the pari-mutuel pool for calculation of the relevant payout. Where, for example, the race providing system is connected to one or more other race providing systems, the wager processor transfers the received wager, where applicable, to the correct race providing system(s) so that the wager can be included in the appropriate pari-mutuel pool managed by that race providing system(s) and similarly, where applicable, obtain information on the size of the pari-mutuel pool from the relevant race providing system(s) for calculation of the relevant payout.

The quick pick race contestant(s) selector 260 may be used to generate one or more sets of quick pick race contestant(s) for each race event. Each set of quick pick race contestant(s) may comprise one or more race contestants of a race event according to a specific wager type and is determined by a race contestant selection algorithm. In an embodiment, the number of determined race contestants in a set of quick pick race contestant(s) primarily depends on the wager type. A set of quick pick race contestant(s) for a win, show or place wager type will comprise one race contestant. Similarly, a set of quick pick race contestant(s) for an exacta wager type will comprise two race contestants. The quick pick function may also uniquely select partial picks, completing a partial selection on a wager. For example, in an exacta, the player may select one of the two runners/horses (in either position) and by pressing quick pick, the system will automatically select the completing runners for that wager type. Similarly with a trifecta, the player selection may be for 0, 1 or 2 horses, and the quick pick selection would complete the selection of 1, 2 or 3 runners, respectively.

The race contestant selection algorithm may employ handicapping information and odds information to determine a set of race contestants for a particular race event according to a specific wager type. In an embodiment pertaining to horse racing, the algorithm may analyze for each race contestant of a particular race event the handicapping information including, without limitation, the race contestant's trainer statistics, race contestant's jockey statistics, the track condition of the race event, and the times between race events for the race contestant. Further, the algorithm may analyze for each race contestant of a particular race event the odds information, for example the difference between the “morning line” odds and current odds information for the race contestant. The quick pick value (according to the practice of the invention) of each race contestant may then simply be a weighted value of the handicapping information and odds information associated with each race contestant. The quick pick values for the race contestants of a race event may then be analyzed to determine a set of race contestants for a specific wager type for the particular race event, preferably an optimal set of race contestants to win the specific wager type for the particular race event. As will be apparent to those skilled in the art, any number of race contestant selection algorithms are possible employing handicapping information and odds information to determine a set of race contestants for a specific wager type for a particular race event. Any other handicapping information may also be included, such as without limitation, post position, wind conditions, temperature effects on the runner, travel history of the runner, performance on particular track types and soil types, and the like. Player preferences, player profiles, and other player specific information may also be added to the data analyzed in the handicapping, even preferences of pole positions (e.g., not wagering on certain odds on horses from certain pole positions, such as beyond the 8^{th} position, and the like) Today, there are no handicapping databases that interact with the totalisator by using the odds feed from at least two systems, such as the ITSP combined with Equibase™ feed for horse names and/or HDW for raw racing data. The combined feeds are fed through a data concentrator and the file containing only picks is sent to machines. This reduces network cost rather than sending through feeds to every machine. In modern day simulcasting there is no time to handicap if a player wants to bet every race or maximize the races that are wagered upon. Most tracks carry 400 simulcast races a day (8 races ×50 tracks). Many of these races are only 1 minute apart, thereby not leaving enough time between races to be handicapped manually since there are too many handicapping variables. Thereby, customers will lose their money easier to other tracks that are only carrying 10 tracks a day since those bettors have more time between races. However, if there are fewer available races on the day, less money will be wagered and there will be less earnings for the track. Even though the track only takes an operating cut or takeout, the tracks and the terminal operators will still want players to win, since the more money they have to play with, the more the track can churn and earn its percentage. It is a general objective of the industry to want the other tracks sending money to tracks where wagers have been placed when the simulcast accounts are settled at the end of the month.

The quick pick race contestant(s) selector 260 may also be implemented on the at least one wagering terminal in addition to or substitute of the quick pick race contestant(s) selector provided at the race providing system. Further, the quick pick race contestant(s) selector 260 can determine the one or more sets of quick pick race contestant(s) automatically for each race event and/or determine the one or more sets of quick pick race contestant(s) for a race event upon request from or at the at least one wagering terminal.

In a variation, the quick pick race contestant(s) selector 260 may be configured to determine a number of sets of quick pick race contestant(s) using a number of different race contestant selection algorithms. For example, a different race contestant selection algorithm may simply be a version of a race contestant selection algorithm giving different weights to handicapping and odds information or may be a race contestant selection algorithm using different handicapping information and/or odds information to select one or more race contestant(s). The quick pick race contestant(s) selector 260 may be configured to use a different race contestant selection algorithm (from among various algorithms that can be provided within the system) whenever a reselection command is received from an at least one wagering terminal in order to provide one or more new sets of quick pick race contestant(s) to that wagering terminal.

In FIG. 2, the CPU 220 may communicate with the system operator interface 200, the wagering terminal transceiver 210 and the memory 230. The CPU 220 may facilitate the operation of the race providing system including executing processor instructions defining the quick pick race contestant(s) selector 260 and the wager processor 270. The CPU 220 may also facilitate, where applicable, the determination of one or more least chosen race contestants for a wager type, particularly the one or more race contestants for a wager type that will yield a payout of the entire pool, as described in more detail below. Additionally, with player input, the program may be able select less than all runners/contestants to complete a partial entry selection by the player/user.

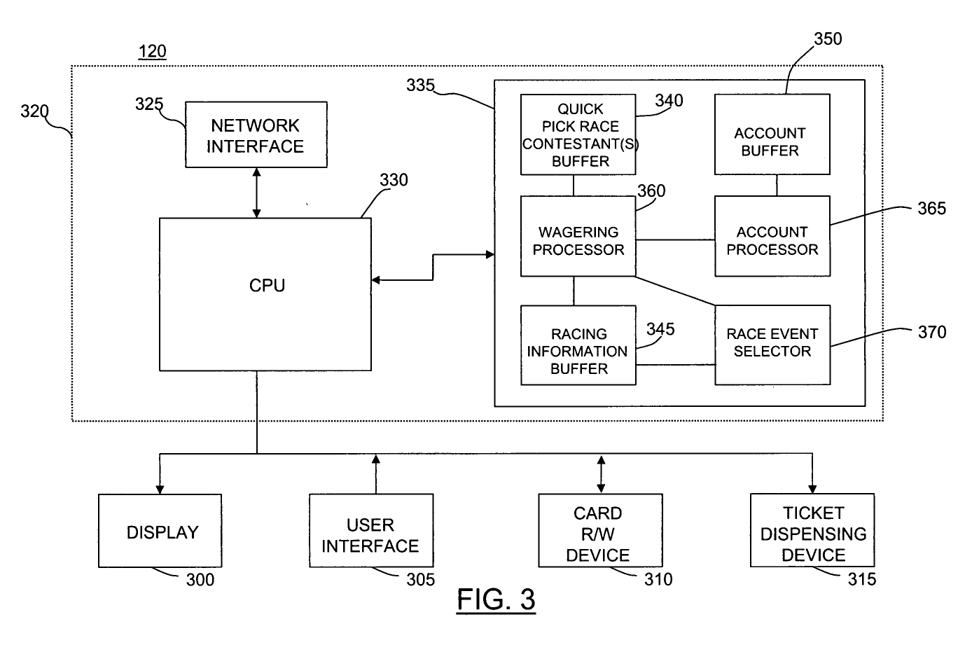

Turning now to FIG. 3, a schematic diagram of an embodiment of an at least one wagering terminal 120 is shown comprising a display 300 for presenting information regarding race events received from the race providing system, a user interface 305 for placing wagers on race events, a card read/write device 310 for receiving an electronic or magnetic-stripe card encoded with a user's account information, a ticket dispensing device 315 for providing a ticket comprising wager information for an elected race event, and a processor 320 for facilitating wagering on the selected next and other future race events and for communicating with the display 300, the user interface 305, the card read/write device 310 and the ticket dispensing device 315. The ticket dispensing device 315 is optional, as the player may remain at the terminal 120, or other accounting systems that track player use, winnings and losses.

In an embodiment, a user may open an account specifically for wagering which is credited and/or debited as required with monetary and/or other credit values. Such an account may be set-up, for example, manually with a clerk of the establishment controlling the at least one wagering terminal 120 or electronically by the user through telephone or the Internet. Typically, an electronic/magnetic-stripe card is issued by the establishment to the user through, for example, a clerk or automated device, and is encoded with information identifying the user's account balance. The user may then credit and/or debit monetary or other credit values through, for example, the clerk or an automated device. Other secure access systems for enabling player/user access may also be used.

A wagering account/card set-up kiosk may be provided for wagering account set-up and/or to issue a wagering card. The kiosk is dedicated to wagering account set-up and provides a number of options on how to set-up the wagering account. For example, the user, or a person facilitating account set-up for the user, can manually enter the necessary information into screens of the kiosk or supply a completed form into the kiosk which is read by optical character recognition hardware and software of the kiosk. Once the wagering account application is accepted, a wagering card or access number may be issued by the kiosk. The access may be limited to the actual amount in the account or may be debited to other accounts (e.g., bank accounts, credit cards, etc.).

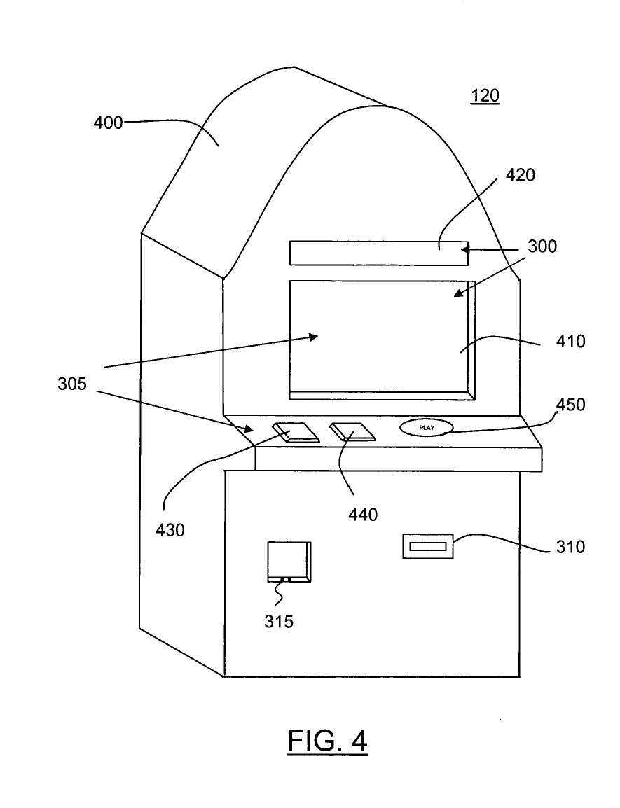

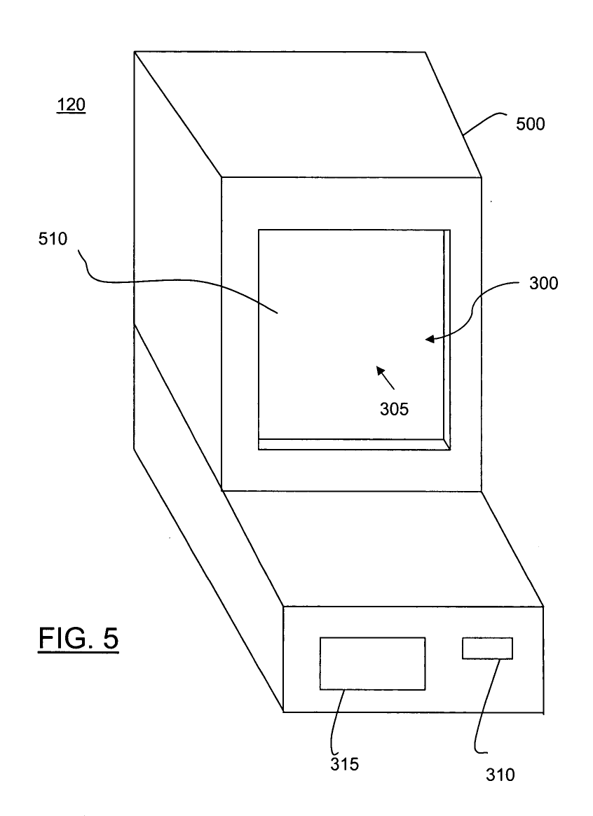

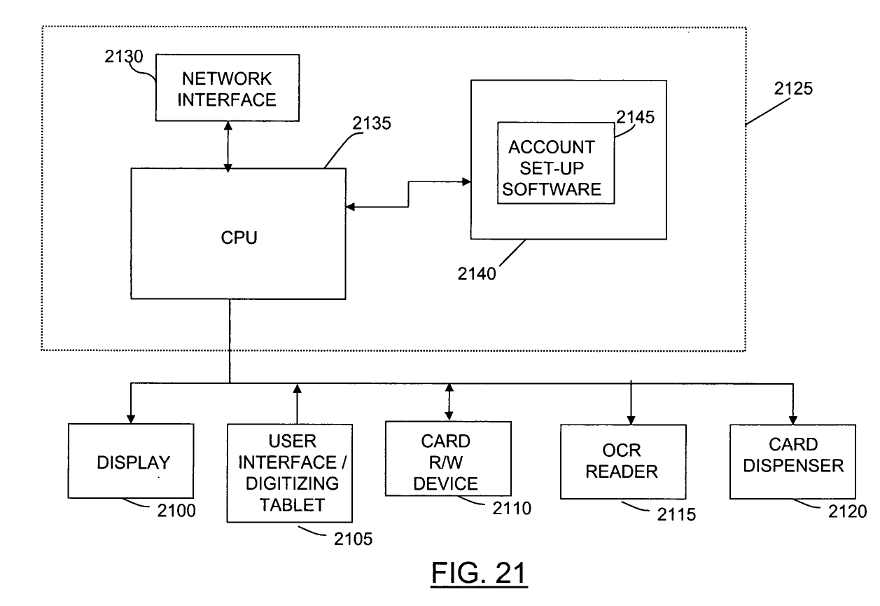

Referring to FIG. 21, the kiosk may include a display 2100 for presenting information about wagering account set-up, optical character recognition reader 2115 (hardware and software) to scan and parse a completed wagering account application form, a wagering card dispenser 2120 to issue a wagering account card on successful completion of wagering account set-up, a user interface and digitizing tablet 2105 to capture a user's input and signature, optionally a card reader 2110 to read various types of cards such as drivers licenses, ATM cards, etc., and a processor 2125 to facilitate account set-up. The account processor 2125 may include a network connection 2130 to an account management system and optionally a credit database, and a central processing unit (CPU) 2135 in communication with the various devices noted above. The processor 2125 may also include a memory 2140 in communication with the CPU 2135. The memory 2140 may comprise account set-up software 2145 to facilitate wagering account set-up. The kiosk may be of the same or similar design as the wagering terminal depicted in FIGS. 4 and 5 and further described below.

As an example, the kiosk may present a message such as “Press here to signup now or insert a completed application”. If the user inserts a completed application (for which copies of blank applications should be available with or near the kiosk), the OCR reader scans the application form and collects all relevant information from the form. The kiosk will confirm the information with the user through a screen presented on the kiosk's display and prompt the user for any missing or illegible information from the application. Once the application has been processed, the account may then be validated and set-up through, for example, a connection to a credit database such as an Equifax™ database. Optionally, the kiosk may request the insertion of a drivers license or credit card into a card reader of the kiosk or request a social security number, password, PIN number or other identifier for validation of wagering account set-up. The kiosk may also request a deposit of value into the wagering account through, for example, the insertion of an ATM card or credit card into a card reader of the kiosk. When the wagering account set-up is successful, a wagering card is dispensed by the kiosk. The user can use the wagering card and, optionally, a personal identification number (PIN) provided by the kiosk, to immediately begin wagering at, for example, a wagering terminal. The completed application may include a signature and the kiosk collects the hard copy applications for later retrieval. The hard copy application form may be used as a permanent record of the user's agreement to the terms and conditions of the wagering account and of the user's eligibility for the wagering account. Alternatively, the wagering card may be mailed or separately delivered to the user. Further, a separate wagering account set-up confirmation may be sent to the user by mail, fax, e-mail, etc. to provide the security that a wagering account has not been fraudulently established.

If the user elects to set-up the wagering account/card immediately, the kiosk provides relevant screens on its display to guide the user through the wagering account set-up process and to prompt the user for the necessary information. In an embodiment, the screens request substantially the same information as on the wagering account application. The kiosk may provide a digitizing tablet to capture a user's signature or fingerprint, or in the future, retinal scans, in order to complete wagering account set-up. Once the screens are completed and the signature is provided, the account may then be validated and set-up through, for example, a connection to a credit database. Optionally, the kiosk may request the insertion of a drivers license or credit card into a card reader of the kiosk or request a social security number or other identifier for validation of wagering account set-up. The kiosk may also request a deposit of value into the wagering account through, for example, the insertion of an ATM card or credit card into a card reader of the kiosk. When the wagering account set-up is successful, a wagering card may be dispensed by the kiosk. The user can use the wagering card and, optionally, a personal identification number (PIN) provided by the kiosk, to immediately begin wagering at, for example, a wagering terminal. The digitized signature may be used as a permanent record of the user's agreement to the terms and conditions of the wagering account and of the user's eligibility for the wagering account. Alternatively, the wagering card may be mailed or separately delivered to the user. Further, a separate wagering account set-up confirmation may be sent to the user by mail, fax, e-mail, etc. to provide security that a wagering account has not been fraudulently established.

To place one or more wagers, the user would introduce the card to the card read/write device, a form of a wagering value mechanism, of the at least one wagering terminal on which the user would like to place one or more wagers. Other accessing formats described herein or acceptable to the field would also be useable by the player user. Thus, the access system, such as the card read/write device of the at least one wagering terminal allows the user to supply the monetary or other credit value needed to place a wager. Further, in an embodiment, the card read/write device of the at least one wagering terminal may facilitate the payout to the user of a winning wager. As will be apparent to those skilled in the art, accounts that are not specifically set up for wagering such as bank accounts or credit accounts could be used in place of or in addition to the wagering account set-up specifically for wagering and similarly, other types of electronic/magnetic-stripe cards such as credit cards or debit cards may be used be used in place of or in addition to the wagering card set-up specifically for wagering.

Further forms of wagering value mechanisms may be provided in addition to or as a substitute for the card read/write device including a currency receiver (not shown) for receiving currency and, where applicable, a currency dispensing device (not shown) for dispensing currency payouts. The currency receiver allows the user to supply the monetary or other credit value needed to place a wager and may also be used to credit monetary or other credit value to a user's account, for example, stored on a card. For example, a user can deposit cash into the user's account by inserting the user's wagering card into the card read/write device and then inserting currency into the currency receiver for deposit into the wagering account. The currency dispensing device may facilitate the payout to the user of a winning wager or the withdrawal of currency from the user's account. For example, the at least one wagering terminal may be registered in the account system as a teller machine and when a withdrawal is made, the user's account is debited and the cash on hand balance for that wagering terminal/teller machine is debited. Similarly, the at least one wagering terminal may be registered in the account system as a teller machine and when a deposit is made, the user's account is credited and the cash on hand balance for that wagering terminal/teller machine is credited. Internal controls are established to ensure that the cash on hand in the at least one wagering terminal, the amount of cash withdrawal and the physical access to the wagering terminal is adequately secured.

As will be apparent to those skilled in the art, the at least one wagering terminal may have electronic access, another form of a wagering value mechanism, to the user's account such that the user's account balance need not be on an electronic/magnetic-stripe or for that matter no card or currency device may be required. For example, the race providing system may provide facilities to access user accounts including the ability to credit and debit the user's account, to receive account information requests from the at least one wagering terminal, verify access to an account by a user using the at least one wagering terminal, etc. Alternatively, another system connected to the at least one wagering terminal may provide such access to user accounts such as credit card merchant services. The user accounts may be accounts specifically set up for wagering or may be general accounts not necessarily maintained at the race providing system such as credit or bank accounts. The at least one wagering terminal could use a card read/write device to get the necessary information for the user's account (for example, for credit and bank accounts) or could allow the user to provide the necessary information to access the user's account through the at least one wagering terminal's user interface. As will be apparent, any number of wagering value mechanisms known now or developed in the future may be employed to provide a wager amount and/or deliver a payout for a winning wager.

In an embodiment where the user opens an account specifically for wagering, to facilitate monetary or other credit value deposit to and withdrawal from the wagering account and the associated wagering card, the wagering account and card may be related to a financial account and/or card, such as a bank account and/or ATM card or a credit card account and/or credit card, to facilitate monetary or other credit value deposit and withdrawal. Where the wagering account/card holds monetary value, a direct transfer between the financial account and/or card and the wagering account/card can be made subject to currency conversions. Where the wagering account/card holds other credit value, a transfer between the financial account and/or card and the wagering account/card involves a conversion process to convert monetary value to the other credit value, subject to currency conversions.

Where the user does not have a financial account and/or card and the establishment controlling the at least one wagering terminal has an agreement with a partner financial institution or bank, the user may automatically get a financial account and/or financial card along with a wagering account/card for use with at least one wagering terminal. The financial account would be similar or identical to a traditional bank or other account. The financial account information will automatically be associated to the user's wagering account information for the purpose of making withdrawals and deposits.

Where the user has an existing financial account/card, such as a bank account/ATM card or a credit card account/credit card, the account information of that financial account/card is associated with the wagering account/card during, for example, the wagering account set-up by the user providing the financial account/card information or electronically swiping the financial card to obtain the financial account/card information. If the user does not have the financial account/card information available, a follow-up offer is made to the user to provide the financial account/card information via, for example, a cancelled check, an on-line check processing step (where a blank check is scanned and used by the system), or an online form. The financial account/card information will be associated with the user's wagering account/card. Through the association, the user is provided a convenient way to transfer monetary or other credit value to and from the user's wagering account/card directly to or from the financial account/card, monetary or other credit value the user can access via, for example, an automated teller machine or other mechanism.

To withdraw monetary or other credit value from the wagering account/card to the financial account/card associated with the wagering account/card, the user can use an automated phone system, an Internet application, a signup kiosk or at least one wagering terminal to request a withdrawal. If the wagering account/card is mapped to the financial account/card, the withdrawal can be available in the form of cash by using the financial card in, for example, an automated teller machine. Similarly, to deposit money into the wagering account/card from the financial account associated with the wagering account/card, the user can use an automated phone system, an Internet application, a signup kiosk or at least one wagering terminal to request a deposit. Appropriate user prompting and/or screens are provided to facilitate withdrawal and deposit. For example, the at least one wagering terminal may provide one or more special icons and/or buttons to access the withdrawal and/or deposit functionality. One or more screens may be triggered and provided by at least one wagering terminal software upon selection of the icons(s) and/or button(s) to prompt the user for an amount to withdraw and/or deposit and optionally request a user identification code such as a PIN. Appropriate transaction processing is provided to the at least one wagering terminal, sign-up kiosk, etc. to facilitate the monetary or other credit value transfer between the financial account/card and the wagering account/card. Such transaction processing can be, for example, provided by a race providing system, a hub or account wagering clearing services described in more detail below, or some other financial transaction processing system.

Further, there are currently a variety of account wagering suppliers in the U.S. and internationally. Each account wagering supplier maintains ownership of their wagering account records and is responsible for reporting and reconciling wagering activity through an aggregation function such as the Inter-Tote Service Protocol (ITSP). Account wagering is provided at, for example, race event tracks, off-track betting facilities, telephone betting facilities and Internet betting facilities. Account wagering is also facilitated in the at least one wagering terminal in accordance with an embodiment of the present invention. However, the variety of account wagering offerings presents a less than ideal solution to a user because of the inconvenience of maintaining several accounts with different account wagering suppliers each with different restrictions and minimum balance requirements. The reasons for fragmentation in account wagering services supply include account wagering suppliers' need to own their customer data, account wagering suppliers' need to control the quality of account wagering service to their customers, variations in the rules governing account wagering from jurisdiction to jurisdiction, tote companies having incompatible account wagering interface formats, and account wagering suppliers and other stakeholders competition to control account wagering services. It is desirable for the present system to have the protocols available to access these tote systems, rather than establishing an independent tote system, but the latter is also an option.

So, according to at least one embodiment of the invention, there is provided a method and system of increasing collaboration between account wagering suppliers to a user location. Advantages of increased collaboration between account wagering suppliers include improved user experience and de-fragmentation of the account wagering environment. The method and system according to an embodiment of the present invention includes a universal wagering card, a portable card reader module, an account wagering clearance service and a business model to provide incentives to wagering account suppliers to accept each others account wagering cards. As will be apparent to those skilled in the art, sub-combinations of these aspects may be provided.

A first aspect is the creation and branding of a universal wagering card. For example, the universal wagering card aims to resolve a problem in the racing industry that wagering cards are associated with specific race event tracks and typically cannot be used at different race event tracks. The lack of a portable wagering card poses problems when a user wants to move between or to new race event tracks. This problem may be significant for account based wagering using the at least one wagering terminal in accordance with an embodiment of the present invention because the at least one wagering terminal may be available at a variety of locations including at race event tracks. Requiring a user to manage numerous different wagering cards could turn a user away from account wagering and using the at least one wagering terminal.

The universal wagering card (UWC) is a wagering card that allows additional account wagering capabilities. In particular, the UWC will essentially be a debit card authorized for account based wagering. In order to meet this need, the UWC will have, in an embodiment, certain features. First, the UWC must have credibility. The card should be prestigious in nature so that users demand it. A gold or platinum card is attractive compared to the existing mag-stripe cards. Further, the UWC should offer benefits over a regular wagering card, such as rebates or prizes. Further, the UWC should be secure. The UWC should be very difficult to duplicate and protected by a PIN code. The UWC should be tied to a trusted account management facility (TAM) via, for example, secure web services and support secure public key communications. In an embodiment, the at least one wagering terminal according to an embodiment of the present invention may be interfaced to the TAM via a VPN concentrator described in more detail below.

Additionally, the UWC should have acceptance. The UWC will be accepted at wagering terminals located at other than a race event track or an off-track betting location. The UWC will be accepted at Internet sites. If a card reader is not present, the wagering account number and PIN may be used and certain wagering restrictions may apply to ensure security. The UWC will be accepted at race event tracks and off-track betting facilities where approved by that facility. Additionally, the wagering terminals should be able to accept traditional wager cards as well as the UWC, especially those wagering terminals at race event tracks and off-track betting locations. The wagering terminals may be configured to allow an account wagering supplier to supply a module to handle that wagering supplier's wagering card as discussed in more detail below in respect of the portable card reader module.

Account wagering suppliers and account wagering customers, such as race event tracks, off-site betting facilities, Internet sites, etc., should be provided an incentive to allow the use of the UWC. For example, the UWC system can vouch money for local (non-UWC) transactions at trusted account wagering customers. An account wagering customer that issues a UWC to a user can receive a percentage of all transactions placed on that user's issued UWC. An account wagering customer that issues a UWC to a user can be entitled to data on UWC card usage. An account wagering customer that accepts a UWC transaction can receive data on UWC users and transactions at that account wagering customer's facility. Also, the UWC card can ensure compliance with all racing regulations regarding deposits, withdrawals, etc. The TAM can provide problem gaming compliance and government reporting. As will be apparent to those skilled in the art, sub-combinations of features or additional features can be provided in relation to the UWC.

In a further aspect, there is provided a portable card reader module (PCRM). The PCRM is a portable hardware/software module for processing account wagering transactions from disparate account wagering cards using a hardware card reader. The. PCRM module works in conjunction with, for example, a VPN concentrator described in more detail below to allow an account wagering customer's existing facility to accept foreign wagering account transactions using one or more foreign wagering cards, i.e., wagering account transactions from a wagering card(s) issued by other account wagering customers. Currently, a wagering device that accepts a wagering card typically reads a 2 track magnetic stripe card and potentially receives a PIN via keypad or input device. Accordingly, in an embodiment, there are two models of the PCRM the first model is a software only component that provides field compatibility with foreign account cards and/or the UWC for existing card readers and the second model upgrades the card reader and keypad/input device to support foreign account cards and/or the UWC. Both models comprise a software module that intercepts the communications between the wagering device software and the card reader/key pad/input device. If the inserted wagering card is a foreign account card or a UWC, the PCRM module provides a reserved account identifier to the wagering device and uses out of band communications through, for example, the VPN concentrator to record the sub-account for the pending transaction. The transaction is then processed through an account wagering transaction processing system such as, for example, a race providing system, a hub or account wagering clearing service described in more detail below, or some other transaction processing system. Additionally, if a wagering device performs a balance lookup function on a wagering account, this function must be wrapped to intercept requests on the reserved account and route them through, for example, the VPN concentrator for fund approval. In an embodiment, this may occur in the account management functions within a race providing system by providing a 3^{rd} party library along with a VPN concentrator to enable real-time balance lookups on foreign wagering accounts or the UWC wagering account.

In accordance with a further aspect, there is provided an account wagering clearing service (AWCS). The AWCS is a secure facility that provides data interchange between multiple account wagering suppliers along with many other crucial pieces of hub functionality described in more detail below for the at least one wagering terminal in accordance with the present invention. The AWCS is able to process foreign wagering account transactions. In an embodiment, the AWCS is Internet based.

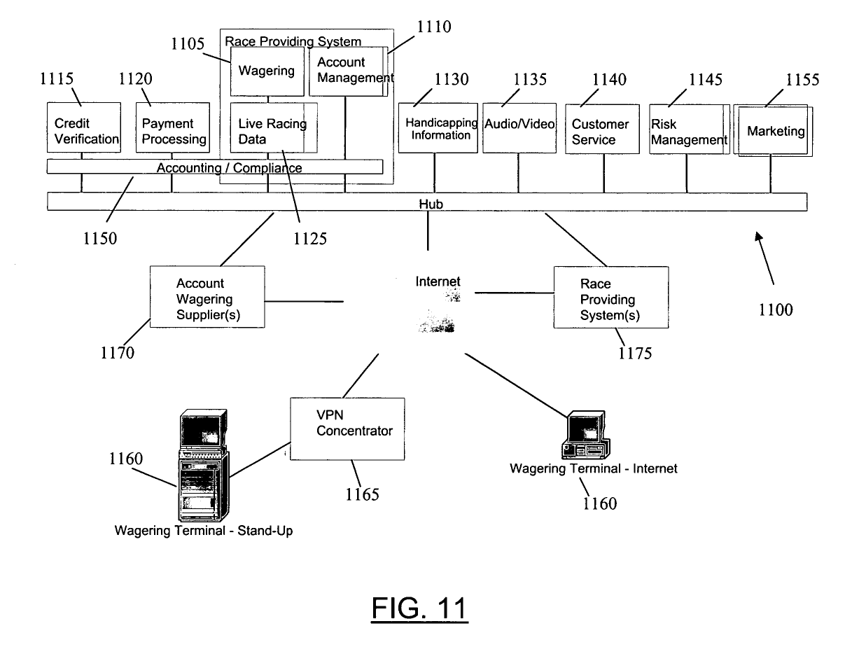

The hub may provide a set of services necessary to support field installations of the at least one wagering terminal in accordance with at least one embodiment of the present invention. Referring to FIG. 11, the hub 1100 may support the aggregation of vendor services including wagering 1105, account management 1110, credit verification 1115, payment processing 1120, live racing data 1125, handicapping information 1130 and audio/video 1135. The hub 1100 may provide a common services application programming interface that will serve as a scalable platform for supporting the at least one wagering terminal and other devices and for delivering wagering services through the at least one wagering terminal and other devices. The hub 1100 may also support business management functions/applications, including customer service 1140, risk management 1145, accounting and compliance 1150, and marketing 1155.

In addition to the broad range of services described above, the AWCS may provide the capabilities of: 1) placing a wager in a foreign wagering account; 2) transferring or vouching for funds between foreign wagering accounts; 3) checking a user's balance in a foreign wagering account; 4) canceling a wager in a foreign wagering account; 5) logging into a foreign wagering account; 6) connecting to foreign wagering account via, for example, IVR, HTTP, XML/Web services, Amtote Gateway API, Autotote ATL, and/or United Tote IVR serial protocol; 7) ensuring compliance with a broad range of jurisdictional gaming regulations via a regulatory rule base; 8) providing detailed user and account data to trusted parties based on access policies represented by an access control rule base; and 9) providing immediate calculation of actual payouts on a given wager and pushing that data to a requester on a given live data channel. As can be seen in FIG. 11, the hub 1100 may have connections to the at least one wagering terminal 1160 via an optional VPN concentrator 1165, to an account wagering supplier(s) 1170 and to a race providing system(s) 1175. In an embodiment, the connections are via the Internet although as will be apparent to those skilled in the art the connections may be a private or direct connection.

In another aspect, a business model is provided to supply an incentive to existing account wagering customers to accept or create foreign wagering cards. In an embodiment, if an account wagering customer chooses to become a member of an account wagering consortium (AWC), the account wagering customer's wagering cards will be accepted by all wagering devices, such the at least one wagering terminal in accordance with an embodiment of the present invention, of at least one prominent member of the AWC. Furthermore, wagering cards of an account wagering customer of a certain level of membership in the AWC will be accepted at all AWC member facilities of the same or higher level of membership. Wagering cards of an account wagering customer of a certain level of membership in the AWC will also be accepted at all AWC facilities of the same or higher level of membership. Members of the AWC agree to accept the UWC at their facilities including Internet site(s) and wagering devices at race event tracks. The AWC members also agree to display an AWC logo prominently at their wagering facilities, on wagering devices, and on their wagering cards.

For each foreign wager account transaction placed at an AWC member, the foreign wager account issuer and the AWC member will each receive a percentage of the handle and/or a percentage of any wagering fee. The AWC will receive a percentage of each wager and fee in exchange for processing the inter-entity transaction, owning the AWC brand, managing jurisdictional restrictions, serving as a clearing house and underwriting the transfer of funds.

The AWC, the foreign wager account issuer or the AWC member may process the wager depending on whether the wagering account supports miscellaneous debit and credit functionality. The foreign wager account issuer will own customer and transaction information for its customers. The AWC member processing the foreign wager account transaction will have per wager information, optionally anonymously, as well as detailed aggregate reports describing foreign wager account issuer(s) transaction volumes and high level user demographics. The AWC will be the trustee for all detailed wagering data to provide a complete audit trail and satisfy various jurisdictional requirements.

In an embodiment, the ticket dispensing device issues wager tickets to provide tangible evidence of a wager placed as well as to provide a means to obtain a payout of a winning wager in addition to or instead of payout via any one of the wager value mechanisms described above. The payout for a wager ticket can be obtained, for example, by providing the wager ticket to an automated machine that processes the wager ticket and provides a payout and/or credits a user's account. Alternatively, the payout can be obtained by presenting the wager ticket to a clerk who may provide the payout and/or credit a user's account. In an embodiment, the wager ticket includes information about the wager including the race track name, race number and date of the wagered race event, the wager amount, the wager type, the selected race contestant(s) of the wager, and the user account balance. In an embodiment, the selected race contestant(s) are shown in detail for the particular wager type. For example, an exacta and 3 wheels bet would show in detail the race contestants of the 3 combinations of this wager.

The processor 320 may comprise a network interface 325 for communicating with the race providing system 110, and a central processing unit (CPU) 330 in communication with the display 300, the user interface 305, the card read/write device 310, and the network interface 325. The processor 320 may also include a memory 335 in communication with the CPU 330.

The memory 335 may include a quick pick race contestant(s) buffer 340 for receiving the quick pick race contestant(s) data for the race events received from the race providing system, a racing information buffer 345 for receiving racing information, including odds information, from the race providing system, and an account buffer 350 for recording the monetary value of funds in the user's account. The memory 335 may also include processor instructions for the CPU 330 to define a wagering processor 360, an account processor 365 and a race event selector 370. As will be apparent to those skilled in the art, the various buffers and processor instructions may be combined into one or provided in alternate arrangements.

The race event selector 370 may communicate with the racing information buffer 345 and the wagering processor 360. The race event selector 370 may be configured to select race event information received from the race providing system for presentation on the display 330. In an embodiment, the race event selector 370 may be configured to determine and make available for display information about a next race event which is scheduled to run at all or certain of the race event tracks for which the race providing system has supplied race event information. The race event selector 370 may also be configured to determine and make available for display future race events in time order at ail or certain of the race event tracks for which the race providing system has supplied race event information. If more than one race event is scheduled to run at or about the same time, the race event selector 370 may select information about one of the race events for display (for example, choosing a race event at a more preferred race event track). In this manner, the at least one wagering terminal may continuously provide a succession of race events to a user upon which to wager. As will be appreciated, some race events can only entertain certain types of wagers. For instance, superfecta wagering may not be permitted at a certain race event. Consequently, the race event selector may select for display only those race events for which the at least one wagering terminal is configured to receive wagers.

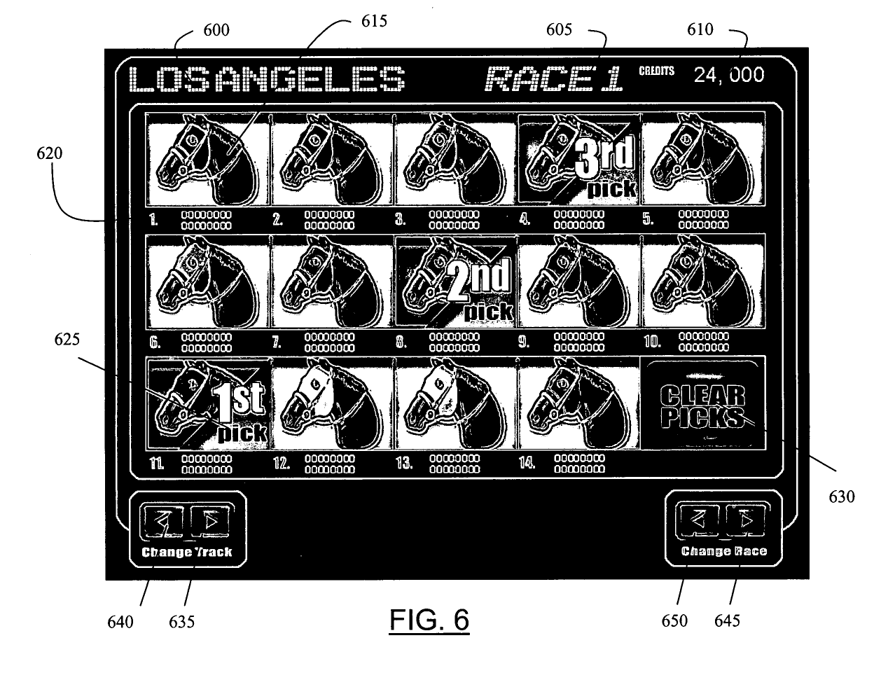

Further, the race event selector 370 may be configured to accept a next or previous race selection command from the user interface via the wagering processor 360, thereby allowing the user to view information regarding a next race event or future race events. For example, referring to FIG. 6, the user may “scroll” back and forth through a next and other future race events by starting time by touching the “Next Race” and “Previous Race” buttons/icons, each touch of the buttons/icons causing the wagering processor to present, as applicable, updated information on the display corresponding to the “previous” or “next” race event by start time. Essentially, the user is able to view (and thus wager on) in time order a next race event and other future race events for which the at least one wagering terminal has information. In an embodiment, a next and other future race events by starting time may be the next race events by starting time found at all of the race event tracks for which the race providing system has supplied race event information. In another embodiment, a next and other future race events by starting time may be the next and other future race events at the certain current race event track which is presented on, the display of the at least one wagering terminal.

In at least one embodiment, an algorithm may be used to select a next race event from available race events at various race event tracks. The algorithm may determine a next race event by analyzing a number of factors which are weighted by importance. The weights may be manually or automatically adjusted to configure the determination of the next race event. The algorithm may continuously evaluate the latest information available for the various factors to make adjustments to the next race event provided to the at least one wagering terminal. The algorithm may also adjust for system factors such as the timely display of audio/video corresponding to the race events and/or the display of race event results. The factors can include: 1) estimated start of race event; 2) estimated duration of race event; 3) nature of the race event such as, for example, popularity, type of race, purse, handle, quality, number of bet types available, etc.; 4) actual start of the race event as affected by delays, for example, horse out of gate, inquiry, weather, etc.; and 5) playability, such as adequate time for a user to bet.

The race event selector 370 may also be configured to determine and make available for display race events at different race event tracks. In this regard, the race event selector 370 may be configured to accept a next or previous race event track selection command from the user interface 305 via the wagering processor 360, thereby allowing the user to view information regarding a race event at different race event tracks. For example, referring to FIG. 6, the user may “scroll” through future race events at different race event tracks by touching the “Next Track” and “Previous Track” buttons/icons, each touch of the button/icons causing the wagering processor 360 to present, as applicable, updated information on the display corresponding to the future race events at “previous” or “next” race event tracks. Essentially, the user is able to view (and thus wager on) race events at different race event tracks for which the at least one wagering terminal has information. In an embodiment, the race event track (of all of the race event tracks for which the race providing system has supplied race event information) having the next starting race event is presented, along with that next race event, on the display 300 of the at least one wagering terminal in response to a “next” race event track command. In another embodiment, the next race event track in alphabetical order (of all of the race event tracks for which the race providing system has supplied race event information) is presented, along with next starting race event at that race event track, on the display 300 of the at least one wagering terminal in response to a “next” race event track command.

The race event selector may or may not have a manual override which deviates from estimated past times derived from the tote feed.

One of the problems with pari-mutuel wagering on race events is that there is a tremendous amount of terminology that the player must be familiar with such as track codes which are abbreviated to save room or “real estate” on the user interface. For example, a track code for Gulfstream Park Racetrack is GP, another track code example is EVD for Evangeline Downs racetrack. A typical betting user interface may have 40 tracks taking up 40 square inches of the user interface. For the player the track codes become a guessing game because track codes such as AP, which stands for Arlington Park racetrack or ArP which stands for Arapahoe Park racetrack become very similar for a new player or “unseasoned” player. With worldwide simulcast there are over 1000 track codes and there is only 137 square inches on a typical wagering interface, thereby only accommodating 137 tracks (1 square inch per track code) per user interface. The player must then scroll through alphabetical pages to find track codes. By having a race event selector the track codes can be spelled out rather than abbreviated such as AP can be shown as Arlington Park, Race 3 with the race number included. The race number is the step or may be the next step with the track code on a conventional wagering terminal. However, track code and race number are combined by the race event selector.

Another aspect of the invention is the selection of races by the provided system based on the time until the next race. The system has access to races at numerous locations and the system selects races for wagering (unless overridden by player input) based upon identifying a race at the most convenient time in the near future. For example, assuming that each player spends 15 seconds placing a wager (including access time to a distal tote where applicable), the system will select the next race for wagering that is at least 15 seconds away. A safety zone of 5 -30 seconds (or any time frame that is determined appropriate, essential, or desirable for practice of the invention, but less than 15 minutes, preferably less than 10 minutes, more preferably less than 8 minutes and less than 5 minutes, and most preferably less than 3 minutes, less than 2 minutes, and less than 1 minute) may also be built into the system to avoid the frustration of having the system switch races during the middle of wager placement and wasting the player's time. It must be remembered that once the wager has been placed on one race, the system may then switch to another race for wagering. This time control access, and the queing of races is a unique feature of the present invention. Available races may be preferably queed in time for system selection and display to the player, and races may be replaced as time passes and the time limit for allowing a player to access and enter a wager on the race passes. The advantage of next race selection with the reasonably closest post time is that it prevents a bettor from missing a race and guides the bettor to the closest post time in the simulcast menu which gives the bettor more accurate odds because the odds are likely to change less because of the proximity of the race. For example, the odds have a greater chance of varying with 5 minutes to post versus 1 minute to post.

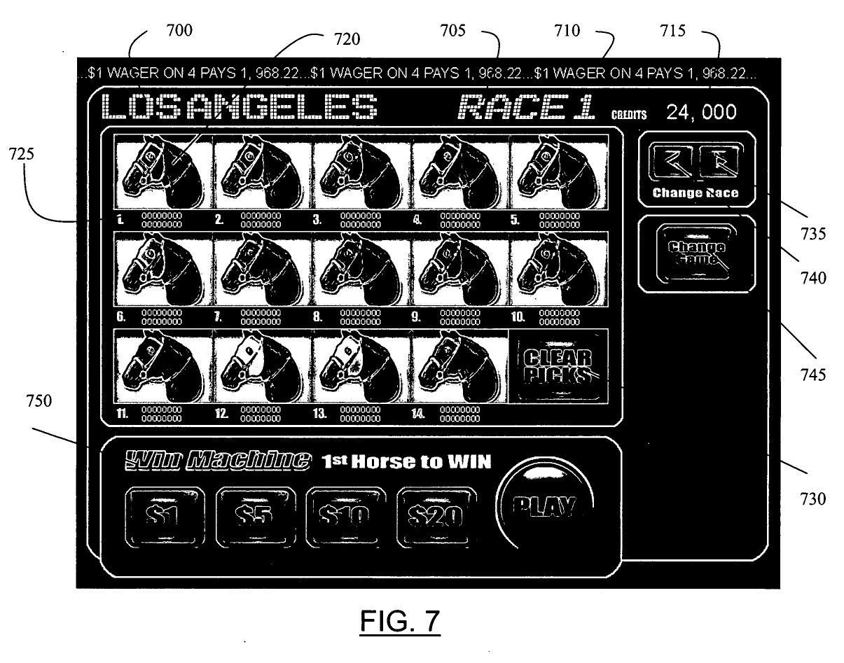

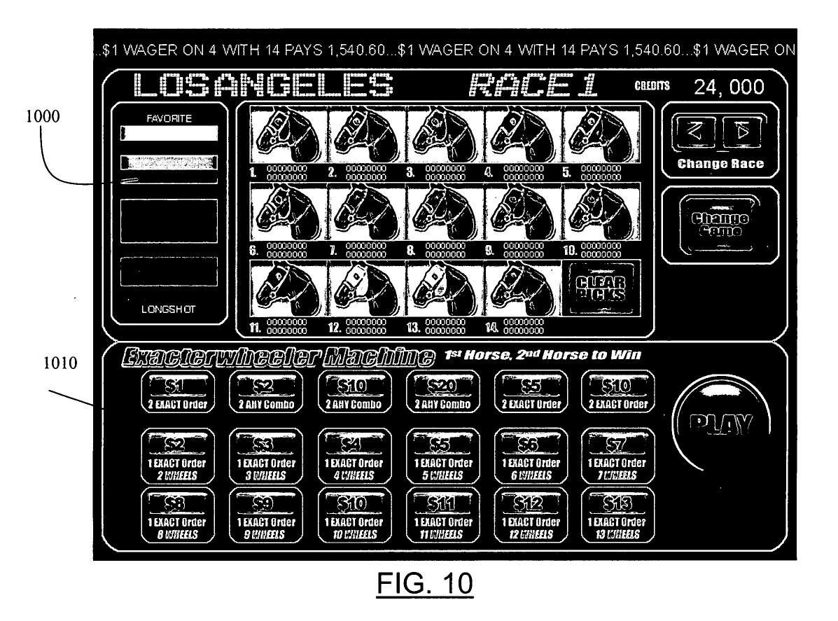

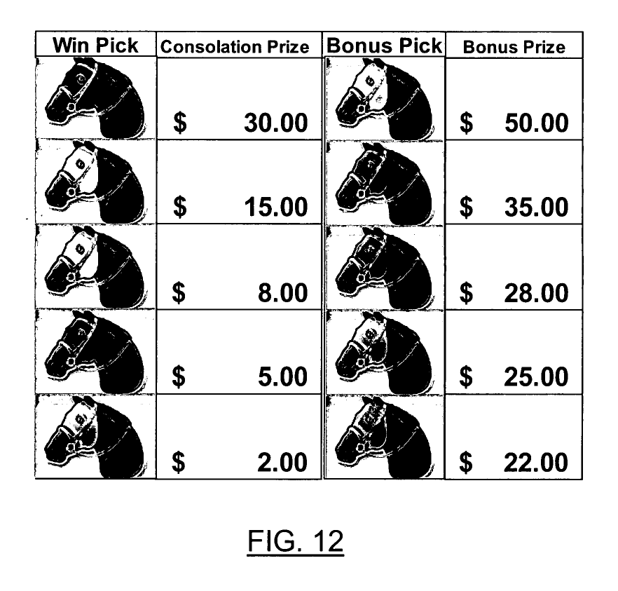

Some unique performance characteristics that have already been discussed above. Those will be further described and elaborated upon here. Automatic arrangement of odds and picks (e.g., a vertical or horizontal list from highest odds to lowest odds or lowest odds to highest odds {favorites to long shots]), are shown on FIGS. 12-18. The odds/payouts are placed into a readily viewable display that can be easily interpreted. FIG. 10 clearly shows color-coding of the odds, especially when arranged, so that players can see the odds in a color scheme both on the odds board and/or on images of the runners used to assist in or enable runner election. For example, the odds board may show the odds on rows that are, in order, red, white, blue, orange, pink, purple, green, etc. The odds would, by way of non-limiting example, be on the display red 5-7, white 2-1, blue 4-1, orange 6-1, pink 7-1, purple 9-1, green 12-1. Whatever the odds on a particular race, the same order of color would be used to display the order of the odds. As the odds shift during wagering, the colors on the odds of a particular runner may shift, but the order of the odds on a horse remain the same. This enables players to select runners (e.g., horses, dogs, etc.) by their colors based on a player' inclination to select horses according to their odds. Similarly to b), payouts can be simultaneously or later displayed in the reverse order of color scheme as the odds, as the potential payouts are relatively inverse in order to the odds, so the color scale will be reversed from the odds scale. The color scale 1000 could include within it, the inverse list of payout amounts or list the specific odds, or include both within the color rows. Alternatively, a separate table may show one or the other of the odds or payouts that are displayed on list 1000, as well as other displays on the screen. This allows the players to maintain a semblance of cognizance about wagers. The runner being wagered on may be shown in a series of rows and columns with representative images as shown in FIG. 7. These are not actual pictures or images of the horses, but representations of horses with the odds/payout colors used to further highlight the display of the runners. The odds or payout colors are associated with the images of the runners (e.g., the ‘color’ on the runner image re the colors of the odds arrangement, not the actual colors of the runner on the track. The colors may shift on the horses, although names of the horses that may be displayed with the symbolic images and the numbers of the horse in the race will remain consistent with the specific runner to be wagered upon in the event. The original display of the images may be by runner number, runner name or randomly on the display, or alphabetically or in numeric order, or by any arrangement that is designed into the system. When the wagers are placed by the player or automatically selected or automatically completed by the software, the columns and rows spin (giving the appearance of reels on a reel-type video slot machine), the spinning stopping, and the selection(s) positioned on a predefined position on the final display of the reels. For example, the winner wagered upon may be shown in column 1, row 1, or column 1, row 2 as a predetermined selection. If a trifecta were wagered upon, the three runners in the selection may be displayed as column 1, rows 1, 2 and 3; columns 1, 2 and 3 row 1; columns 2, 3 and 4 in row 1 or row 2, etc. The final display of the runners wagered upon may also and preferably highlight the runners wagered on, as by screen highlights, overlay of numbers on the runners (e.g., an image saying 1^{st}, 2^{nd} and 3^{rd} overlaying each of the runners wagered on in a trifecta, and any other visual indication of the actual runners that a wager has been placed. When an automatic select function has been made or elected, the ‘reels’ may spin until the decision is displayed. Also, the wheels spin while the system is having its wager entered into a pari-mutuel pool. Similarly, the winning runners or horses may be displayed on the same or separate ‘reels’ for comparison with the wager display or to follow the wager display. It is important to be able to provide in the practice of the invention to have a workable system, software, algorithm etc. to enable handicapping. The preferred system uses handicapping that incorporates tote odds, pool odds, HCW, odds dropping, standard handicapping functions and parameters, singly or in combination. The preferred method combines tote odds and HCW information.

In an embodiment of the invention, referring to FIG. 1, a wagering network, denoted generally as 100, is shown comprising at least one wagering terminal 120 and a race providing system 110 in communication with the at least one wagering terminal. In an embodiment, the communications connection or network between the race providing system and the at least one wagering terminal comprises a closed connection or network. However, the communications connection or network may instead comprise an open connection or network, such as the Internet, if the open connection or network has sufficient bandwidth for adequately servicing the at least one wagering terminal. Additionally, security safeguards such as signatures, user identification requirements, encryption of signals and trails, and the like are desirable attributes of various embodiments of the invention. Moreover, such a connection or network may be of any form including without limitation wire, cable or wireless or any further developed system. Each of these formats is merely a communication system for transmission of signals used in the practice of the invention.

The wager processor also does not send a specific bet type to the wager terminal machine if that specific bet type is not available and (with certain screening controls applied), if the top payouts of the relevant race are not available. A wager processor has the ability to not send an event with a certain field size to machines. For example, 5 horse fields are very unpopular since there are less handicapping angles and smaller betting pools.

The account processor 365 may be in communication with the card read/write device 310, the account buffer 350 and the wagering processor 360. The account processor 365 may be configured for crediting and debiting, in accordance with the amount wagered and the outcome of the elected race event, the balance of a user's account. For example, the account processor 365 may determine whether the user has introduced an electronic/magnetic-stripe card to the card read/write device 310, and then establish an account for the user in the account buffer 350. The balance of the user's account may be stored, for example, on the electronic/magnetic-stripe card which is introduced to the card read/write device 310. Information about the amount wagered and the outcome of the elected race event is supplied by the wagering processor 360. The account processor 365 may perform basic checks to ensure that the user's account has a credit, that the account has enough credit for the amount wagered and that the card is otherwise operating properly. Information regarding some or all of these checks may be communicated to the wagering processor 360 in order to allow the wagering processor 360 to submit a wager to the race providing system. In an embodiment, the account processor 365 may also be configured to request from the user an appropriate password or other identification information via the user interface 305 before establishing the account for the user in the account buffer 350. In an embodiment, the electronic/magnetic-stripe card is specially designed and configured for the at least one wagering terminal. As will be apparent to those skilled in the art, other types of cards may be used such as credit and debit cards.

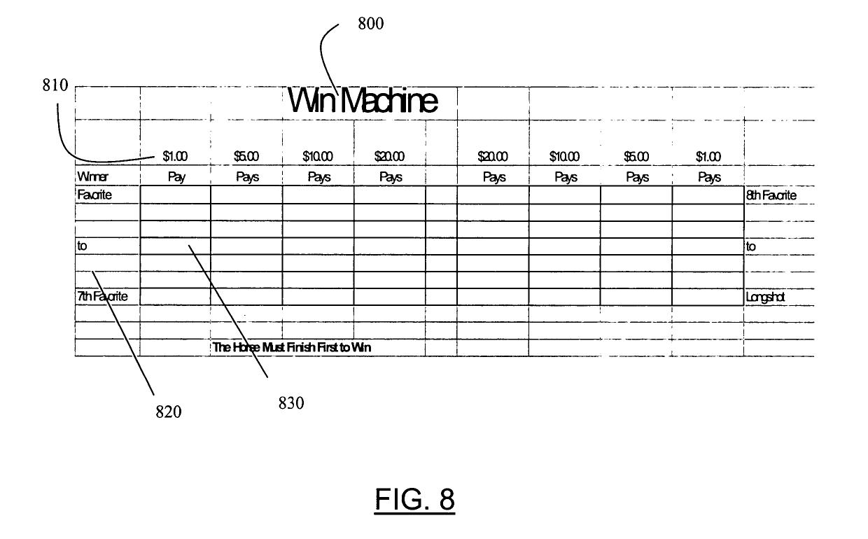

The wagering processor 360 may communicate with the quick pick race contestant(s) buffer 340, the racing information buffer 345 and the account processor 360. The wagering processor 360 may be configured to display the race contestants of the displayed race event using the odds information stored in the racing information buffer 345. In an embodiment, race contestants are shown as differing shaded/color icons on the display depending on the odds information associated with the race contestants. A color palette may be provided on the at least one wagering terminal to identify the colors associated with the race contestants, namely colors ranging from favorite to long-shot. In an embodiment, the color palette is provided physically on the glasswork of the housing of the at least one wagering terminal although as will be apparent to those skilled in the art, the color palette may also, for example, be provided on the display or as part of a payout table (as described in more detail below with respect to FIG. 8). For example, a horse icon for a favorite horse race contestant may be shown in blue while a horse icon for a lesser favorite horse race contestant may be shown in purple (see, e.g., the color chart 1000 of FIG. 10). In an embodiment of the at least one wagering terminal, each differing shaded/color icon is associated with a race contestant based on the win odds associated with the race contestant. If two race contestants have the same win odds, then the amount wagered on the race contestant in the win pool (if available) is used to select the favorite. Otherwise, whichever race contestant has the lower number assignment will be considered more favorite. In another embodiment of the at least one wagering terminal, each differing shaded/color icon is associated with a race contestant based on the amount wagered on the race contestant. As will be apparent to those skilled in the art, any number of means of assigning one or more colors reflecting odds associated with a race contestant may be used.

In an embodiment, a user may place wagers according to the user's risk profile by using handicapping information with odds shopping and using colors and other indicators to present choices according to the user's risk profile to the user. For example, different users may have different preferences and tolerances for risk/reward. Some users may favor long shots while other users may prefer wagering the favorites. So, in an embodiment, the user can indicate the user's risk/reward profile in setting up a wagering account or by indicating a desired risk/reward profile on a wagering screen of the at least one wagering terminal. For example, a button/icon on the at least one wagering terminal may allow the user to request race contestant wagering information according to a selected profile such as a long-shot profile or a favorites profile. More detailed profiles, as identified above, can also be inserted at the beginning of play or entered into a permanent player profile.

Handicapping information may be provided using gaming industry terminology and formats. For example, in at least one embodiment, handicapping information may be provided in accordance with the Running Style-Position (RS-Pos™) methodology available from Handicappers Data Warehouse (HDW), Inc. of Georgetown, Ky. The Running Style-Position methodology is a complete methodology that is designed to help users understand the race event (e.g., a horse race event) and may be used alone or to supplement another handicapping methodology. By assigning a descriptive label on each race contestant (e.g., horse), the similarities and differences between race contestants and the race events can be identified, thereby allowing the user to view the handicapping process from a new and different perspective. This method may involves two major components determining projected “RS” (Running Style), and determining projected “Pos” (position).

The projected “RS” may be determined, for example, prior to the race event. The projected “RS” attempts to project how the race contestant can win the race event, while the actual running style, after the fact, may indicate how the race contestant actually ran the race event. For example, every paceline in the race contestant's past performance may have a projected “RS” and an actual running style. In an embodiment, multiple major categories of running styles may be used, including, but not limited to: “E” “EP”, “P”, “PS”, “S”, “SS”, and “U” as defined below in Table 1 for an actual winning “RS.”

TABLE 1

| Running Style | Description | |
|---|---|---|
| E | Early | A win where the horse goes wire to wire |
| EP | Early Presser | A win where the horse is within 1 length of the |
| | | leader at the ¼ mile call |
| P | Presser | A win where the horse is within 1 length of the |
| | | leader at the ½ mile call |
| PS | Presser Sustained | A win where the horse is within 1 length of the |
| | | leader at the stretch call |
| S | Sustained | A win where the horse does not qualify for any of |
| | | the above but is never more than 7 lengths off the |
| | | pace or positioned farther back than seventh |
| SS | Slow Sustained | A win where the horse does not qualify for any of |
| | | the above, in other words, a deep closer |
| U | Unknown (or Ugly) | The horse has not demonstrated it's running style |
| | | yet |

Every race contestant's projected “RS” may be defined by the way the contestant has won recent race events. For example, the projected “RS” may consider the last three, last four or last five wins (any other number determined to be useful may also be used). According to this example, if a race contestant has won only as an “E” then that contestant may be projected as an “E”; if, however, the contestant has won as an “E” and an “EP” then that contestant may be projected as an “EP.” Furthermore, if the contestant has won as an “E”, “EP”, and “P” then that contestant may be projected as a “P”. In each case, the running style furthest off the pace when the race contestant has won with more than one running style may be selected. The RS-POS™ method of projection can be used as a powerful elimination tool, and may further include additional subcategories and subtleties beyond those described here. By defining the running styles of the race contestants, a picture of the race is will begin to evolve.

By way of example, an “E” race contestant is likely going to try to win wire to wire. A “PS” race contestant, on the other hand, may not get involved in the early going and will not put any pressure on the early pace. In fact, the “PS” race contestant may not get involved in the race until the stretch if he is to win. An “SS” race contestant may be at the back of the pack, won't put any pressure on any part of the race, and will win probably on the last stride. The “SS” race contestants typically do not win their fair share of race events. The specific definitions described above may provide an opportunity to predict a race contestant's chance of winning by only knowing the contestant's projected “RS”. For example, an “EP” race contestant that is slower than the “E” contestant in the race event has a reduced chance of running his best race. A “PS” race contestant, whose stretch pace ratings are inferior to all other contestants, cannot run his best race. A “P” race contestant that has never run a half-mile close to others in the race event has a small chance of running his best race. With a little bit of experience, a user can quickly review the RS-Pos™ reports and immediately see which race contestants have a good chance of winning, and which have little or no chance of winning.

The “Pos” portion of RS-Pos™ may be calculated by predicting how fast each race contestant can run based on, for example, the best time a contestant has actually run in the last 10 race events. A very high correlation between this ranking and finish position has been found in practice. Applying this, of the race contestants with the best times (e.g., “B¼”) for each of the last 10 race events, the contestant that ranks first will win more race events than the contestant that ranks second, who will win more than the contestant that ranks third, who will win more than the contestant that ranks fourth, etc. The race contestant that ranks seventh will most likely be seventh at the first call and will most likely finish seventh. This fact gives us a powerful tool to use in handicapping.

Such RS-Pos™ information may be provided as raw speed information and need not be adjusted in any manner. Race contestants that can run fast have demonstrated that they can run fast. An error is to try to make some type of adjustment to the raw speed data. However, when a race contestant moves from a very fast track to a very slow track, the contestant slows down; however, not all contestants will slow down by the same amount. Conversely, to assume that race contestants speed up when moving from a slow track to a fast track can be incorrect, because not all contestants do. However, “E” race contestants may be more affected than “S” contestants. What is very difficult to determine with any accuracy is by now much.

By combining the two types of information, running style and position, the RS-Pos™ methodology may provide a descriptive label that uniquely identifies each contestant in a race event, for example: E1, P4, PS5, S7, EP2, SS13. Once these labels are applied, the understanding of each race event may be greatly improved, and the reasons why certain race contestants win or lose become much more evident. While the number of different race scenarios is still large, the user's understanding of the race event using the RS-POS™ methodology may provide the user with a significant edge. Some example applications are set forth as follows.

For example, a lone E1 race contestant with an inside post will get the lead 60% of the time and will win 50% of the time that he gets the lead. If that contestant has been in races in his recent past where he has been an E3 or E5 or not alone (not the only E), he can go wire to wire today at a big price. “P” race contestants tend to place more than they show, and very often a morning line favorite P5 or P6 will be the place contestant and not the win contestant. A P1 will run his best race when he is outside, ridden for example by a jockey that likes to track, and is behind an E1 and E2. An S7 can't win on his own the contestants in front of him have to go to fast and set the race up for him, and the S7 must have final times far superior to an EP 1 in the same race event if he is expected to beat him. “S” race contestants may show more than they win and are key to playing trifectas. An E7 is more likely to run last than first, and at times are favored to win without any significant chance of doing so. In a horse racing example, “Cigar” was almost always a P2 or P3 in his races, but in the Breeder's Cup he was a P7 with “Alphabet Soup,” an EP 1. Furthermore, in a horse racing context, the user may soon begin to notice that certain jockeys have strong preferences for a particular position that they would like to obtain, and will do fine if the horse happens to be capable of getting to that position, but fall otherwise. Horses will finish better when the jockey matches the horse's position or takes back from that position. However, horses perform worse when the jockey moves them forward of their preferred position. For example, a P4 will fare better from fourth position than from first. An EP6 doesn't fit the race. “E” horses tend to run first and third, “P” horses tend to run second, “S” horses tend to run third more than they win, etc. Horses that are first, second, and third at the ¼ mile win about 60% of the races, and the running style position methodology readily identifies these horses to the user. Exemplary codes for use with the RS-Pos™ handicapping methodology are included in an Appendix to this specification, which Appendix is herein incorporated by reference as if set forth fully herein. With a risk/reward profile selected, handicapping data showing estimated probability of race contestants finishing in specific positions can be matched against current odds to find wagering opportunities where the user may have a positive return on investment. The determination of the profiled race contestant wagering information can be performed in the at least one wagering terminal or performed at the race providing system and then fed to the at least one wagering terminal. In an embodiment, different odds shopping algorithms may be employed and may be triggered to be used by a user.

The at least one wagering terminal may then present the profiled race contestant wagering information according to the user's profile to allow the user to choose a wager that fits the user's profile. In an embodiment, the user interface 305 can use color, position, symbols, flashing, etc. to present the profiled race contestant wagering information in order to allow the user to choose a wager that has been partially handicapped automatically by the system. For example, the horse head icons described in more detail below may be provided in different specific color or have another indicator to signify the preference of the race contestants according to the user profile. A chart may be provided on or near the at least one wagering terminal to instruct the user on the significance of the color or other indicator. In another embodiment, specific wagers, race contestant selections and/or wager amount may be presented to the user in accordance with the user's risk profile. For example, two particular horse head icons may be flashing on a wagering screen of the at least one wagering terminal with an indication to wager those race contestants in an exacta wager for a certain amount.

The wagering processor 360 may also be configured to display the potential estimated winning payout of a wager on one or more race contestants of a race event according to the wager type of or selected in the at least one wagering terminal. For example, a wagering terminal configured for or in which is selected, an exacta wager type may present on a display (see, e.g., the ticker-type display of FIG. 4 and associated description below) a combination of race contestants (such as horse 5 and horse 3) of the race event about which information is shown on the display (see, e.g., the CRT display of FIG. 4 and associated description below), that may yield a certain estimated winning payout (such as $10,000 if horse 5 and horse 3 finish in that order in first and second place). In an embodiment, the greatest potential estimated winning payout(s) (and associated race contestant(s) that need to be selected to win the estimated payout(s)) is displayed according to the wager type of or selected in the at least one wagering terminal and the race event displayed on the at least one wagering terminal. In another example, a wagering terminal (e.g., configured for or in which is selected a superfecta wheeler wager type) may present on a display (see, e.g., the ticker-type display of FIG. 4 and associated description below) the current pool total of the race event about which information is shown on the display (see, e.g., the CRT display of FIG. 4 and associated description below), such that perhaps a certain unique winning wager combination of the superfecta wager type may yield a payout of the pool (“jackpot”).

The wagering processor 360 may also be configured to receive wager information from the user interface 305 and for selecting one or more race contestants for the wager. For example, the wagering processor 360 may receive through the user interface 305 an instruction for a wager amount, for an elected race event, which is transmitted to the race providing system together with the elected race contestants once the user instructs through the user interface 305 the submission of the wager. In an embodiment, referring to FIGS. 4 and 5, the at least one wagering terminal has buttons corresponding to certain wager amounts and/or combinations which when engaged by the user instruct the wagering processor 360 the wager amount and/or combination and a play button which when engaged by the user instructs the wagering processor 360 to submit the wager. In an embodiment, the wagering processor 360 may employ a default wager amount and/or combination, e.g., the lowest wager amount and/or the quick pick race contestants, when it is not instructed the wager amount and/or combination through the user interface 305 but is instructed to submit the wager.

Through the user interface 305, the user also can manually select the one or more race contestants for a wager or select that a set of quick pick race contestant(s) as provided in the quick pick race contestant(s) buffer 340 is used for the wager. As discussed below, the one or more sets of quick pick race contestant(s) may be supplied in a substantially continuous fashion to the wagering processor 360 and/or as requested by the wagering processor 360 (typically via the quick pick race contestant(s) buffer 340). In an embodiment, the user can manually select one or more race contestants for a wager by touching a touch-sensitive screen of the display or may select a set of quick pick race contestant(s) by pressing the “Play” button of the at least one wagering terminal. In an embodiment, the wagering processor 360 may employ one or more race contestants from a set of quick pick race contestant(s) to complete a wager if all the necessary race contestants for the wager type have not been selected but the wagering processor is instructed nevertheless to submit the wager. In this fashion, the wager will comprise the race contestant(s) selected by the user and one or more race contestant(s) from the quick pick race contestant(s) needed to complete the wager of the applicable wager type.

The wagering processor 360 may also be configured to show on the display the race contestants (usually in symbolic form, rather than real images of the race contestants) that have been manually elected by the user or the race contestants in a set of quick pick race contestant(s). For example, in an embodiment, the user selection of a race contestant on a touch-sensitive display causes an icon corresponding to the race contestant to change in appearance to indicate the race contestant has been selected. Similarly, the icons of quick pick race contestant(s) may change in appearance to indicate their selection.

The wagering processor 360 may also be configured to receive information regarding the sufficiency of credit in a user's account from the account processor 360 and to provide the amount wagered and the outcome of the elected race event to the account processor 360 for crediting and/or debiting a user's account.

The wagering processor 360 may also be configured to provide a prize to a user upon the submission of a wager. For example, the submission of a wager may trigger, according to a prize selection algorithm, the provision of a prize to the user, for example, in the form of a credit of the user's account or a credit or other type of prize on a ticket provided from the ticket dispensing device. In an embodiment, the prize selection algorithm may simply be a random seed or else the prize selection algorithm may determine to provide a prize after every certain amount of wager submissions through the wagering terminal. In another embodiment, where the prize selection algorithm is implemented across the wagering system, the prize selection may determine to provide a prize to a particular wagering terminal after every certain amount of wager submissions through wagering terminals throughout the wagering system.

The wagering processor 360 may also be configured to select one or more race contestants, according the applicable wager type, which represent the least chosen one or more race contestants for the wager type, particularly the one or more race contestants for the wager type that will yield a payout of the entire pool. Such selected race contestant(s) may determined using the odds information and/or betting pool information or may be provided by the race providing system. In an embodiment, a button (titled, for example, “Jackpot” button) is provided to allow the automatic selection of such one or more race contestants for a wager.

In an embodiment, the wagering processor provides one or more bonus picks to provide additional ways for a user to win and win larger payouts. By tying into a “jackpot” or bonus pool in addition to the regular wagering of race events, new ways to win are provided to users. A bonus pick is a selection of a race contestant from the remaining race contestants in the race event not included in the user's wager or other bonus picks. In an embodiment, the selection of the race contestant is random.

Alternatively, the selection may be performed according to an algorithm. A user wins a bonus prize if each of the bonus picks finishes in exact order following the finish of the user's chosen winning race contestants. For example, in the case of a win bet, the 1^{st} bonus pick horse must finish 2^{nd} if the chosen horse finishes 1^{st}. Similarly, in the case of a place bet, the 1^{st} bonus pick horse must finish 3^{rd} if the chosen horse finishes 2^{nd} Accordingly, the results for the whole field of race contestants for a race event (not just the 1^{st} 4 finishers) will usually need to be known to determine the payout for a winning bonus pick(s).

In an embodiment, the at least one wagering terminal or the race providing system may provide 1 to 4 bonus picks (or none at all). Where the at least one wagering terminal makes the bonus pick selection, the bonus picks are sent to the race providing system for record keeping in a database and to facilitate payout. If the race providing system makes the bonus pick selection, the bonus pick(s) are maintained in a database and a feed of the bonus picks is provided to the at least one wagering terminal by the race providing system. The number of bonus picks or whether bonus picks are offered at all can be configured in various ways. For example, the number of bonus picks selected may simply be random or may depend on the amount wagered, the specific configuration of the at least one wagering terminal, the wager type, or any other type of algorithm. If a bonus pick(s) is provided, it is typically added to every wager placed on the at least one wagering terminal.

The pool out of which the bonus prize(s) for a winning bonus pick(s) is paid out may be funded by a one or more of: 1) a set aside of a percentage of the wagering handle; 2) an additional contribution by the race event track(s); and/or 3) a wager surcharge. In an embodiment, the pool may be underwritten by an insurance policy to ensure the bonus prize(s) can be paid. As is apparent, the pool for the bonus prize(s) may be separate from the pari-mutuel pool typically used for race event wagers through the at least one wagering terminal. Optionally, the pool for the bonus prize(s) may be added to or be a part of the pari-mutuel pool.

The payout of the bonus prize for the winning bonus pick(s) may be determined by: 1) the size of the entire bonus pool; 2) the straight odds of winning the entirely random segment (bonus picks) of the wager; 3) the effective payout or odds of winning the user's wager (whether composed of actual user race contestant pick(s) and/or quick pick race contestant(s)); 4) an actuarial based approach to determine the bonus prize(s); or 5) a pari-mutuel approach with a jackpot and reserve similar to lottery systems.

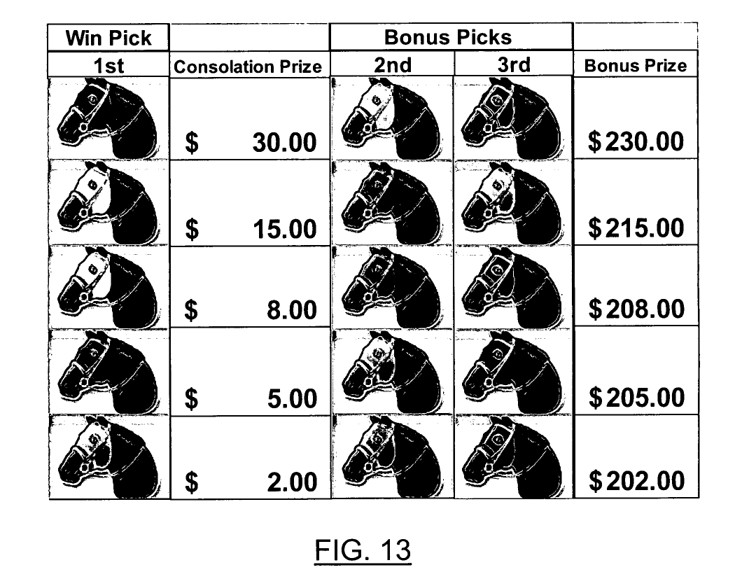

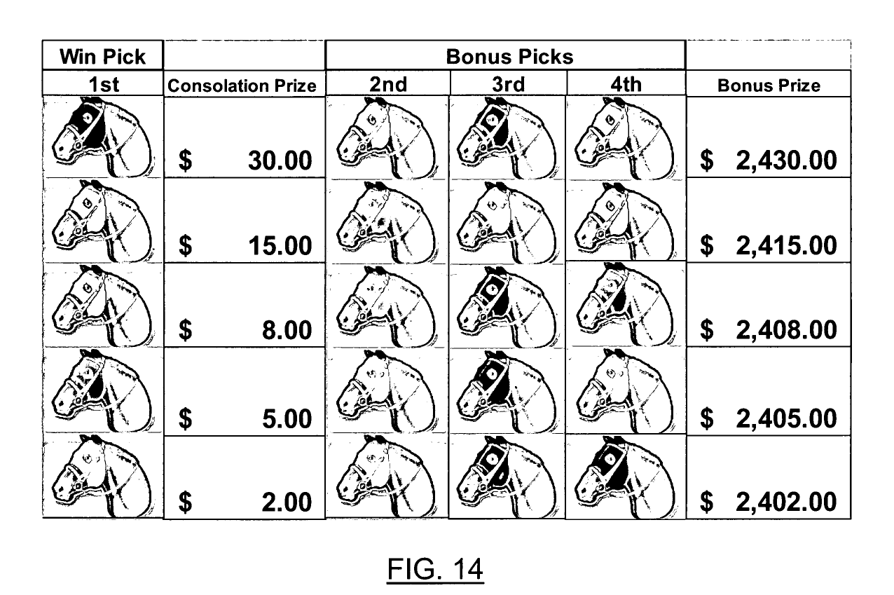

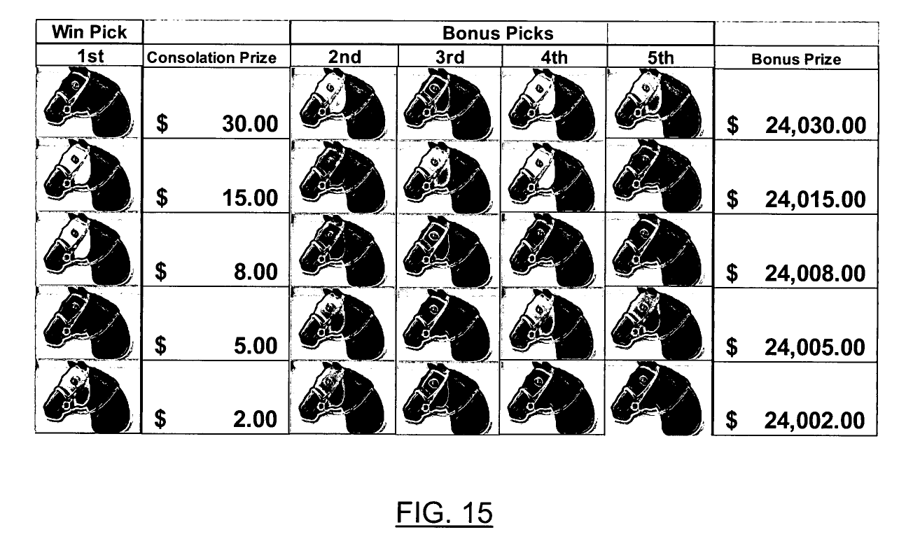

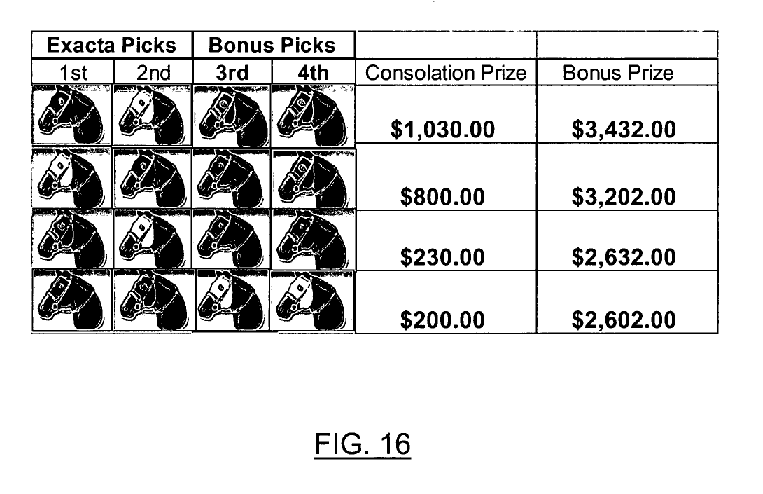

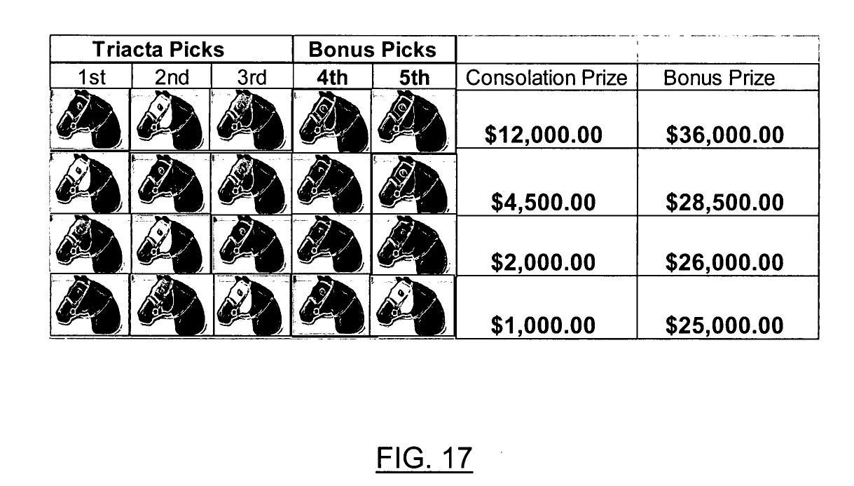

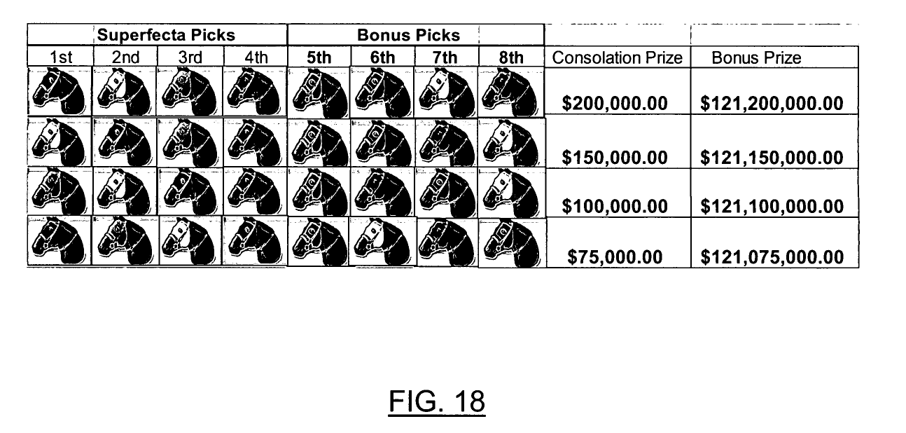

Referring to FIGS. 12 to 18, sample estimated payout tables for various wagers and an associated bonus pick(s) are shown. In an embodiment, the payout table(s) may be provided on the at least one wagering terminal, e.g., on the display of the at least one wagering terminal. FIG. 12 shows a sample estimated payout table for a win wager with one bonus pick. The “Consolation Prize” column lists the estimated payouts for the basic win wager for several race contestants shown in the column “Win Pick”. The “Bonus Prize” column lists the bonus prize for each race contestant shown in the “Win Pick” column if the corresponding bonus pick race contestant in the “Bonus Pick” column comes in 2^{nd} place behind that race contestant shown in the “Win Pick” column. In this example, the bonus prize is the consolation prize plus 10% of the total odds (which in FIG. 12 amounts to $20). FIG. 13 shows a sample estimated payout table for a win wager with two bonus picks. As in FIG. 12, the “Consolation Prize” column may list the estimated payouts for the basic win wager for several race contestants shown in the column “Win Pick”. The “Bonus Prize” column may list the bonus prize for each race contestant shown in the “Win Pick” column if the corresponding bonus pick race contestants in the “Bonus Picks” column comes in 2^{nd} and 3^{rd} place behind that race contestant shown in the “Win Pick” column. In this example, the bonus prize is the consolation prize plus 10% of the total odds (which in FIG. 13 amounts to $200). FIG. 14 shows a sample estimated payout table for a win wager with three bonus picks. FIG. 15 shows a sample estimated payout table for a win wager with four bonus picks. FIG. 16 shows a sample estimated payout table for an exacta wager with two bonus picks. FIG. 17 shows a sample estimated payout table for a triacta wager with two bonus picks. And, FIG. 18 shows a sample estimated payout table for a superfecta wager with four bonus picks.

In an embodiment, a separate (that is a distinct ticket, with wagering information on only the bonus event(s) in play, although a ticket may issue with an underlying wager information and the bonus free wager information) ticket may be issued incorporating the details of the user's wager and providing the bonus pick(s). Alternatively, the bonus pick(s) may be provided on the same ticket of the wager in association with which the bonus pick(s) are provided. In an embodiment, the ticket having the bonus pick(s) may be provided with a bar code to track and facilitate payout of the bonus prize(s) for a winning bonus pick(s).

In a variation (not shown), the user interface may include a reselect button for initiating reselection of the race contestants, and the wagering processor 360 may be configured to reinitiate selection of race contestants upon receipt of the reselection command from the user interface 305. In this variation, the wagering processor 360 may be configured to issue a command to the race providing system to provide a one or more new sets of quick pick race contestant(s) and then to select from the one or more new sets of quick pick race contestant(s) provided by the race providing system. In this manner, the wagering processor 360 typically selects different quick pick race contestant(s) for each actuation of the select button.

The details of the wagering process of an embodiment, as facilitated by the processing instructions of the wagering processor 360, are explained in greater detail below in regards to FIG. 7.

In an embodiment, a portable wagering terminal module may be provided with memory 355 to cooperate with the CPU 330 and network interface to support interoperability with various race providing systems. Race providing systems typically have proprietary protocols for communications of race information. Accordingly, to communicate with disparate race providing systems, the at least one wagering terminal may support a plug-in software module to provide the interface between the at least one wagering terminal and the race providing system(s) with which the at least one wagering terminal communicates. One side of the module defines an application programming interface based on the behaviors provided by and the requirements of the at least one wagering terminal. The other side of the module will provide serial and/or flexible networking services for the race providing system. A race providing system vendor (or other party) would be able to rapidly adapt existing terminal code to create a plug-in module for use in the at least one wagering terminal. The portable module will define means to specify the capabilities supported by the portable module and plug-in module(s). The at least one wagering terminal will query those capabilities and determine the best way to utilize the race providing system. Accordingly, the race providing system vendor will not need to disclose its protocol in detail and the at least one wagering terminal vendor will not have to share the wagering terminal design.

Turning now to FIG. 4, an embodiment of the at least one wagering terminal 120 is shown comprising a display 300 for presenting information about the selected race events, a user interface 305 for viewing race event information and placing wagers on an elected race event, a card read/write device 310 for receiving an electronic, optical or magnetic-stripe card encoded with a user's account information, a ticket dispensing device 315 for providing a ticket comprising wager information for an elected race event and a stand-up type housing 400 for retaining the display 300, the user interface 305, the card read/write device 310 and the ticket dispensing device 315. The wagering terminal 120 may also include a processor 320 (not shown) as discussed above for facilitating wagering on race events. The wagering terminal 120 may also include a speaker (not shown) for playing audio associated with the wagering and race events information.

Preferably, the at least one wagering terminal 120 according this embodiment may be configured for providing a wager in only a single wager type, and the housing 400 includes a wager description, prominently displayed on the housing 400, identifying the wager type using words which explain the wager type in simple betting terminology.

For example, the at least one wagering terminal 120 may be configured to provide a win, place, show, win-place-show (a win, place and show bet on a particular race contestant), exacta, trifecta, superfecta, exacta and wheels, trifecta and wheels and superfecta and wheels wager type. Example wager descriptions include “Pick a Winner”, “Pick Two Exact Order”, and “Pick Three Exact Order”. In an embodiment, the wager type of the at least one wagering terminal 120 can be changed, for example, by manually configuring the at least one wagering terminal 120 from one wager type (e.g., exacta) to another wager type (e.g., place) or by issuing a configuration change command from the race providing system to the at least one wagering terminal 120 to cause the at least one wagering terminal to change from one wager type (e.g., exacta) to another wager type (e.g., place). Optionally, the configuration change command can be issued to the at least one wagering terminal 120 that in its current configuration is able to process a wager type that is not available for a next race event (about which information is made available for display and wagering on the at least one wagering terminal 120).

The display 300 may comprise a CRT display 410 for displaying information regarding the race events and ticker-tape type display 420 for displaying select wagering information regarding the race events. Preferably, the CRT display 410 comprises a touch-sensitive CRT display, including a touch-sensitive membrane (not shown) in communication with the processor for “scrolling” between next and previous race events and race event tracks and for manually selecting race contestants for an elected race event. As will be apparent to those skilled in the art, any appropriate type of display may be used.

The user interface 305 may comprise a series of wager buttons 430, 440 for accepting wagers in certain wager (e.g., dollar) amounts and/or combinations. For example, referring to FIG. 4, button 430 may be engaged for a $1 wager amount and button 440 may be engaged for a $5 wager amount. Although not shown in FIG. 4, the wager buttons may also represent certain wager combinations, e.g., exacta and 2 wheels (see, e.g., buttons/icons 1010 in FIG. 10). The user interface also includes a bet submission button 450 for initiating transmission of a wager to the race providing system.

Turning to FIG. 5, another embodiment of the at least one wagering terminal 120 is shown comprising a display 300 for presenting information about the selected race events, a user interface 305 for viewing race event information and placing wagers on an elected race event, a card read/write device 310 for receiving an electronic or magnetic-stripe card encoded with a user's account information, a ticket dispensing device 315 for providing a ticket comprising wager information for an elected race event and a table-top type housing 500 for retaining the display 300, the user interface 305, the card read/write device 310 and the ticket dispensing device 315. The wagering terminal 120 may also include a processor 320 (not shown) as discussed above for facilitating wagering on race events. The wagering terminal may also include a speaker (not shown) for playing audio associated with the wagering and race events information.

The display may comprise a CRT display 510 (or any other visual display, including but not limited to LED, liquid crystal, plasma display, fault screen, reflection system, backlit system, or the like) for displaying information regarding the race events and preferably, the CRT display 510 comprises a touch-sensitive CRT display, including a touch-sensitive membrane (not shown) in communication with the processor for selecting the desired wager type, for selecting the desired wager amount, for “scrolling” between next and previous race events and/or next and previous race event tracks, for manually selecting race contestants for an elected race event and for initiating transmission of a wager to the race providing system. As will be apparent to those skilled in the art, any appropriate type of display may be used.

Preferably, the at least one wagering terminal 120 according to this embodiment is configured for providing a wager in a plurality of wager types, although as will be apparent it may be configured for a single wager type. Information presented on the display 300 will facilitate easy selection of the wager type. For example, each time the user touches a portion of a touch-sensitive screen of the display 300 associated with a button/icon to change the wager type of the at least one wagering terminal 120, the user scrolls through the various wager types offered by the at least one wagering terminal 120. Each time the user scrolls through the wager types offered by the at least one wagering terminal 120, the information regarding race events is presented according to the selected wager type. Alternatively, for example, the selection of the wager type may be performed by selecting a desired wager type in a menu presented on the display or by selection of icons corresponding to specific wager types offered by the at least one wagering terminal 120.

It should be understood that the configurations shown in FIGS. 4 and 5 are only an implementation for an at least one wagering terminal 120, and that other configurations are also envisaged. In a variation, not shown, the user interface includes a plurality of wager type buttons, each identifying a respective wager type (e.g., win, place, show, exacta, etc.), for facilitating placement of the wager according to one of a plurality of wager types.

In an embodiment of the at least one wagering terminal 120for a trifecta wager type or the at least one wagering terminal 120 capable of selection of a trifecta wager type, a button and/or display icon may be provided for placing a $1 trifecta wager amount for the three selected race contestants in the exact order as selected and another button and/or display icon may be provided for placing six $1 trifecta wager amounts on the three selected race contestants in any order. Similarly, in an embodiment of the at least one wagering terminal 120 for a superfecta wager type or the at least one wagering terminal capable of selection of a superfecta wager type, a button and/or display icon may be provided for placing a $1 superfecta wager amount for the four selected race contestants in the exact order as selected and another button and/or display icon may be provided for placing 24 $1 superfecta wager amounts on the four selected race contestants in any order.

In an embodiment of the at least one wagering terminal 120 for an exacta and wheel wager type or the at least one wagering terminal 120 capable of selection of an exacta and wheel wager type and referring to FIG. 10, a number of buttons and/or display icons 1010 may be provided for placing various combinations and amounts of wagers according to this wager type. For example, there may be provided a button and/or display icon for placing a $1 exacta wager amount for the two selected race contestants in the exact order as selected, a button and/or display icon for placing two $1 exacta wager amounts on the two selected race contestants in any order, a button and/or display icon for placing a $5 exacta wager amount for the two selected race contestants in the exact order as selected, a button and/or display icon for placing two $5 exacta wager amounts on the two selected race contestants in any order, a button and/or display icon for placing a $10 exacta wager amount for the two selected race contestants in the exact order as selected, and buttons and/or display icons each for placing X (where X is greater than or equal to two) number of $1 exacta and wheel wager amounts on the one selected exacta race contestant and the X selected wheel race contestants selected.

In an embodiment, the pari-mutuel wagering terminal configurations shown in FIGS. 4 and 5 may be constructed using gaming cabinets, peripherals, operating systems and software that are certified for use in a slot machine application. By using slot machine equipment, the wagering terminal has a greater resale value by providing a larger market and range of applications in which the equipment can be used, allows the wagering terminal 120 to provide features requiring a greater level of security, e.g., cash handling, and gives regulators, users, tracks and other stakeholders a greater sense of confidence in the wagering terminal 120 because it is wholly or partially certified by a set of rigorous and mature standards compared with those of the pari-mutuel industry. Further, using slot machine equipment allows the at least one wagering terminal 120 to additionally offer slot or other casino-type gaming if the at least one wagering terminal 120 is properly configured with appropriate hardware and software.

In an embodiment, a virtual private network (VPN) concentrator may be provided o streamline performance of one or more wagering terminals and other devices. The deployment of a wagering terminal(s), signup kiosk(s), telephones and network connected handheld computing devices into a facility can pose a variety of challenges for security, reliability, and scalability. For example, wagering terminals streaming audio/video from an Internet source should not have to retrieve multiple copies of the data stream, but rather should share a single copy within the facility. Wagering terminals and other devices should not require wiring and configuration changes depending upon the type of network access. Wagering terminals and other devices should be “plug and play” and require only physical wiring for power. Telephones and network connected handheld computing devices used to support staff at the facility should not depend on or assume infrastructure capabilities of the facility itself. Accordingly, there is provided a concentrator device to streamline provisioning and to provide a simple, efficient, reliable and secure means for installing the above mentioned terminals and devices in a facility.

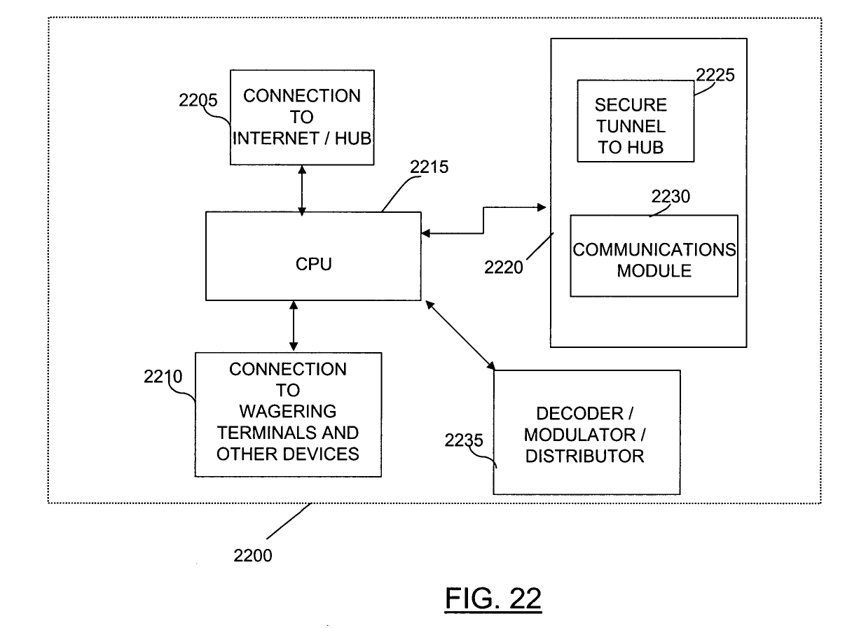

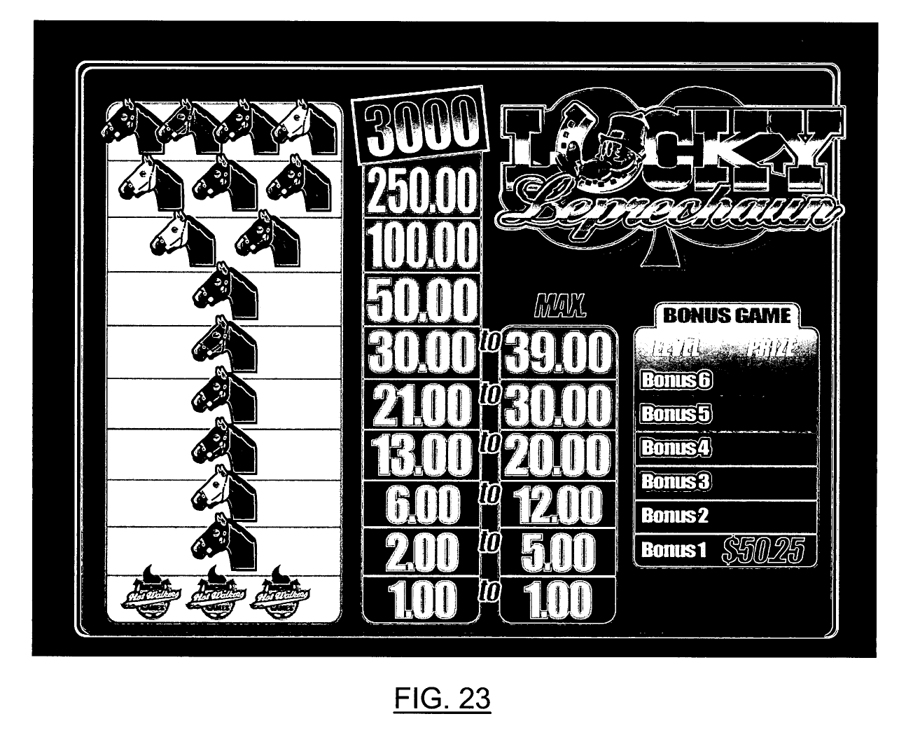

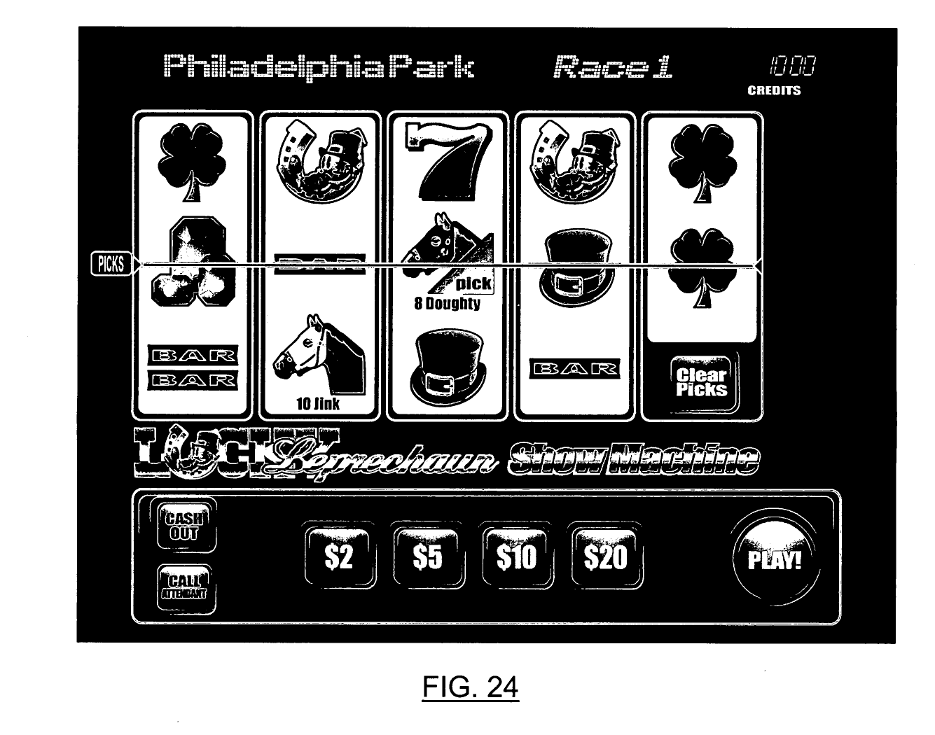

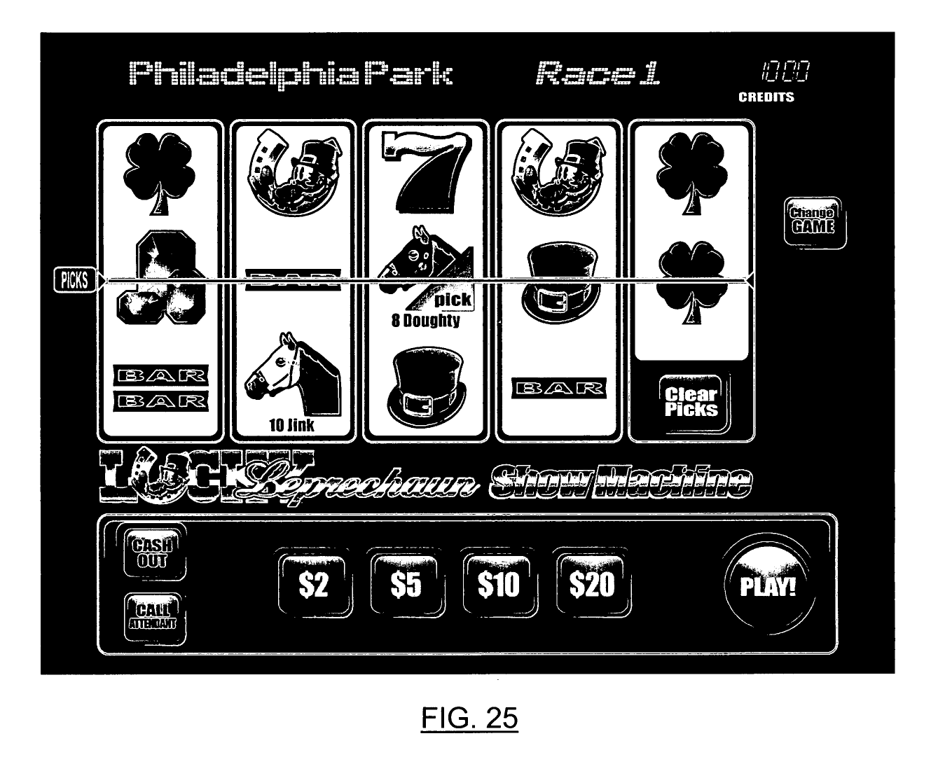

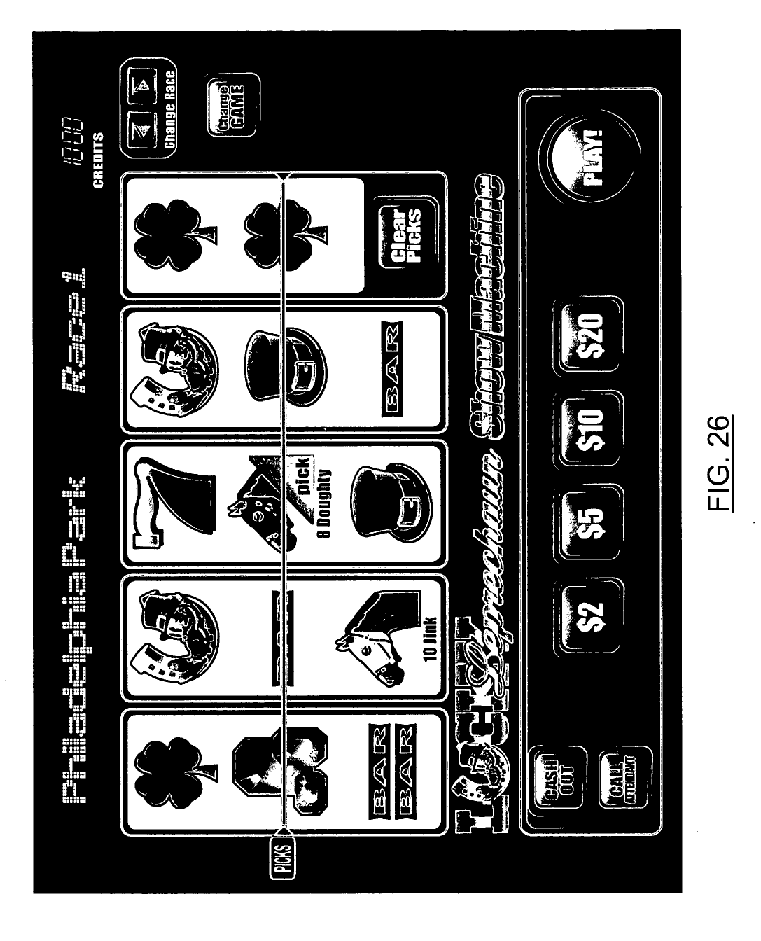

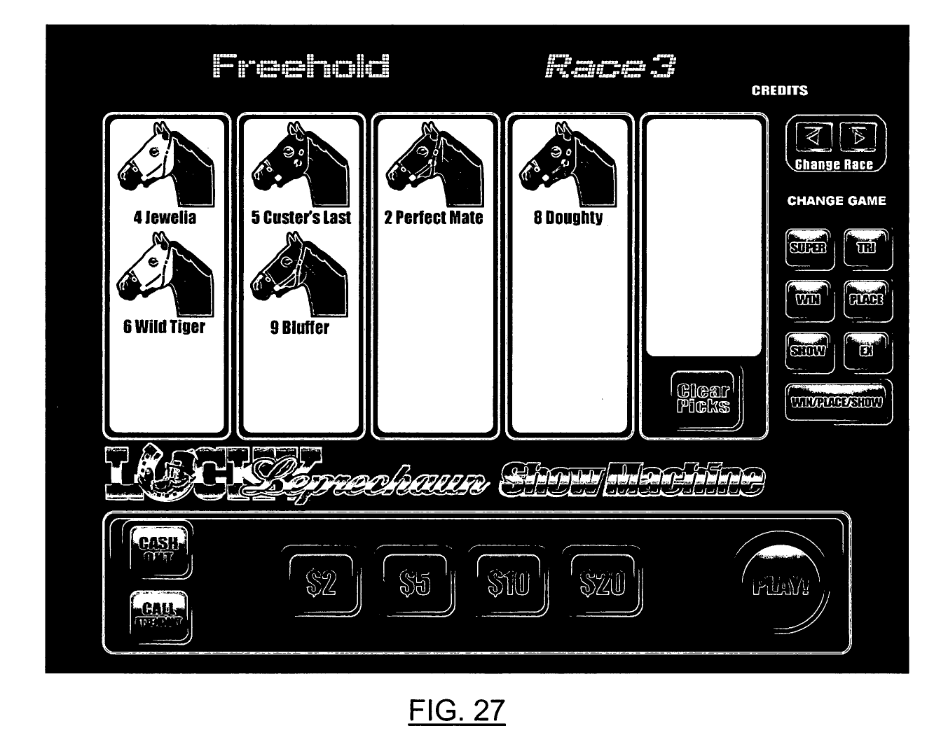

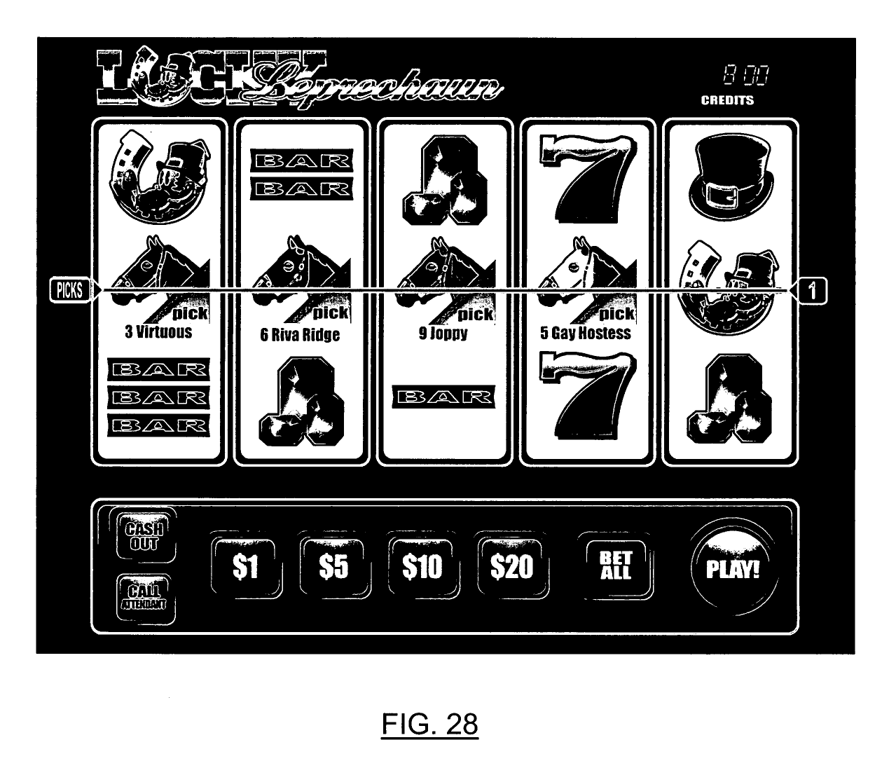

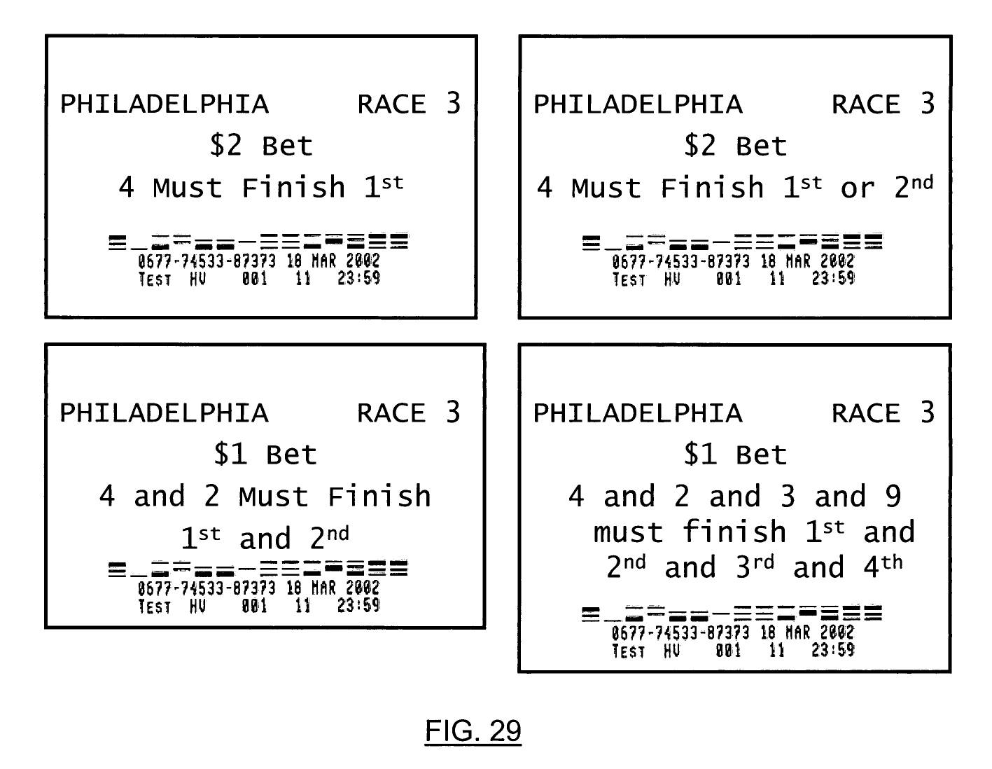

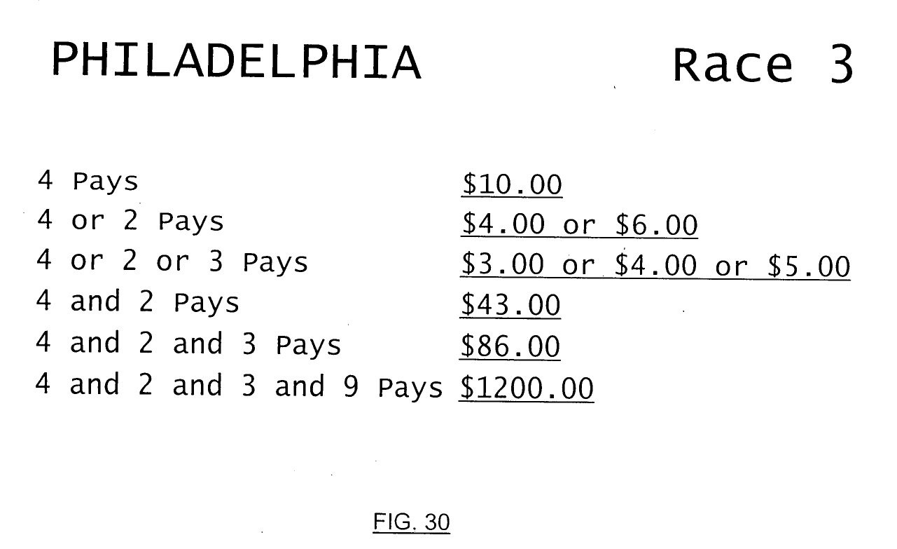

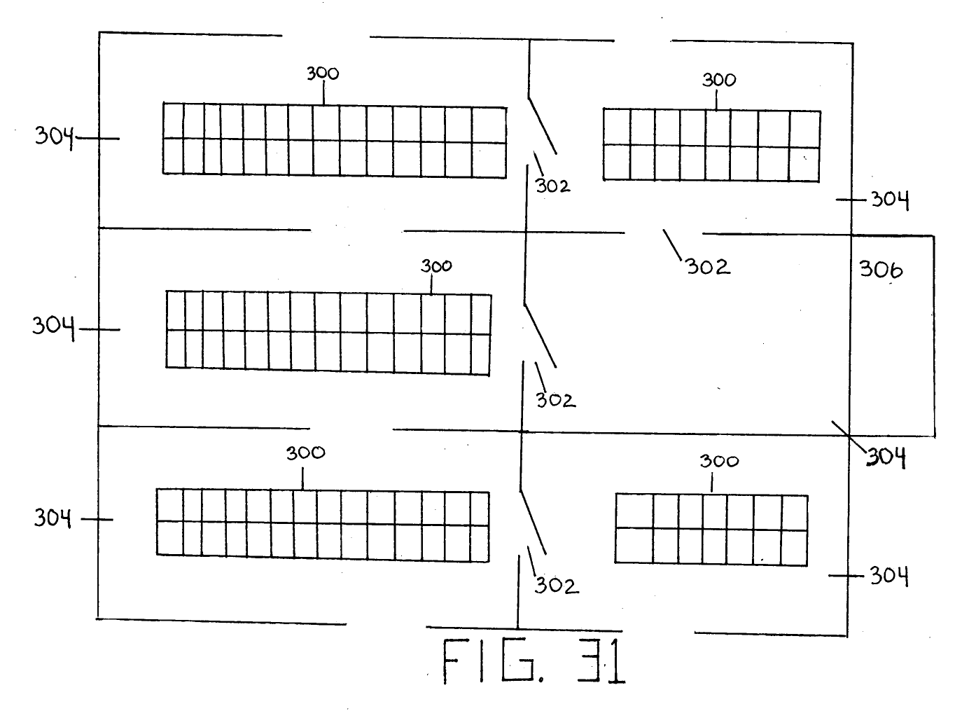

The VPN concentrator may include hardware/software to provide VPN Internet connectivity to facilities, particularly facilities currently served by hardwired wagering devices. Referring to FIG. 22, the VPN concentrator 2200 may include a hardware device and software modules that provide: 1) a secure tunnel 2225 (via IPSec or similar means) between the wagering terminals and other devices and a hub, such as the account wagering clearing service described above; 2) a wired or wireless connection 2210 for the wagering terminals and other devices to connect to the VPN concentrator; 3) a wired or wireless connection 2205 for the VPN concentrator to connect to the Internet and/or the hub; and 4) a software module 2230 to facilitate structured communications between the wagering terminal and other devices and the hub. The VPN concentrator may further comprise a central processing unit 2215 communicating with the various connections. Further, the VPN concentrator may also comprise a memory 2220 that communicates with the CPU and comprises the secure tunnel software and the software module to facilitate structured communications.

Thus, the VPN concentrator 2200 may provide at least one or more of the following functions: 1) a wireless networking access point for wagering terminals, signup kiosks and handheld computing devices; 2) a wireless telephony access point for telephones used at the facility in relation to the wagering terminals; 3) a decoder 2235 to downlink satellite signals for race event audio/video; 4) a gateway to WAN networking services, i.e. CSAT, cable, DSL, etc. available through the hub; 5) a RF modulator 2235 to pipe downlink audio/video onto facility cable TV wiring; and 6) a distributor 2235 for streaming audio/video to allow one copy of an audio/video stream to be shared by the wagering terminals and other devices at the facility.

In another variation, the at least one wagering terminal may be a personal computer or a handheld device with all wagering functions provided on the display of the personal computer or handheld device for selection by use of a pointing device and/or designated keys on a keyboard associated with the personal computer or handheld device. In this variation, an electronic wager ticket mechanism may be provided in place of a physical wager ticket dispensing device. The electronic wager ticket mechanism would generate an electronic representation of the wager ticket that may be presented, for example, graphically on the display of the at least one wagering terminal. Further in this variation, a user may provide the relevant account information to the at least one wagering terminal instead of introducing an electronic or magnetic-stripe card to a card read/write device. For example, the user may manually enter the account information or employ any other electronic wallet or other automatic means for making the account information available to the wagering system. Many other variations of the wagering terminal will be apparent to those of ordinary skill in the art.

Turning to FIG. 6, an embodiment of a screen shown on a CRT display of a stand-up type at least one wagering terminal is depicted. The screen depicts information regarding Race 1 at the Los Angeles horse race track. More particularly, race event track information 600 (“Los Angeles”) and the race event number information 605 (“Race 1”) are shown. The screen also depicts account balance information 610 regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers.

Further, a number of horse head shaped icons, such as horse head icon 615, associated with the race contestants of the depicted race event are shown. Moreover, the race contestant start position information, such as race contestant start position information 620 (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant may change appearance to indicate the race contestant has been selected. For example, a pick number 625 may be presented on the display to indicate the selection of the race contestant and, where applicable, the race contestant's order in selection of a set of race contestants. In an embodiment, the user can clear the selected race contestant(s) using a “Clear Picks” button/icon 630 in order to re-select one or more race contestants, as applicable, for a wager.

Further, the user may “scroll” through future race events at different race event tracks by touching the next 635 and previous 640 track buttons/icons, each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next 645 and previous 650 race buttons/icons, each touch of the icons causing the wagering processor to present, as applicable, updated information on the display corresponding to the “previous” or “next” race event by start time.

Turning to FIG. 7, an embodiment of a screen shown on a CRT display of a tabletop type at least one wagering terminal is depicted. The screen depicts information regarding Race 1 at the Los Angeles horse race track. More particularly, race event track information 700 (“Los Angeles”) and the race event number information 705 (“Race 1”) are shown. The screen also depicts account balance information 715 regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers. Further, in an embodiment, a ticker-tape type display 710 for displaying select wagering information regarding the race events, such as potential payouts for selected race event contestants for the current wager type depicted on the screen, is provided.

Further, a number of horse head shaped icons, such as horse head icon 720, associated with the race contestants of the depicted race event are shown. Moreover, the race contestant start position information, such as race contestant start position information 725 (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant changes appearance to indicate the race contestant has been selected. For example, a pick number (not shown in FIG. 7) may be presented on the display to indicate the selection of the race contestant and, where applicable, the race contestant's order in selection of a set of race contestants. In an embodiment, the user can clear the selected race contestant(s) using a “Clear Picks” button/icon 730 in order to re-select one or more race contestants, as applicable, for a wager.

Further, the user may “scroll” through future race events at different race event tracks by touching the next and previous track buttons/icons (not shown), each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next 735 and previous 740 race buttons/icons, each touch of the icons causing the wagering processor to present, as applicable, updated information on the display corresponding to the “previous” or “next” race event by start time.

As discussed above, in the tabletop type wagering terminal, the wager type presented on the display can be changed by the user by touching the “Change Game” button/icon 745. So, by using the “Change Game” button/icon, the user may change the display to present a “Win” wager type as shown in FIG. 7 or scroll to any other wager type such as place, exacta, superfecta, etc. wager types offered by the at least one wagering terminal. For the “Win” wager type, for example, the screen comprises additional buttons/icons 750 corresponding to the win wager type of the at least one wagering terminal to allow the user to select the wager amount (“$1”, “$5”, “$10”, “$20”buttons/icons) and to initiate the wager (“Play” button/icon). For other wager types, different additional buttons/icons may be provided as required by the particular wager type selected. As will be apparent to those skilled in the art, the wager type change feature may also be provided in the standup or any other type of display for the at least one wagering terminal.

A variation of the screen of FIG. 7 may also be used for a personal computer or handheld device variation of the at least one wagering terminal. In this variation, the screen of FIG. 7 or another screen could provide the ability for a user to enter account information (as discussed above) through, for example, the touching of a button/icon that initiates an account information entry dialog.

Further, audio and/or video content related to the race event displayed on the at least one wagering terminal may be provided to a user of the at least one wagering terminal. In an embodiment, the screen of FIG. 7 or another screen could permit the user to view race event video corresponding to the race event displayed on the at least one wagering terminal and a speaker of the at least one wagering terminal can provide the race event call for the race event displayed on the at least one wagering terminal. So, for example, as the race event displayed on the at least one wagering terminal changes, the race event audio and/or video would change to correspond to the displayed race event. Symbolic races scenes, using the color scheme of the odds and payouts, could be used to provide a simulated race event, with data from the wagering source and/or race track fed to the terminal or a central distributor at intervals to provide a continuous stream or segmented stream (e.g., at each eighth mile) simulated event image. In an embodiment, a separate display may be provided on the at least one wagering terminal for the race event video display. In a further embodiment, separate devices, such as televisions, monitors and speakers, may be provided in association with the at least one wagering terminal, which devices present the audio and/or video for the race event displayed on the at least one wagering terminal. The audio and/or video may be provided, for example, in a feed from the race providing system or from a cable or satellite system.

In an embodiment, the race event audio and/or video may be presented when the wagering closes on a next race event displayed on the at least one wagering terminal. So, for example, the wagering screens are presented on the at least one wagering terminal until the wagering closes for the next race event. When the wagering closes, the display of the at least one wagering terminal may be replaced with the video display of the next race event or race event information (or a portion of the wagering screen or another display associated with the at least one wagering terminal includes the video of the next race event) and the audio of the race is played over the speaker of the at least one wagering terminal. When the race event is over, the whole wagering screen may be once again presented for wagering on a next race event. Such a sequence may repeat while the at least one wagering terminal is in operation. In an embodiment, the audio and/or video of the next race event may be presented while simultaneously the wagering screen of the at least one wagering terminal is available to the user.

In an embodiment, the determination of the presentation of the audio and/or video is made based upon the feed from the race providing system indicating that the wagering on the next race event is closed. The race video and audio is then presented for as long as the last race event wagered upon is taking place. If no wager had been placed on that race event, the apparatus could and should shift to the next available race event and ignore the event on which no wager was placed. The time for the race event is determined, for example, by estimating the run time of the race event and adding extra time for delayed starts and slow race events. The time for the race event may also be determined through the feed from the race providing system or other system indicating the race event finish, e.g., the unofficial results.

In an embodiment, audio and/or video for a race event may only be presented when a user has wagered on that race event. In another variation, a user may override the audio and/or video presentation or just the video presentation in order to access the wagering screen. The race event audio and/or video may also only be displayed on or in association with specific wagering terminals, such as terminals where a user has wagered on that race event. Further, the user may selectively request presentation of the audio and/or video through for example a “View Race” button/icon instead of having the audio and/or video automatically provided. Optionally, tape delay or other buffers may be used to present the audio and/or video of a next race event in case of scheduling conflicts/overlaps with a next following race or where the user overrides the audio and/or video presentation. Previously run race events may also be presented where there is a long time gap between next race events. Thus, a scheduling algorithm manages the presentation of the audio and/or video of next race events so as to maximize wagering, such as selecting between the presentation of conflicting or overlapping race events by, for example, picking randomly, choosing the next race event at a preferred race event track or picking the race event with the largest handle.

Also, the screen of FIG. 7 or another screen could provide the display of information regarding electronic wager tickets (as discussed above) corresponding to wagers placed by the user of the at least one wagering terminal. For example, representations of unofficial electronic wager tickets corresponding to user wagers can be displayed at the bottom of the screen of FIG. 7 to show the outstanding user wagers. As the user's wagers become official, the representations of those unofficial electronic wager tickets could drop off the display at the bottom of the screen of FIG. 7. Further, a monitor bets button/icon may be provided on the screen of FIG. 7 which allows the user to review the details of all unofficial and official electronic wager tickets.

Referring to FIG. 8, a payout table is depicted for a “Win” wager type of an at least one wagering terminal. The payout table includes a title 800 generally describing the wager type, such as the win wager type in FIG. 8, of the payout information included in the table. More particularly, the payout table includes columns 810 indicating the wager amount placed for a particular wager type, e.g., $1 placed on a win wager. The payout table further includes rows 820 indicating race contestants, e.g., identifying information for each race contestant or combinations of race contestants, such as the post position or name(s) and, if applicable, the corresponding icon color (as described above), ranked from favorite to longshot. The payout table then further includes information for each row-column combination 830 indicating the actual or potential payout for the wager represented by the row and column information according to the wager type of the payout table. So, for example, the intersection in the payout table of FIG. 8 of the $1 wager amount column and the favorite race contestant would provide information for the actual or potential payout of that wager. In an embodiment, the payout table may be an electronic display that provides updated payout information depending on race event and/or wager type presented on the display of the at least one wagering terminal. Alternatively, where possible, the payout table may be simply a printed table of actual or potential payout information. As will be apparent to those skilled in the art, payout tables may be provided for wager types other than the win wager type.

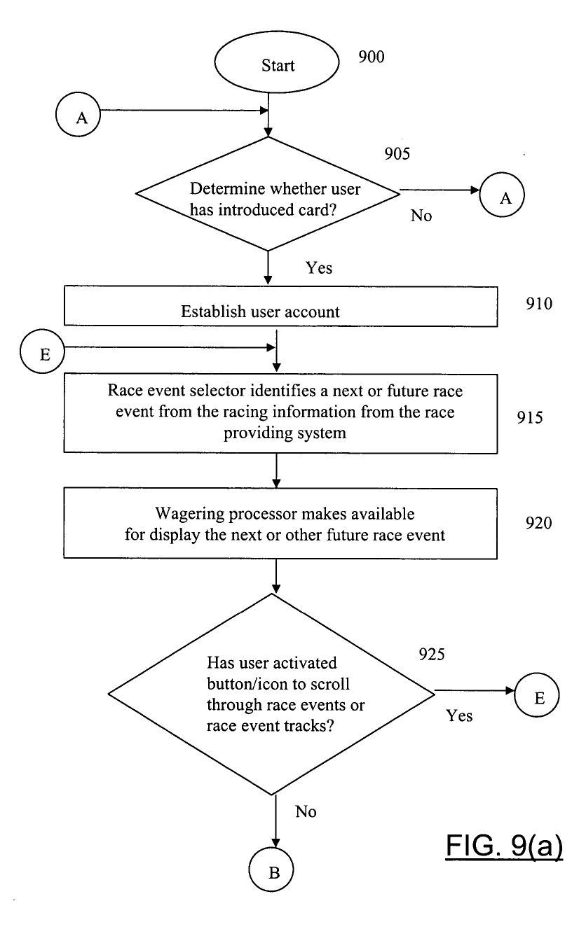

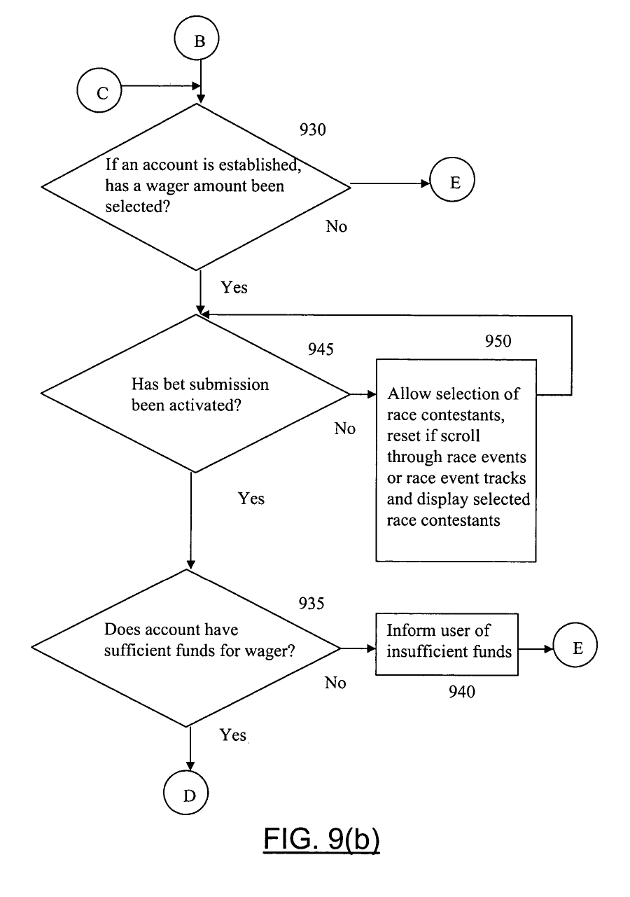

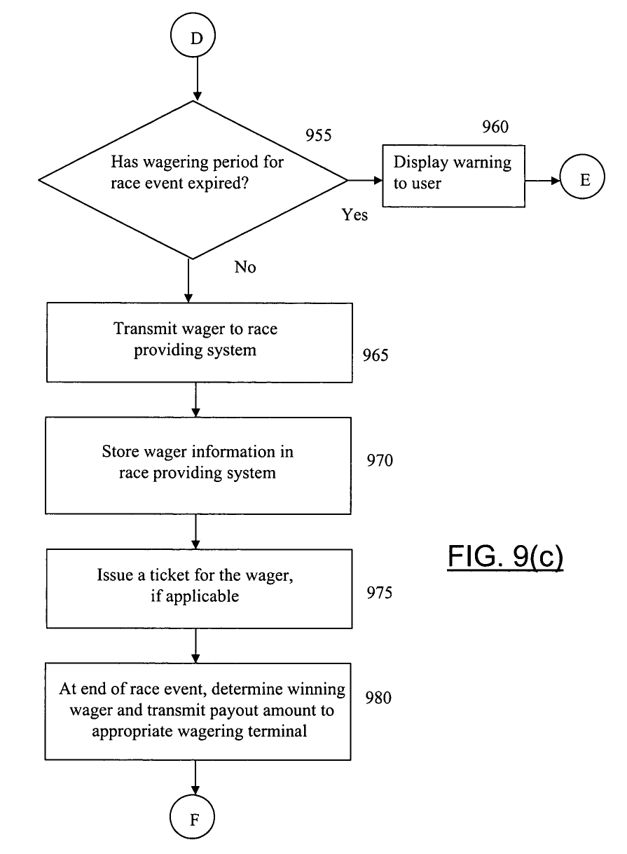

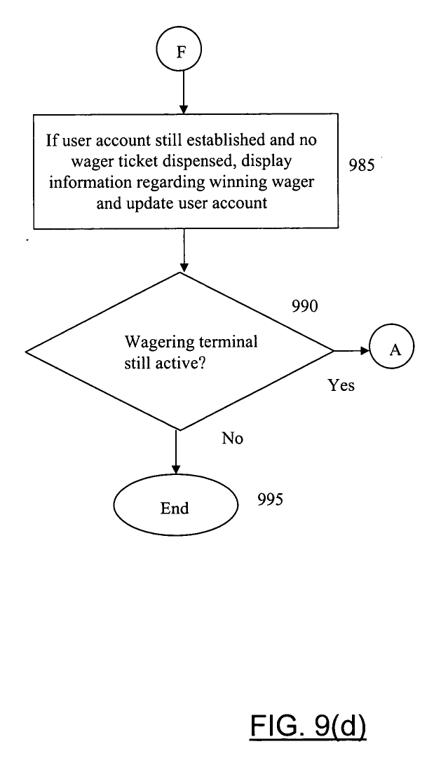

Referring to FIG. 9, the wagering facilitated according to an embodiment of the invention will be described. In this embodiment, the at least one wagering terminal may be configured to provide a single wager type (although it may be reconfigured to a different wager type by a configuration change command). Where the at least one wagering terminal provides multiple wager types, the wagering facilitated by the wagering system according to that embodiment would query the user to select a particular wager type (not shown in FIG. 9) but would then operate according to the wagering described below in reference to FIG. 9. For example, the user interface may include a plurality of wager type buttons to allow the user to select a desired one of the wager types.

The account processor may determine whether the user has introduced an electronic/magnetic-stripe card 905 to the card read/write device and if so, establishes an account 910 for the user in the account buffer if there is a credit in the account sufficient for the lowest wager amount available on the at least one wagering terminal and the card is otherwise operating properly. If the user has not introduced an electronic/magnetic-stripe card to the card read/write device, the account processor may keep determining whether a card has been introduced and the user will be unable to submit a wager or scroll through race events, e.g., the user interface is inactive, until a card is introduced. Optionally, the account processor may make available for display a warning to the user if the card is not operating properly, the user's account does not exist or there is an insufficient credit in the account. In an embodiment (not shown in FIG. 9), the account processor of the at least one wagering terminal is configured to request from the user an appropriate password or other identification information via the user interface before establishing the account for the user in the account buffer. In an embodiment (not shown in FIG. 9), a user may scroll through race events without having to introduce an electronic/magnetic-strip card to the card read/write device. In an embodiment (not shown in FIG. 9), only the buttons/icons corresponding to wager amounts and combinations available for wagering in view of the balance available in the user's account and the particular race event displayed will be active. For example, available wager amount and combination buttons/icons are lighted or shown when the user has a sufficient balance for those wager amounts and/or the wager combination is possible at the displayed race event. Similarly, the inactive wager amount and combination buttons/icons are dark or not shown when the user has an insufficient balance for those wager amounts and/or the wager combination is not possible at the displayed race event.

Once a card is introduced, the race event selector of the at least one wagering terminal may query the racing information received from the race providing system, and identifies 915 a next and other future race events, as described in more detail above, for display on the at least one wagering terminal via the wagering processor. At the outset and as the wagering pools associated with displayed race events close, the race event selector may identify a next race event for display on the at least one wagering terminal. As a user scrolls through race events by, for example, next or previous race event and/or race event track selection commands, the race event selector may identify other future race events for display on the at least one wagering terminal.

Thus, in an embodiment, a next race event is displayed on the at least one wagering terminal at the outset when a user introduces a card to the at least one wagering terminal. Thereafter, the user may scroll through race events and race events tracks but when the pool closes for a displayed race event, a further next race may be displayed on the at least one wagering terminal. In essence, the race providing system provides a substantially continuous stream of racing information to the at least one wagering terminal in order to provide a substantially continuous display of information regarding a succession of race events. Further, the race providing system may also provide one or more sets of quick pick race contestant(s) as other information pertaining to the racing information in a substantially continuous fashion to the at least one wagering terminal and/or as requested by the at least one wagering terminal. Optionally, the at least one wagering terminal may receive a configuration change command to change the wager type assigned to the at least one wagering terminal.

The wagering processor may make available for display 920 the information regarding the next and other future race event, particularly the race event track name and race event number, as identified or supplied by the race event selector. Particularly, the wagering processor may make available for display, as identified or supplied by the race event selector, next race events upon the introduction of a card to the at least one wagering terminal or as the pool for a displayed race event closes and next and other future race events scrolled through by the use of next and previous race events and race event tracks selection commands.

The wagering processor may further make available for display a number of icons corresponding to the race contestants in the displayed race event, including icons of varying shade/color to identify the different odds information associated with each race contestant. The wagering processor may use, for example, the odds information in the racing information buffer to assign varying shades/colors to the icons associated with each race contestant of the displayed race event.

The wagering processor may also determine 925 whether the user has activated a button/icon to scroll through race events and/or race event tracks i.e. the “Next Race”, “Previous Race”, “Next Track” or “Previous Track” buttons/icons. If so, the race event selector may determine a next or other future race event for display and the wagering processor may make available for display information regarding the user elected next or other future race event, determined by the race event selector, resulting from the scrolling.

If an account is established, the wagering processor may query 930 whether a wager amount has been selected (for example, via selection of one of the wager buttons). If not, the at least one wagering terminal may continue to determine next and/or other future race events for display, display information regarding such race events, and present on the display information regarding elected next or other future race events resulting from the scrolling through race events and/or race event tracks. In an embodiment (not shown in FIG. 9), the wagering processor may employ a default wager amount, e.g., the lowest wager amount, when bet submission has been activated but no wager amount has been selected.

If a wager amount has been selected, the wagering processor may wait for one or more race contestants to be selected by awaiting 935 the activation of the bet submission button i.e the “Play” button. For example, the race contestant(s) may be manually selected 940 via touching a portion of a touch-sensitive screen of the display associated with the icon(s) of the selected race contestants (and then hits the “Play” button to submit the wager). If the user hits the “Play” button without selecting race contestants or only a partial number of the needed race contestants (not shown), the wagering processor may query the quick pick race contestant(s) buffer to derive a suitable set of quick pick race contestant(s) to complete the wager (as discussed in more detail above), in accordance with the wager type assigned to the at least one wagering terminal. If the user at any point touches a “Next Race”, “Previous Race”, etc. button/icon, the wagering is reset and the account processor waits for a new wager.

In a variation not shown in FIG. 9, the user interface may include a select button for initiating selection of the race contestants. Accordingly, in this variation, the user places a wager by selecting one of the wager amount buttons. The user can then manually select one or more race contestant(s) according to the wager type or activate a select button causing the wagering processor to query the quick pick race contestant(s) buffer and display a set of quick pick race contestant(s) in accordance with the wager type by, for example, changing the appearance of the icon(s) associated with those race contestant(s). If the selected race contestants are deemed by the user to be unacceptable, the user can manually select new race contestant(s) or re-activate the select button, causing the wagering processor to obtain and display a set of quick pick race contestant(s), in accordance with the wager type, picked using an alternate algorithm for selecting quick pick race contestant(s). Once the race contestants are deemed by the user to be acceptable, the user may complete the wager by activating the bet submission button i.e. touching the “Play” button. As will be apparent, error checking loops may be employed with related dialogues for display to the user. It is to be noted that even with the handicapping be automatic as an available component of the system, the 'reselect'function is expected to provide a different selection than the first selection. This can be implemented in a number of ways. The reselect can delete the last selection as an option, the nature of the wager form (win, place or show, etc.) can be altered, the player profile adjusted or reconsidered to provide additional input, and the fact that the handicapping system may be implemented in a manner where there are a variety of selections that may be appropriate according to the handicapping system, and these various selections may be randomly selected from upon the initial selection and the activation of the reselect mode.

If the selected race contestant(s) were picked manually by the user, the wagering processor may then present 950 the manually selected race contestant(s) on the display by, for example, changing the appearance of the icon(s) associated with those race contestant(s) (for example, as described above in more detail). If the selected race contestant(s) are deemed by the user to be unacceptable, the user can override the selection by, for example, touching a button or a portion of a touch-sensitive screen of the display associated with an icon for resetting the manually selected race contestant(s) so a new set of selected race contestant(s) can be manually chosen or a set of quick pick race contestant(s) can be chosen by pressing the “Play” button. Alternatively, the user can continue to pick race contestants until too many race contestants have been chosen at which point the selection of race contestants is reset so a new set of selected race contestant(s) can be manually chosen or a set of quick pick race contestant(s) can be chosen by pressing the “Play” button. If the user at any point touches a “Next Race”, “Previous Race”, etc. button/icon the wagering is reset 950 and the account processor waits for a new wager. If the manually selected race contestant(s) are deemed by the user to be acceptable, the user completes the wager by activation of the bet submission button i.e. the “Play” button. As will be apparent, error checking loops may be employed with related dialogues for display to the user.

Once the bet submission has been activated, the account processor may query 945 the account buffer to determine whether there are sufficient funds in the user's account for the wager. If the account processor determines that the account does not have sufficient funds for the wager, the wagering processor is informed 950 of the insufficient funds and the wagering processor may present a message on the display indicating that the user has an insufficient credit balance for the wager. The account processor may then check for next race events, as applicable, and waits for a new wager.

In an embodiment, once the bet submission has been activated, the screen of the display of the at least one wagering terminal shows a spinning reel animation (e.g., like a slot style wheel) with sound effects until the wager ticket is printed or displayed. During the animation, the wager may be processed including the selection of one or more race contestants as the bonus pick(s) and, where applicable, one or more quick pick race contestants. The spinning wheel represents that the wager is being processed. When the animation is finished, the screen will pause to show the race contestant(s) selected for the wager centered on the middle of the screen. The race contestant(s) are re-organized from betting number (numerical) order to ordering the user's picks and bonus picks in numerical order starting from the center row (“pay line”). After the pause, the screen will revert back to where another wager may be placed. This screen shows for the first time the race contestant(s) chosen as the bonus pick(s) as well as, where applicable, the quick pick race contestant(s) for the wager.

If the account processor determines that the account does have sufficient funds for the wager, the wagering processor may then determine 955 whether the wagering period has expired for the race event upon which the wager has been placed, that is, if the race event has started or the ability to wager on the race event has been closed. If the wagering processor determines that the wagering period has expired, the at least one wagering terminal may present 960 on the display a warning to the user to indicate that the wagering period has expired, continue to determine next and future race events for display, display information regarding such race events, etc. As will be apparent, since the race providing system continuously updates the at least one wagering terminal with information on the future race events, shortly after a wagering period expires the at least one wagering terminal will display information about a next race event.

If the wagering processor determines that the wagering period has not expired, the wagering processor may transmit the wager amount 965 and the selected race contestant(s) to the race providing system. The race providing system stores the wager information 970 in the wager database, together with the network address of the at least one wagering terminal. The race providing system continues to receive wagers until the end of the wagering period of a race event. The wagering terminal may also issue a ticket 975 corresponding to the wager, which can be used to obtain a payout for a winning wager via an automatic device and/or a clerk. The delivery of a ticket may be initiated by the activation of the bet submission button i.e. the “Play” button and/or by a separate button/icon activated by the user to request the printing of a ticket.

In an embodiment, at the end of a race event, the wager processor of the race providing system may query the wager database 980 to identify the winning wagers, calculates the payout payable to each user in accordance with the amount wagered (and either the payout odds if the wager was a fixed odds wager, or the size of the pari-mutuel pool if the wager was a pari-mutuel wager), and then transmits to each winning wagering terminal (using the network address stored in the wager database) a data packet indicating the payout amount.

Upon receipt of the winning contestant data packet, if the user's account is still established in the at least one wagering terminal and a ticket with respect to the winning wager has not been dispensed, the at least one wagering terminal may present on the display 985 information regarding a winning payout. Upon receipt of the payout data packet and if the user's account is still established in the at least one wagering terminal, the account processor may update the user's account including, if appropriate, updating the account information on an electronic/magnetic-stripe card. The user can then place a wager on the next race event, or else discontinue wagering by closing the user's account on the at least one wagering terminal by, for example, disengaging the electronic/magnetic-stripe card from the card read/write device. If the wagering terminal is still active 990, the wagering terminal may determine whether a user has introduced a card, identify future race events, etc.

In an embodiment, winning users of the wagering terminal may be announced and a results board of winning users is provided. To protect the privacy of users, a key phrase may be provided, for example, on tickets so that wagering account holder names and winning amounts are not disclosed to the public.

To generate excitement, a wagering terminal may ring its bell or provide some other audio signal depending on a) the number of winning tickets played on that terminal and/or b) the amount of money won on that terminal. The audio signal may occur at the completion of each race.

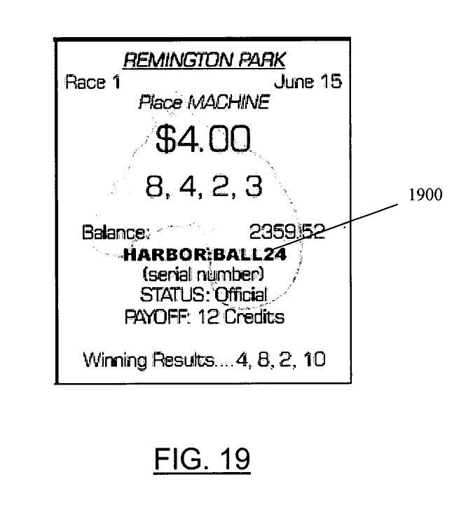

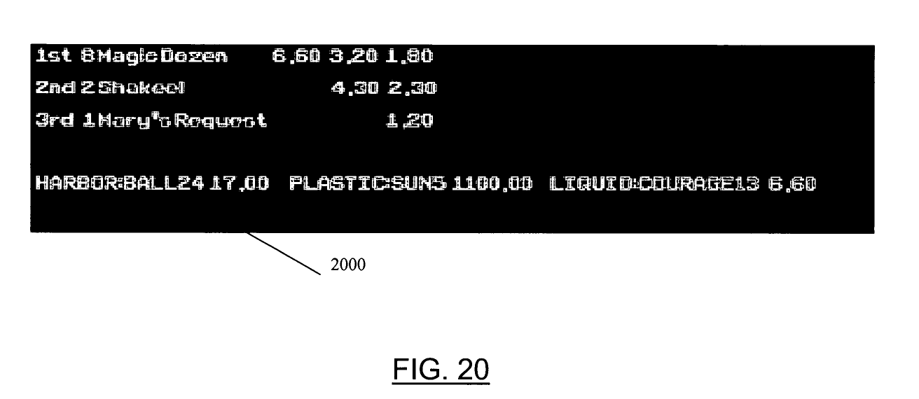

Further, the results of one or more races may be displayed on a results board provided on the at least one wagering terminal or provided separately with the at least one wagering terminal. Flashing lights, scrolling, sound and colors can be used to attract attention to the results board. The results board may display individual winners along with the amount won through a code name. Each ticket provided by the at least one wagering terminal may include a code name corresponding to the particular wager placed by a user. The code name protects the identity of the user but allows for the identification of the winning amount through a public display board and may enable the money to be directed to and directly deposited into an account. In an embodiment, the code name may be simply a concatenation of a randomly selected word (or combination of randomly selected words) followed by a 2 digit number. For example, referring to FIGS. 19 and 20, a user makes a $4 place wager on at least one wagering terminal. Referring to FIG. 19, the user's ticket prints the code name “HARBOR:BALL24” 1900 on the ticket. More secure code names based on random number generation, encoding sequences, bar codes, and the like may alternatively provided. In this example, the race is run and the user's wager is a winner. Referring to Fig. 20, the results board will either flash or scroll the code names and winning amounts for all winning tickets such as “HARBOR:BALL24 $17.00” 2000. The code name associated with each ticket may be stored in a database. After the race runs, the database may be used to determine approximate winning amounts and to display them on the board. The database may be stored on the machine or concentrator in volatile memory and is reset if a machine is power cycled. The amount shown is an approximate amount and not exact due to various differences in the calculation of winnings across jurisdictions. When the player inserts their wagering card, the balance will “ring-up” their last known credit balance up to their current balance if they won.

The detailed descriptions may have been presented in terms of program procedures executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the invention is not limiting of the invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the invention based on the description herein with only a reasonable effort and without undue experimentation.

A procedure is here, and generally, conceived to be a self-consistent sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations of the invention described herein; the operations are machine operations. Useful machines for performing the operations of the invention include general purpose digital computers, special purpose computers or similar devices.

Each operation of the method may be executed on any general computer, such as a mainframe computer, personal computer or the like and pursuant to one or more, or a part of one or more, program modules or objects generated from any programming language, such as C++, Java, Fortran, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a processor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-tern storage devices, for example, magnetic disks, rewritable optical disks, and so on.

In the case of diagrams depicted herein, they are provided by way of example. There may be variations to these diagrams or the operations described herein without departing from the spirit of the invention. For instance, in certain cases, the operations may be performed in differing order, or operations may be added, deleted or modified.

An embodiment of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD-RW, CD+RW, diskettes, tapes, hard drives, computer system memory (e.g. RAM or ROM), and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to the method of the invention and/or to structure its components in accordance with a system of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

On conventional wagering machines, a player must choose a track code, then a race number, then an amount or denomination for that respective track code and race number. For example, a user engages the machine in selecting AP (Arlington Park), Race 3 for the wager to be placed. However, choosing a denomination requires a bet type and the denomination or wager amount. For a bet type that involves two or more race contestants, the process may require mathematical factorial considerations. For example, if one were to place a wager such as a superfecta that keyed race contestant number 5 and then wheeled race contestants number 2, number 6, and number 9, the bettor would have to do the factorial math in order to arrive at a denomination amount or wager amount for the respective wager Key 5, wheel 2, 6, 9 which cost $6 (3×2×1=6) for $1 wagers on each combination. Therefore, it would be advantageous to have a wager amount/bet type selector that performs these calculations for the race providing system and the user interface to save time. A wager amount/bet type selector, according to the present invention, combines bet type and dollar amount. By having a wager amount/bet type selector, fewer tickets will be cancelled by the player since the player is not “surprised” at how much the wager will cost. For example, the difference between 3 wheels and 4 wheels is $18. (3 wheels=$6, 4 wheels=$24=24−6=18) and the difference between 4 wheels and 5 wheels is $96 (5×4×3×2×1=120 and 4×3×2×1=24 =120−24=96) Notice how 1 wheel can make a difference of $96 in this type of situation causing the bettor to cancel a ticket with a clerk manually or start the whole process over again by hitting “Cancel Wager” on the user interface, which increases bet process time for the player and the other players waiting to use the machine and the respective players may be “shut out” of the race due to the race “going off” and pool closings.

A conventional wagering machine allows a player to select a dollar amount (for example $2) and then a bet type, for example, an exacta wager, and then a bet type within a bet type (for example key-wheel and wheel) where race contestants are chosen simultaneously or interchangeably between the key function and the wheel function. Another way to do this on a conventional wager machine would be to choose an amount, then a bet type then a bet type within a bet type (box) and choose the race contestants by a random numbered quick pick that has no algorithm or handicapping formula. Rather than doing these conventional steps as mentioned above, it is an optional aspect of the invention to provide a wager amount/bet type within a bet type selector that enables the player to select a bet type (for example exacta) then a dollar amount (for example $2), then the wager amount. A bet type selector according to the invention chooses the bet type with the bet type selector and the race contestants via a handicapping formula. Whether the dollar amount is chosen first or the bet type is chosen first is irrelevant in regards to conventional wagering or in an embodiment of this invention. Having a wager amount bet type within a bet type selector is advantageous to the player for two reasons:

1) It eliminates the number of steps or expedites the wagering process since a bettor does not have to understand specific betting terminology such as key, wheel, box or wheel-all. The player also does not have to choose race contestants either simultaneously or interchangeably between the key, wheel, box or wheel-all functions.

2) The second advantage is that if the player has a choice between two bet types within a bet type such as key 1^{st}, key 2^{nd} or 2 exact order or wheel 1, wheel 2, or 2 any order, the handicapping formula will make this decision by an algorithm that combines a third party vendor (for example HDW) and a race providing system. For example if the handicapping formula says that horse number 1 will run a PSR (projected speed rating) of 80 and horse number 2 will run a PSR of 70, this indicates a 10 point different and the odds are about 30 to 1. Then the algorithm will make an economic, handicapped race contestant decision to process the wager key number 1 for 1^{st} and key number 2 for 2^{nd} since the wheel number 1 and wheel number 2 only pays $10. By way of example, this wager does not make wagering sense since the 1 horse will most likely beat the number two horse and the results would pay $20 more to key the number 1 horse for 1^{st} and the number 2 horse for 2^{nd}.

Quick Pick Rotator Summary. In small countries or small pari-mutuel betting market countries where there is not much live racing and not a significant number of simulcasts, it would be beneficial to have non-commingled pools using a quick pick rotator making sure that each bet type pool is balanced. As long as a pool is balanced in regards to amounts wagered on each race contestant, even though the pool may be small, the payouts will be economically enticing. For example, if you had a $10 pool where there were 10 race contestants where there was $1 wagered on each respective race contestant, the winning wager would pay $8. (10- $2 takeout=$8 [8 to 1 payoff]). Now, consider the situation where there is a $100,000 pool where there is 60,000 bet on #2 and 10,000 on #1 and 15,000 on #3 and 5,000 on #4 and 5,000 on race contestant #5. If horse #2 wins, the winning wager only pays (100,000−20,000 takeout=80,000÷60,000) 1.30 to $1 wagered. Notice that even though the betting pool was larger in the second example (100,000) versus first example ($10), the first example paid 8 to 1 versus 1.30 to 1 in the second example. This is because the quick pick rotator “flattened” or “evened” or “smoothed” the pool by assigning the same dollar amount to each respective race contestant. Since the wagering terminal keyboard or betting user interface icons only contain small denominations (for example $1, $2, $5) it is easy to smooth pools. For example, player #1 chose $1 play and is assigned race contestant #1. Player #2 chooses the $2 denomination and the quick pick rotator assigns to player #2 horse #2. Player #3 comes along and chooses a denomination of $2 just like player #2 and the quick pick rotator assigns player #3, race contestant #3. Therefore, we have $1 on race contestant #1, $2 on race contestant #2 and $2 on race contestant #3.

If there are only 3 race contestants in the win bet type pool, when player #4 arrives and chooses $1 denomination, that player #4 will be assigned, via the quick pick rotator, horse #1 to even out or smooth the win bet type pool. Now, there will be equal dollars on each race contestant providing each player the same odds and payoffs. The quick pick rotator prevents the racetrack management from having minus pools. Minus pools can cause a track to lose money on a bet type pool or make no money on a break-even on a bet type pool. If a player wagers $100,000 in a $1,000 pool, there are state regulations that require the player be paid a minimum of 10% profit on any winning wager. This even includes show bet types that where the pool must be divided three ways. In the scenario just previously mentioned the track would have to forfeits $9,000 of a $10,000 betting commission to pay the player 10,000 on a 100,000 wager. (1,000 pool+9,000 commission forfeit=10,000 payoff). It would be ideal to a user interface that contains small denominations or keyboard buttons that have small denominations to be supplemented by a quick pick rotator in order to prevent “lop-sided” or unbalanced pools where the track is in danger of losing commissions due to state laws on minimum payoff and the player receives very uneconomical returns for his $2 wager where the bettor only receives 10 cents profit due to a large bettor destroying his wager with one minute to post time. The small bettor's wager is destroyed because the large bettor and the small bettor chose the same race contestant.

Also in small countries where there is very little live racing to supplement the simulcast menu or very little simulcasting due to U.S. tax laws such as IRS withholding tax, foreign countries cannot commingle betting pools between two countries because IRS agents cannot claim taxes in Mexico for example. In Mexico, there is only one live racetrack running and U.S. simulcast racing there must be separate pools since the IRS will not let the Mexican players, for example, commingle with U.S. live pools due to IRS withholding tax on foreigners. The only way for a foreign country to bet into large American live pools is to have a tax treaty with the U.S. regarding this issue. Therefore, it would be ideal to have separate betting pools for each U.S. track and using the quick pick rotator to make sure the betting pools are balanced so the bettors are left with economical payoffs and racetrack management is not responsible for minus pools. With the quick pick rotator functioning in separate non-commingled pools, the player can play thousands of races in a small foreign betting market. This reduces dead time between races and increases total handle for racetrack management since there is a direct correlation between the amount of races carried that day to total handle wagered that day. The correlation is the more races offered the more handle is generated for the racetrack due to less “dead time” between races which enables the player to bet more races in a shorter time frame.

Summary of Quick Pick Wager Amounts Rotator and Separate Betting Pools. There are jurisdictions where separate pools are required due to laws that forbid commingling of international wagering pools mainly for tax purposes. This is because a commingled pool requires that the tax laws and takeout be the same as the host track that is hosting the wager. For example, if Mexico wanted to commingle wagers with a Canadian pool, the Mexican track would have to adopt the Canadian pari-mutuel regulations regarding what bet types are allowed at what minimum wager amount. (Many jurisdictions require $2 minimum for win, place, show bet types and $1 for exacta, triactor, superfecta). For example, for years there was no superfecta wagering in Canada, therefore a Mexican track could not commingle a superfecta wager into a Canadian on track betting pool. Also, communication costs are very expensive. For example, for Mexico to commingle with Canada, since it is far away, there may not be enough bandwidth to accommodate wagers that require speed to enter the host pool with only one minute or less to post. Communication costs for commingled pools is very expensive due to fact that superfecta wager may have 24024 different combos in a 12 horse field with each combo containing 32 bits of synchronous or asynchronous data (24024×32=748,768 bites). Since the average takeout of every betting dollar is 20% (10% to horsemen for race purses and 10% to track management) whereby only 7% only goes to track management since another 3% is deducted for a commingling fee and broadcast fee to the track. The host track also sends a satellite feed to a non-host track that wants to commingle wagering pools so the fans in the building can see the race at the non-host track or non-host off-track betting location (O.T.B.). However, the costs of uplinking the satellite fee is absorbed in the 3% charge which is called a simulcast export fee or broadcast fee by the host track. One can view a simulcast export fee as a “broadcast” fee just as the major broadcast networks do business.

Now that we have mentioned above how the business, regulatory, technological framework of simulcast works it would be beneficial to have a self-sufficient, self-contained, non-commingled, statewide only or national only network so that a racetrack at off-track betting shops in these statewide or national pari-mutuel network would not have to adopt other state or other national pari-mutuel betting regulations to commingle. Also in the self-contained network there would be no need to convert different currencies to commingle wagers (such as U.S. dollars in Canadian dollars in order to commingle into a Canadian host pool). Also the network costs would be drastically reduced due to only on-site communications or communications that only involved an inter-state hub where only O.T.B.'s or racetracks of that country or state were connected unlike a worldwide simulcast network that involves “double bouncing” of satellite feeds between three continents or an “intra” state hub (a hub that connects several states) which is larger than a state only hub. Intrastate hubs are usually on a GAN network whereas an interstate hub is usually on a MAN network. Another benefit of having your own network is that you can have fractional betting which is very attractive in more economically depressed regions in the world or where the monetary value of the currency is less. For example, it is very expensive for a Mexican to wager $2 U.S. or Canadian into these countries respective pools in order to commingle since the countries require a $2 minimum to commingle win, place, show bet types. By having a 1 Peso wager it would enable a greater market to play the machines or betting terminals rather than $2 U.S. minimum denomination which is roughly 20 pesos which is out of reach or too expensive for low income players 5 cent slot machines or 25 cent slot machines are very popular and cater to a different market that would otherwise not play or wager. However, the downside of non-commingled separate pools is that they tend to be very small because they only cater to one regional or national or even one local site such as a racetrack that has no phone wagering or off track betting thereby have very little distribution. With very small pools a large bettor could cause a “minus” pool. For example, a bettor wagering 100,000 dollars into a 10,000 pool will cause a minus pool when the takeout is factored in. It is unlikely that a bettor want to invest so much in a small pool because many state regulations require a minimum 5% or 10% payout which is more money than what you get leaving your money in the bank for the day. Also in a five horse field, the chosen race contestant must only beat two horses to get 3^{rd} place in a show bet. Many race contestants in these situations are only entered for 4^{th} or 5^{th} money and really don't “belong” in the race, they are there only for a guaranteed paycheck since most races pay up to 5^{th} place. The issue becomes how to prevent the huge professional bettors (whales) from destroying the betting pool. (It is not fun making a wager on a race contestant that is at 4 to 1 at post time and when the gates open it is 1 to 9 thereby only paying 5 cents on a $2 bet to return $2.05. The solution is to use a quick pick rotator to even out the wagering dollars on each of the race contestants in conjunction with a keyboard or button panel or user interface denomination icons that are only available in small amounts. For example, in an embodiment where only $1, $2, $5 denominations. If a player wants to place a large bet such as $1,000 via the $5 button he will receive (1,000÷5=200) 200 different wagers on different race contestants. For example, in a 10 horse field, this large bettor will receive 20 $5 bets on each race contestant. 20×$5=$100×10 different horses=1,000 total dollars wagered) thereby neutralizing this large bettor which could otherwise created a minus pool or make the win bet. For example, only paying 10 cents on a $2 wager takes the “fun” or economic reasons for playing away. Also, with a quick pick rotator less confident or new players will play because the rotations in the processor or in the software are not revealed to the respective players. Therefore, depending on the rotation, the best handicapper may get the worst horse and the worst handicapper may get the best horse or horse with the statistically best chance because the horse which the player is about to receive is not revealed on the user interface until the bet enters the pool or a ticket is printed. By having separate pools, racetrack management does not have to know the world-wide state regulations for commingling with various jurisdictions which reduce legal costs for the racetrack since they (racetrack management) only have to abide by their own state regulations since the separate pools are only hosted in that respective state or country. It is very confusing for the player to have many different takeout rates associated with each state or country. For example, in Arizona the win/place/show takeout is 28% and in New York the win/place/show takeout rate is 15%. However, these takeout rates are not blatantly advertised because it is not the most attractive thing to have a 28% takeout rate. Takeout rates are viewed as taxes and wherever takeout rates are increased bettors get angry because not as much money goes into the actual betting pool. Therefore, it would be ideal to have a betting network that has one standard takeout rate instead of hundreds of different takeout rates for each track and bet types. Many bet types are taxed differently for each state. For example, in New York, win/place/show betting is taxed 15% and exacta, triacta, and superfecta is taxed at 20%.

Summary of betting pools with no consolation. Small betting pools that have consolation rules associated with their state or national pari-mutuel regulations cannot carry over since there will always be a player that will have a winning ticket by default to the next winning combo or succession of default winning consolation wagers until a winning ticket is eventually claimed. For example, if the winning result is 4,1,2,9 for a superfecta wager and nobody has this combination, the default combination may use the 5^{th} place horse instead of the 4^{th} place horse such as 4,1,2,11 where the race contestant #11 ran in 5^{th} place and now became the 4^{th} horse for a superfecta combo by default. In another default scenario may be when nobody has the 3^{rd} horse in a result such as 4,1,2,9 where nobody had two for third in their superfecta combo. Again, the winning wager combo by default would bump up the 4^{th} to the third spot and 5^{th} horse to complete the superfecta in the 4^{th} position. For example, mentioned earlier 4,1,9,11 would be the winning superfecta combo.

However, in small commingled betting pools or separate betting pools it would be advantageous to have no state regulations in regards to consolations or a state regulation saying that unless the exact numbers of the race result are chosen or picked and entered into the pool, there will be a carry over to the next respective race at that racetrack. This would be very beneficial to a small betting markets that only have a couple hundred bettors on the pari-mutuel network betting at one moment in time. If there were no carry over and each player wagered an average of $2 per race, and there were 500 people playing each respective race the pool would only amount to roughly $1,000 per race with a consolation ticket most likely winning the wager instead of a ticket that had the 1^{st}, 2^{nd}, 3^{rd}, 4^{th}, horse respectively which is very unlikely in a 12 horse field where the odds are 24024 to 1 (12×11×10×9=24024.

Thereby, it would be advantageous to have betting pools that with no consolation prizes so the prize could carry over until an exact winning ticket with the first 3 race contestants in a trifecta bet type or the exact winning ticket with the first 4 respective horses in a superfecta bet type is achieved. I mention, triactor and superfecta because win, place, show and exacta wagers have on so few possibilities such as win/place/show is 10 to 1 in a 10 horse field and an exacta is 90 to 1 in a 10 horse field (10×9=90). There are hundreds or thousands of people playing in the exacta pool it is most likely to have an exact winning ticket will be achieved because it is not expensive to box or wheel or key an exacta because it is only based on 2 factorial or the first and second position being chosen. It would also be advantageous to have a third party handicapping system interfacing with a race providing system and a quick pick rotator or a handicapping formula built in a race providing system that would only pick horses that were most likely to lose or not run in the top 3 for a triactor or top 4 in a superfecta thereby producing a carry over. The quick pick rotator in this case would start with the combo involving 12 highest longshot, 11 highest longshot, 10 highest longshot for the first quick pick. The second quick pick would be the 11^{th} highest longshot followed by the 12, 10 highest longshot respectively. The third quick pick rotator would be the 10 highest longshot followed by the 12, 11 highest longshot respectively for a triactor quick pick rotator selection.

This procedure by using the most unwanted horses would involve using either a handicapping formula to find the least desirable race contestants or live odds or morning line odds. If there were no more unwanted or undesirable race contestants left to be chosen then handicapping algorithm would start to use moderately desirable horses followed by favored race contestants until all the different combinations were all taken or accounted for in the bet type pool. By using a statistical systematic approach more carryovers will be achieved, therefore increasing the pool to create a larger prize or “jackpot”. Lotteries today use carryovers in order to create larger prizes and more excitement or lifestyle changing prizes for their players.

In addition to the structural and elemental game play features of the invention, there are methods and capabilities that are unique to the practice of the invention that are neither present nor suggested in prior pari-mutuel wagering technologies. For example, using the above-described quick-pick rotator that selects combinations or segments of race locations, race events, and race competitors based on handicapping, odds, and other wagering characteristics by application of an algorithm of comparative program designed to make such selections on the basis of at least one of the parameters, and which may also be influenced by smoothing functions, wager spreading functions, pool smoothing functions, pool evening functions and the like, either commingled pools may be entered (have wagers entered into them) or a separate, non-commingled pool may be entered with a quick pick rotator. The use of a separate, non-comingled pool offers some unique characteristics. In commingled pools, in addition to the retention of a portion of the wager by the track and the state, the totalisator operator may also take a significant or even the most significant portion of the wager retained by the presenters of the wagering system. By eliminating the entry into the commingled pool, the system operators may retain individually larger monetary portions of the total wager, yet return larger percentages to the player by eliminating the substantial portion removed by the pool manager or totalisator. Additionally, it is possible to better control the distribution of wagers within the separate, non-comingled pool, to place partial wagers (e.g., $0.25 wagers on a specific wager type and contestant as compared to the required minimum of a $2.00 wager), and to provide level payouts, payouts on races that are fixed from the time of the wager until actual completion of the race, and provide other services that provide significant interest and value to the players and the system operators and partners. This separate, non-commingled betting pool may be provided with no consolation prizes or prize, operating in a rebate mode, or steady state mode when there is a time delay in accessing race event results.

For example, one method of play already indicated is the placement of a wager on a pari-mutuel race event, upon which results have not yet been provided. Before winning or losing characteristics can be ultimately determined and resolution of those wagers initiated, the event must conclude and the official results provided. Therefore, actual winnings cannot be distributed by the terminal in the apparent slot machine play. This leaves at least some potential dead time (which may be as little as a few seconds or as much as a few minutes gap in the play. This period of time before a first or a significant number of pari-mutuel wagering resolutions shall be referred to herein as “interrupt time.” This interrupt time is contrary to one of the objectives of the system, but can be addressed in a number of different manners. For example, if the player has been tracked, or the player has an established account, rebates may be made to the player during this interrupt time. For example, as with comps that have been established in casino environments, the past play of the player may be acknowledged in an account and that rebateable amount will be used in play during the interrupt time. As this is actual value that is to be returned to the player, the system may provide a series of templates or specific patterns of symbols or events in the terminal play to the player that will return at least a portion of the rebate amount to the player during this interrupt time. For example, if the player has 100 hours of play at the maximum level at a terminal on record (or other play at that facility or a related facility (e.g., at an associated casino), the comp system may identify that $20.00 comp award is available to that player. Assuming $1.00 minimum events, the central control system will therefore establish that during the interrupt time (which can be accurately gauged by the system since the post time and race time can be approximated), templates of symbols will be provided to the player that will return at least a portion of this rebate amount.

It is important to note at this point that the ‘play’ of the slot, poker keno, or other symbol events on the display of the terminal are not truly random events, as they must be in slot machine play. Rather, this apparent slot play is a mechanism for paying out awards won in the pari-mutuel wager that has been placed. Once the wager has been placed, the event results determined, and the wagering results determined and associated with a specific player or terminal, the apparent (non-random) slot play becomes merely a mechanism for returning the winning of the pari-mutuel wager to the player at the terminal. There is no actual random slot event that occurs. Thos offers considerable flexibility in the operation of the apparent slot play. This term “apparent slot play” is used to mean any methodology of showing symbols or images on the display or reels that indicate whether or not the player is entitled to an award or payment, whether in a primary mode, bonus mode, or combination of the two. The specific display is insignificant, although as described herein, some are aesthetically or functionally preferred (e.g., horse or racing images). Such symbol displays may be reel-type displays (e.g., cherries, bells, sevens, oranges, bars, lemons, plums, character images, color symbols, thematic images, and the like), card images (e.g., poker game displays, draw poker, stud poker, deuces wild, jokers wild, etc.), keno, baccarat, player selectable images with hidden prizes or awards, automatic game-controlled selection of awards from groups of symbols, or any other display game that is capable of indicating a prize or award. According to the premise identified above, where there is a rebate available to a player, $5.00 of the rebate may be provided to the player over an estimated period of time of five (5) minutes by providing the player with a set of templates of symbols that when played to conclusion, will provide a winning set of events that will provide the player with $5.00. For example, assuming a set of forty (40) plays over the five minute intervals, the templates may provide collective winnings on $0.25 wagers as (with wins indicated without a numerical sign and losses indicated with a (−) sign:

| Play No. | Result | Play No. | Result | Play No. | Result |
|---|---|---|---|---|---|
| 1 | 0.50 | 2 | −0.25 | 3 | 0.25 |
| 4 | −0.25 | 5 | 1.00 | 6 | −0.25 |
| 7 | −0.25 | 8 | −0.25 | 9 | 1.00 |
| 10 | −0.25 | 11 | −0.25 | 12 | 0.50 |
| 13 | 2.00 | 14 | −0.25 | 15 | −0.25 |
| 16 | −0.25 | 17 | −0.25 | 18 | 0.50 |
| 19 | −0.25 | 20 | 0.25 | 21 | 0.50 |
| 22 | −0.25 | 23 | −0.25 | 24 | −0.25 |
| 25 | −0.25 | 26 | 1.00 | 27 | 0.25 |
| 28 | −0.25 | 29 | −0.25 | 30 | 1.00 |
| 31 | −0.25 | 32 | −0.25 | 33 | 0.25 |
| 34 | −0.25 | 35 | −0.25 | 36 | 0.75 |
| 37 | −0.25 | 38 | −0.25 | 39 | 1.00 |
| 40 | 0.25 | | | | |

By providing a sequence or total number of templates of symbol displays that will provide this result (a collection of symbol sets in a random order or specific order), the pari-mutuel payout will be provided to the player. This is not truly a random payout, but rather is a fixed payout to the player over time that is the result of the pari-mutuel win. If the player did not win, on the wager, the predetermined set of symbol sets or templates will decrement the wagers placed in the machine by the player.

This system of payouts by templates has another significant potential benefit. As the payouts on wagers do not have to be made in one pseudo reel spin or apparent slot play, a number of events, occurrences, and wagers can be taking place at the same time. For example, as there is the inherent potential for delays, even with access to many different race events that are accessible through pools, the payouts and losses on original wagers may be spread out over time. For example, even with 100 tracks being accessed through the system, once a wager is placed, a particular race on which a wager is placed may take 2-3 minutes to run, and the results may not be immediately official. Even if seven different race events have wagers placed on them at the same time, there may be an initial delay in obtaining the wager results. So once a first winning wager is established, the payout may be spread over time, rather than being paid at once. Software may be provided to spread the winnings/losses over time, and the software may be self-adjusting for intermediate or sequential events, such as winning additional races while one race is being paid off, or losing an additional race while a first race is being paid off, or winning a race while a loss is being decremented, or losing an additional race while a previous loss is being decremented. For example, say the first race result was lost with an initial wager of $2.00 having been placed on that wager, and another wager had been placed for $1.00 on a separate wager event. After $1.00 has been decremented from the player for the loss, the second wager has a winning result of a win of $2.50. The software will balance the two event results to a total win of $0.50, with $1.00 already having been decremented, and the resulting play that the system will effect will be providing winnings of $1.50 to the player so that the total effect of the two wager is a win of $0.50.

Where larger wins have been provided by the results, the templates may be provided by the software to provide the large payout over various periods of times. For example, if the Quick-Pick rotator provided a perfecta that paid $123.50, the series of templates or sets of symbols provided over the next five minutes may provide winning displays in the apparent slot plays of the $123.50, with various distributions of amounts in individual payouts including individual large payouts of $50.00 and $25.00 distributed within the ‘play’ of the terminal. This will provide the player with both large awards, extended play with many awards, and minimize interrupt time during play. Certain amounts of the winning distribution may be booked into the player's comp account for use in rebate mode at a separate time.

Another feature that may be played by the pseudo-slot play is the control and assurance of returning winnings to the player, even when the complete cycle of payouts has not yet been completed. For example, a player may be at a machine, winnings of $7.00 have been identified on a recent wager, yet the player (not being aware of this award) has been requested by a spouse to leave the machine and cash out credits. Upon hitting the Cash Out button on the device, a pseudo Bonus Mode may be identified to the player. For example, upon pushing the Cash Out button, a display may appear on the screen of “Special Bonus Event,” “Bonus Event,” “Bonus Play,” or any other identification that the system is operating to the benefit of the player. This situation may also address the circumstance where a wager has been placed on a race event and the results are not yet final when the Cash Out button has been pressed. By alerting the player that a special and potentially beneficial event is occurring, the player will not leave the machine until resolution of the event. A time warning may also be provided, such as “Bonus Event Duration Approximately 3 minutes” so that if the wagered amount has not been resolved on the basis of an unofficial result or the race event has not been concluded, the player will be made aware of the possible time to conclusion. Any display of a game or award system for the bonus may be used, even the mere announcement of display of the result of the event (e.g., a display of “Bonus is $7.40! Congratulations!”). Another system that offers the advantage of being able to provide the exact amount of the winnings to a player is the provision of selectable (e.g., by button, mouse, touch screen, laser wand, etc.) indicia or symbols, such that if there are winnings of $7.40 to be paid to the player, prize-hiding indicia (e.g., six horses) may be provided, and behind each horse, as selected by the player, would be $1.00, $0.05, $0.10, $0.25, $2.00 and $4.00. The player would thus be paid out on all winnings that have not yet been registered with or disclosed to the player, even though the player has indicated that the player is about to leave the game area or the machine. There is no obvious risk of loss to the player at this time, as the machine is operating in a bonus mode without overt player wagering.

The control that may be exercised on the system is quite unique and because of the underlying pari-mutuel wagering, is fundamentally different from conventional slot or video or keno or poker wagering, even though the screen may give every appearance of that type or format of play. For example, to build pools, a handicapping formula that systematically chooses least desirably race contestants and enters the race contestants into a separate betting pool may be used. A handicapping formula that uses least desirable race contestants and sends an electronic file to a “Quick Pick” or automatic pick icon on the user interface or button on the user interface may also be used.

While this invention has been described in relation to certain embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention. Changes, including equivalent structures, acts, materials, etc., may be made, within the purview of the appended claims, without departing from the scope and spirit of the invention in its aspects. Thus, it should be understood that the above described embodiments have been provided by way of example rather than as a limitation of the invention and that the specification and drawing(s) are, accordingly, to be regarded in an illustrative rather than a restrictive sense. As such, the invention is not intended to be limited to the embodiments shown above but rather is to be accorded the widest scope consistent with the principles and novel features disclosed in any fashion herein.

The use of a private pool, used by only those machines or terminal connected at the same time into the server, hub or private pari-mutuel pool may be established. As the ultimate objective is to provide winnings at a defined minimum rate allowed by the state (e.g., payout of at least 80% are usually required), the handicapping system may be fixed or varied over the course of play to provide payouts of 80%, 85%, 90%, 92%, 94%, 96% 98% or whatever the target rate is. In the use of commingled pools, the handicapping systems of the invention have been found to be quite successful, and in tests with commingled pools, the machines, software, and systems of the invention. have been able, in some circumstances, to provide payouts to players over time in excess of 100%, even with the track, the state, the totaliser company, and the machine owner taking out their shares. This is effected because the handicapping system of the invention can be more efficient and win more often that the regular track or OTB player.

A handicapping formula may be used that does not choose two or more race contestants or race contestants combos for the same bet type. AS the system can make handicapped picks, the software should be able to balance wagers so that wagers are not cannibalizing themselves or negative pools are being built up on a wager type. For example, if the terminal is placing two place wagers on the same event, the software may be designed to assure that the wagers are spread out, selecting, for example, the favorite in the race for one place wager and a longshot or intermediate odds contestant for the other place wager, whatever the handicapping formula decides, with statistical and risk- benefit analyses built into the handicapping formula so that the handicapping algorithm does not always place all wagers on the favorite, whether the input is from a single player or multiple players. This can also be effected by poll smoothing considerations, wager splitting from each player and other techniques. By wager splitting, for example, if there are ten horses in an event, and there are 120 players making $2.00 wagers, the total wagering money may be distributed nearly equally among the contestants (e.g., $24,00 per horse), but the actual wagers on each horse may be variously distributed among the players. For example, Player 1 may have $1.00 on horse 1, and $0.25 on four other horse, while player 2 may have $0 on horse 1, $0.50 on three horses and $0.25 on two other horses. By distributing the risk among the players in the pool (whether private or commingled, there will be a guarantee that some players will win.

It is also possible to design the handicapping system so that the handicapping formula does not make multiple win, place, show wagers on the same bet type at the same race track event for a single player. Thus, a player will not be wagering against himself when the Quick Pick rotator is exercised for multiple wagers. The same player may have different wagers on the same event, such as a wager to win, a wager to show, and an exacta wager, but in that event, he is not wagering against himself in a single pool. The win wager and the exacta wager may identify different winning horse, but as these are different pools, this is more risk distribution or benefit analysis results of handicapping and does cause the player to be wagering against himself in the same pool. The system may also use a handicapping formula that uses two or more wagers and uses probability and financial return for two or more race contestants in order to “hedge” the total amount wagered whereby the handicapping formula is in the race providing system or third handicapping data combined with race providing system. For example, the handicapping system may, for one or more players, place $X to win and $Y to show to provide maximum wagering on a race event to increase the handle at a track, the different wagers also providing decreased risk to the players. This can enable the wagering to build secondary pools for the system, which facilitates player winnings. By using proper handicapping (e.g., using latest at post; real-time data), the player's money is better protected, and the player is provided with an increased opportunity of winning as compared to wagers being made on old or static information (e.g., last night's tally sheets or handicapping sheets).

A network to accomplish this could comprise a wagering terminal that had two modes of operation. The two modes can be called in an embodiment “rebate mode” and differentiating “result mode”. The explanation and the reason for existence and how each mode operates starting with rebate mode will be explained. The “rebate mode” application is a software program that rebates or gives back money to players in order to stimulate play from a sales and marketing perspective. Again, as the system is not exclusively a random number generated outcome based slot-type system, significant flexibility in awards and payouts is available with pari-mutuel wins provided on the system. For example, in an embodiment a rebate program may give more back to a higher percentage to first time players in order to gain their confidence or eliminate the intimidation factor a first time player would have. If players win on their first or second spin, their confidence grows and helps reduce the learning curve of learning how to use a new gaming interface. Another example of a rebate program in order to stimulate play would be to reward players based on total amount of play, which can be tracked via a magnetic stripe or smart card. As the total amount of play increases, the player reward rebate increases in regards to the percentage. An embodiment may carry hundreds of different rebate programs so that an element of surprise is created for the player and the player cannot track a pattern of how the machine rebates since there are so many rebate programs and the amount of time or frequency varies in regards to implementation of the rebate program. Plus this is all transparent to the player since different rebate programs are not named on the machine and not revealed the player since they are burned into the microprocessor. However, the player knows he is in rebate mode, by the fact that his game credits or credits are not being credited (lowered) however he does not know how he or she is being rebated. The advantage of rewarding a player directly from a terminal is that it increases the player's cash flow while playing, rather than sending a cheque to the player's address or rebating the player at the end of the day, week, month, etc. This is good for racetrack management because racetracks make their money by increased churn of handle whereby an operating cut or “takeout” is levied on every dollar wagered. By having money or a credit voucher rebated through a wagering terminal it helps the player because the player may be at the end of his credit balance and could use the money or credits if the last ticket purchased to produce a balance of zero credits is not a winner, the rebated voucher or rebated credits would come in handy since the player could keep playing due to the fact that balance is not zero due to the rebated voucher. By keeping the player “alive” the racetrack can continue to chum the player's wagering dollars, thereby making a percentage on every dollar wagered whereby tables games or slots in a casino want a player to lose money to the house. Another major benefit of the “rebate mode” is that eliminates “dead time” between races by keeping the player pre-occupied during situations such as waiting for the official race contestants order of finish, the stewards reviewing the race, and the “dead time” between races where there is lack of simulcast product or races. For example, a simulcast agenda may have a race scheduled at 1:10 p.m. and the next available race thereafter at 1:15 p.m. according to the post times which are received through a race providing system or a totalizator system along with other race providing info such as number of race contestants, total dollar amount wagered on each race contestant, etc.

In the situation mentioned above, there is a certain amount of dead time between races where it is impossible for the player to obtain a result. When dead time between races exists a player can only obtain pari-mutuel tickets for future races, not knowing if the tickets are winners until the respective races are official. This is not the case for slot machines or table games whereby a player plays one event per spin or bet, not multiple bet types on a race event such as pari-mutuel race contestant wagering. A gambler adjusts his strategy or monetary amount of play based on a result by result basis, thereby the quicker a monetary result can be obtained, the gamblers strategy can be adjusted accordingly. For example, if a gambler is ahead or up for the day he may want to increase his play since the gambler feels he is playing with “free” or “house money”. In pari-mutuel race contestant wagering whereby a race is every five minutes in one example, the player tends to “wait and see” by only playing one wager per race event rather than wager 10 different bet types on one race event tying up the bettor's cash flow. Many bettors have only minimum cash flow and they do not want to bet it all while waiting 20 minutes between races and have nothing for a future race that fits the bettors profile in regards to handicapping race variables. Therefore, it would be ideal to have a pari-mutuel race contestant terminal that has a continuous flow of play whereby wagers and results are obtained in a respective alternate fashion one after another which can be obtained through 9 or fewer combinations of rebate mode and result mode. It would be ideal in this situation to use the “rebate mode” to rebate the player. The player would be rebated until the end of the next race which would be “X” minutes after the 1:15 p.m. post time if the player missed the 1:10 post time or the player would be in rebates mode until the 1:10 post time race is official which would be “X” amount of time which like the previous situation mentioned above is based on the time to run the race and the time to make the race official and the totalizator to disperse the pool accordingly to the winning players. While the machine is in rebate mode, the player plays for bellyglass and paytable payouts, which are for the next available race or next selected race. For example, if the paytable had six paylines just like a slot machine and the six lines had prizes or estimated payouts in one embodiment of 5,505.80 for the top prize and 4,055.70, 3,225.10, 2,455.10, 1,588.20 and 901.80 respectively for the successive prizes representing paylines 2 to 5, the respective players at the terminal or computer would play for the estimated or current pari-mutuel payouts which are based on live results and live races. Since they are based on live contestants and live races, the paytable will fluctuate since the handicapping formula is only concerned about choosing profitable winning race contestants and is not concerned about the amount wagered on each of the respective race contestants. The paytable amounts will only stabilize or be static when the betting pool is closed when using a handicapping formula for the race contestant selector. Once the betting pool is closed the machine will switch to “result mode”. The paytable Will then stabilize until all the credits in result mode where the race has been declared official have been used or played. In result mode, the player spins the wheel by hitting the play button, which causes the wheel to spin whereby icons are attached to each bet type. For example, if a winning win bet type may be represented in an embodiment by three consecutive diamonds and two shamrocks. A superfecta may be represented by a number 7, a horseshoe, a bar, a diamond and a shamrock on the middle line of a 3×5 slot interface. The middle line represents the payline. If the player spins the wheel and at the end of the spin, the icons of the respective spin on the payline match a winning combo or icon on the paytable the players win meter is immediately debited (increased) (I used the word debit from an accounting perspective such as when an asset goes up you debit the account).

An electronic file may be sent by a race providing system or third party with chosen race contestants or picks is sent to the race contestant selector. The electronic file contains picks or chosen race contestants for each race and for each bet type within the respective race. This specific electronic file that contains race contestants for each bet type for each race is posted on the bellyglass or paytable. The player can view this paytable and decide whether he or she wants to play by gauging or evaluating the respective payouts for in one embodiment of the six paylines of each bet type or wager that have been processed or totaled through a race providing system to produce estimated odds that are based on a future race in the simulcast menu. For example, the top payline may show a prize of 10,800.25 which could be a triactor, or superfecta bet type or any bet type since the bet type is not revealed, however, the player knows that somewhere in the world of pari-mutuel simulcast there is a wager that pays 10,800.25 at that moment in time for $ 1.00 and that there are respective icons attached to this wager. If the actual wager that was orchestrated by the race contestant selector, bet type selector, race event selector processors is an actual winning wager based on a “live” racing event or sports event that was entered in a “live” pool before the pool closed, the respective icons will show up on the payline, which are also correspondingly on the paytable. If the ticket wagered on the live race contestants was not a winner, an icon or group of icons representing a losing spin will appear instead of winning icons that are on the paytable. The reason for using icons or themed characters is to create a look and feel like a slot machine with using live pari-mutuel betting pools and algorithms instead of using random actuators. Themed icons such as a diamond or shamrock are more identifiable to the player or the player can relate to symbols versus an abbreviated result board so often used in race books, O.T.B.'s and racetracks such as:

FG Race 3

| | | |
|---|---|---|
| 10.40 | 9.00 | 5.20 |
| | 6.0 | 3.00 |
| | | 2.10 |

| | |
|---|---|
| Ex. | 21.00 |
| Super | 4,002.80 |
| Tri | 312.10 |
| DD | 12.00 |

In order for the player to understand an abbreviated result board, he or she must understand track codes such as FG and abbreviated bet types such as tri, super, DD (daily double) win, place and show, versus just comparing themed icons on the payline to themed icons on the bellyglass or paytable. In other words, players want to compare apples with apples not apples with oranges. Also, the usage of symbols does not require English, which is an advantage, in non-English speaking countries whereby symbols are universal. For example, a slot machine will have winning icons on a paytable such as in one embodiment where three cherries represents the top payline and three bars represents the second payline, etc. Either you have the icons on the payline that match the paytable or you don't. There are no comparisons whereby a player compares a race contestant ticket with a differently formatted result board several minutes later whereby there are numerous numbers to compare in order to determine whether the result was a winning one or losing one. The traditional process of comparing tickets to official result boards can be very time consuming if a player plays 400 races whereby having 400 spins on a slot machine is less work due to the fact that you only have to remember one set of branded winning icons and even if the player fails to remember these icons the machine will immediately add to the credit meter even if the player does not know he won. Whereas a winning pari-mutuel race contestant ticket may not be claimed because the player failed to realize he won and therefore did not reinsert the winning ticket into a voucher reader of a self-serve terminal or failed to communicate with a teller thereby causing an “uncashed” ticket. Every racetrack has thousands of dollars of uncashed tickets every year which is not fair to the player since uncashed tickets that are usually not claimed after “X” time are cashed in by racetrack management or other state agencies, etc. It is almost like buying groceries and not reminding the customer that he forgot his food thereby reclaiming the items. If the player decides to increase his credit balance on the wagering terminal he or she may do so via a pre-purchased voucher inserted into the voucher reader or inserting money into a bill acceptor or inserting a player card that is smart card containing credits or loaded with credits or a debit card which has pre-paid credits stored on the card. However, the player could not play in “result mode” until the live race or event was official. Therefore, the machine would be in rebate mode while waiting for a live race event to start or a race that is currently in progress or is subject to an inquiry or the winning tickets have not been processed yet by the race providing system or totalizator system to the winning players all of which is necessary for the machine to switch from rebate mode to result mode. For example, a player will enter money into the bill acceptor or a winning voucher or cash voucher into the terminal. The terminal will then try to find the next available race in the simulcast menu or a specific race in the simulcast menu. However, in one example, the race may be two minutes away from the post time and may require a 1 minute to 3 minutes to run and be official whereby the totalizator or race providing system can submit result payoffs to each group of themed icons that correspond to the respective paytable on the machine. If the actual ticket that the race providing system chose for the player via the race event selector, bet type selector, race contestant selector, and/or the quick pick rotator is a winner, the user interface will produce the respective winning icons on the payline and increase the win meter to whatever the live race contestant event paid or what the estimated odds at that point in time would pay. “Result mode” always uses payoffs that don't fluctuate since the wagering pools are closed whereby no more money can enter the pool and be placed on a combo or individual race contestant to change the odds proportionately on each race contestant. However, “rebate mode” may use in one embodiment odds of a future race which are estimated when commingling with other live racetrack event bet type pools since all total dollars wagered through each totalizator or race providing system have not been totaled at the respective hub were the race bet type pool is being hosted. In situations where the pools are open there is money still entering the pool and the estimated odds are always behind or lag behind the real time odds at the specific or exact moment in time when the money enters the pool. However, if the quick pick rotator is used the paytables will be static from when the pools are open until when the pools are closed. The quick pick rotator has already been elaborated upon.

The pre-selected race contestants and which are displayed on the bellyglass or paytable and entered into a live bet type pool via the play function may be chosen via two different processes or methods. The first method of selecting race contestants is via a third party handicapping electronic feed which contains race contestants selection for each bet type and dollar amount for a specific race chosen by the race event selector. The same information may as well be contained in a race providing system or totalizator system such as Amtote whereby no third party information is required other than information suppliers such as Equibase™ who supply race contestant names, racing statistics variables where no algorithm are used to combine variables such as a third party handicapping formula would on back.

In this situation just mentioned the race providing system chooses the race, bet type, race contestants and denomination amount if need be. If the race providing system or the race providing system in conjunction with third party handicapping data chooses a winning ticket that has the correct race contestants for a specific bet type than the “slot like” user interface will display the appropriate winning icons in respective order that match the paytable or bellyglass on the payline of the user interface. The whole process just mentioned above whether a losing ticket which in turn receives losing icons on the payline or a winning spin which receives or displays winning icons on the payline can be achieved by a user or player inserting a cash voucher or cash into a terminal and then pressing or touching the play function. The machine software or user interface has the same look or feel whether the terminal is in result mode or rebate mode. There are only two differences between the two modes. One is that while in “result mode” the paytable is fixed or static in regards to payoffs whereby “rebate mode” the estimated payoffs fluctuate. The second difference is that while the machine is in “rebate mode” the credit meter is not lowered when the user hits the play function since the credit or credits have not been processed through the entire cycle of a totalizator system such as United Tote or a race providing system, therefore, the player is rebated with rebate payoffs that match the respective bellyglass or paytable of future estimated payoffs provided by a totalizator or race providing system. Whether the machine is in “rebate mode” or “result mode” it is transparent to the user with only two differences between the two modes.

Now that I have described the way race contestants are chosen via the back end of the system and how the player or user interface with the system from a “look and feel” perspective the second method of choosing race contestants will be explained. The second system involves using a quick pick rotator which selects race contestants by how much money is wagered on each race contestant. The quick pick rotator tries to “level off” or even the amount of money on each race contestant in a specific bet type pool. The quick pick rotator works two different ways. The first way is to allocate different race contestant selections for each bet type or a specific race selection for an individual bet type for each terminal by sending the specific race event, race contestant(s), bet type(s) denomination amount to the play function icon on the user interface or play button on the keyboard via an electronic file and also sending the race contestants and their estimated payoffs (for rebate mode only) or official or real-time payoffs (for result mode only) to the respective paytable or bellyglass for each terminal connected to the hub. Therefore, each terminal or computer connected to the hub would receive different selections or payoffs unless two terminals were provided the same race contestant selection for the same race. In this situation just mentioned above, the actual horse's names may be or may not be on the 3×5 slot user interface. Once the machine is in result mode the true horse result would spin on the payline. For example, say race contestant #1 (red), race contestant #2 (orange), race contestant #3 (pink) and race contestant #4 (black) finished first, second, third and fourth respectively, the result would be shown on the payline of the 3×5 slot interface containing the color horses where the first horse to 4^{th} horse were displayed from left to right in the correct order. In the example just mentioned, the correct respective order of a red icon, orange icon, pink icon and black icon could in one embodiment represent a winning superfecta bet type.

The third way to allocate race contestant(s) or contestant selections is to select race contestants for each bet type whether via a handicapping formula or a quick pick rotator which in turn the race contestants would be entered in their respective betting pools and when official the payoffs for each race contestant would be calculated for a bet type of several race contestant for numerous bet types if only the race contestants finished in the appropriate placings to qualify for the respective bet type they were chosen for by a handicapping formula system that may have odd-shopping or they were selected by a quick pick rotator. These official or estimated payouts would then be posted or displayed on the paytable. However, only these payoffs would be posted, the respective horses would not be posted, instead icons or an icon representing a bet type or icons representing the same bet type or different bet types would be shown on the paytable or bellyglass. If the selected horses resulted in winning bet types, then the respective icons that are on the paytable would appear on the payline and the players win meter would increase to the actual official pari-mutuel payoff if the machine were in result mode or the estimated payoff at that point in time when the user hit the play function if the machine or terminal were in rebate mode. If the quick pick rotator or handicapping formula algorithm did not select a winning race contestant for any bet type or bet type, then losing combos of icons or a losing icon would appear on the payline which would not be on the bellyglass or paytables.

To cover the “dead time” between races, in order to keep the player pre-occupied where the player is still playing for equivalent or comparable payoffs in “rebate mode” as compared to “result mode”, and in order to have enough money to rebate players, a “giveback” or “rebate pool” must be established through increased takeout of win/place/show/exactor/triactor/superfecta/pick 3/pick 6/daily double/quinnella wagers. For example, rather than having 20% takeout on win/place/show, it should be increased to 40% in one embodiment if half the dead time comprises of half the day and the other half of the day there is no dead time based on 24 hour average of “dead time” versus “play time”. Actual play time is increased if the player inserts more credits into the machine, which are then processed for result mode. In the situation mentioned above where the takeout is increased from 20% to 40% since the “dead time” is estimated to be equal the play time since “play time” is estimated by the attendance of the facility multiplied by the per capita or amount wagered per player whereby one credit takes an average five seconds. If the average capita per player is $200, this amounts to a 1000 seconds or 16.6 minutes of play time. If there are 100 machines in a facility that is open 12 hours a day which results in (60 minutes×12 hours×100 machines) 72,000 minutes of total time the machines can be player. Therefore, an average attendance of (72,000÷16.6) equals 4,325 must be achieved with each player playing a daily 200 per capita. However, if this was the actual attendance, there still would be dead time due to the dead time between races where the players are changing terminals with one another and the new player must play in rebate mode until his money is processed through a live race event totalizator system whereby result mode can be played after processing. Therefore, a player turnaround time must be calculated. One could estimate two minutes between post and an average time of 1.5 minutes to run a race and 5 minutes for the race to be official and totaled by the race providing system. Thereby there could be 4 minutes (2 minutes+1.5+1.5) player turnaround time per player. If the attendance over 12 hours is 4,325 there would be 17,300 minutes (4 minutes×4,325 players) of dead time where the machine must be in “rebate mode” and 54,700 minutes where the machine would be in “result mode” which is 69% of the time and 31% of the time in “rebate mode”. Therefore, the takeout must be increased by 31% in order to have enough money set aside to “rebate” players whereby they are still playing for the payoffs or prizes which are on the bellyglass or paytable thereby making it transparent to the player whether the machine is in rebate mode or result mode. However, if the attendance of the facility or total players playing increases or the length of play time per player increases, the takeout may be lowered since less of a rebate pool is required at this point in time. However, if attendance of the facility decreases or the amount of the total players in the system decreases or the length of play time per player decreases the takeout may be increased in order to create a greater rebate pool which creates more play time and entertainment value for the player since more dollars are being rebated. A pari-mutuel race contestant network that uses variable takeout rates would be beneficial to a race track operator or the group of players since if the facility or network is not busy the takeout rate could be lowered increasing the players play time since more is given back to the players which lets the players “live longer” on their initial financial investment. However, if the facility or network is really busy and there are lineups at the machines or the network via internet wagering is not scaled to handle the traffic or volume increasing the takeout will create a faster player turnaround since increased takeout leads to a lower pari-mutuel “chum” or handle, since not as much money re-enters the live bet type pools when more takeout is levied. However, if the player does realize that he or she is in rebate mode, most likely he or she won't care because the prizes or payoffs will be the same as result mode and from a marketing perspective the player when playing in rebate mode may notice that they credit balance is not going down and my enjoy this because he or she realizes that this can increase his or her play at the machine.

Another problem in pari-mutuel wagering is that $2 in many jurisdictions is the minimum wager or denomination amount required by law to commingle win/place/show wagers. Many states require a $1 minimum denomination or wager to commingle exotic wagers such as triactor, exactor, or superfecta wagers. Many slot machines today offer 25 cent playing which is very popular due to less risk or capital investment versus $1 or $2 minimum of pari-mutuel race contestant wagering. Therefore, it would be ideal to have 25 cent pari-mutuel race contestant wagering whereby the player could commingle with jurisdictions that still had a $1 or $2 minimum requirement to commingle or allow an out of state or local player to combine his money into the host pool.

This can be done via a denomination processor that can take whole dollar amounts such as $1 or $2 and create fractional bets by dividing the fractional amount into the whole dollar amount. For example, a $1 superfecta wager can be divided into four 25 cent superfecta wagers whereby all four 25 cent wagers are the same bet types with the same race contestants. For example, a $1 superfecta wager with race contestants 9,1,2,5 on race 3 at Churchill Downs would be now four 25 cent wagers on the same race contestants 9,1,2,5 for a total of $1. However, the wager did not enter a race providing system or totalizator system for 25 cents or four individual 25 cent bets it entered the race providing system pool or totalizator bet type pool for a single minimum $1 wager amount or more on race 3 at Churchill Downs using race contestants 9,1,2,5 respectively. It is the denomination processor that divided the $1 by 25 cents when the player hit the 25 cent denomination button on the keyboard or touchscreen thereby reducing the credit balance .25 when the machine is in result mode only. Remember the credit meter cannot be reduced when in “rebate mode”. If the $1 superfecta wager is a winner, then the player would receive four winning spins for 25 cents each or two winning spins for 50 cents each or two winning spins for 25 cents each and one winning spin for 50 cents or just one winning spin for a $1 credit. This would be determined by whatever buttons or denomination icons the player was choosing on the button panel or icons or screen.

If the superfecta 9,1,2,5 on race 3 at Churchill Downs were a non-winning ticket then the player would receive non-winning icons on the payline, which are not on the corresponding bellyglass or paytable. If by chance a race contestant is scratched at the gate or scratched for whatever reason the machine will issue $1 winning spins at various times until the scratched ticket is fully refunded. This form of refunding has to be done since the player entered money or other monetary instruments into the machine which in turn was entered into a live race event bet type pool, however the race contestant was then scratched by the racetrack stewards thereby entitling the player to a refund. The player is refunded by pressing the play function which in turn spins the wheel and produces a payline result which that matches the lowest or a payoff on the paytable above the machine.

The system of the invention may provide many variations in controls over the system, both for security, player-recognition, comping, rebating, and the like. For example, the cash-accepting pari-mutuel terminal may print value vouchers but does not print tickets and does not have wagering via a personal account. Face recognition may include vide cameras, retinal scans, fingerprints, personnel recognition (e.g., by floor walkers, pit bosses, change providers, and the like) or by any other recognition system, with data input into any central control or clearing system.

As note throughout, it is desirable to reduce dead time in the race contestant pari-mutuel network. This can be effected according to the various means described above and others that may be developed, such as the rebate mode, the systematic payout of awards, the stretch time for payment of awards, and the like. There may be both individual rebate modes and pool rebate modes where excess retention in pools is paid out to players who happen to wager in that pool by direction of the Quick-Pick or any other means. It is also possible to provide fixed payout modes in the wagering system. This is an issue that has been repeatedly questioned in the racing industry and has always been a source of concern to players. For example, the odds on a contestant may be 30:1 when the wagering opens, yet this horse may leave the gate at 5:1 or less because of the increased amount of wagering done on the contestant between opening of the pools and closing of the pools. The horse may have been a reasonable risk at 30:1, but less attractive at 5:1 or less. This is inherent in the nature of pari-mutuel pools. In managing separate pools, it is possible to assure a fixed winning amount on a wager by smoothing or evening the pools. For example, if there are 11 players wagering $2 each in the win pool of a 10-horse race, in the win pool it can be set that whichever horse wins, the payout for the win will be $18, this being done by assuring that there is at least $2.00 wagered on each horse in the win pool. This enables the track, the totalisator and the state to take their share, yet guarantee a winning amount.

By operating in a rebate mode, the pari-mutuel race contestant wagering network may have a player insert a monetary instrument and win immediately without waiting for official results. The money may be taken from various overstocked pools in the system or rebate or promotional funds. Risk and profits may also be masked by this technique. This is also available where there is a pari-mutuel race contestant network that places a wager into a live pool and may allow the player to win immediately after the money is entered into the machine. Different software programs may be available in the rebate mode to assure a specific degree of payout, similar to the stretching of payouts described above, or in any other format. This type of system may also enable a terminal or network to allow a player to play and win estimated odds on a future race. The rebate mode may be based on future odds or races, since the wagers can be distributed among all possible wagers, assuring some return to the pools for payment to players. Money awarded to players during the rebate mode may also be balanced against actual winnings where needed, as with lower winning rates are encountered. Carryovers may also be brought into the rebate mode payout. Carryovers from other wagers, such as exacta or perfecta pools may also be used in this procedure.

It is desirable for the system to enable the terminal, with or without notification to the player, to automatically switches modes (e.g., between result mode, rebate mode, bonus mode, etc.) when monetary instruments are in the terminal are associated with the respective race whereby when official results respective switches into a different mode of operation in regards to determining winning payoffs or rebates. Once race results are final, winning combinations of symbols or icons can be provided to the player to effect distribution of winnings. There can, as noted earlier, be fractional payouts stretched over time, rather than an attempt to provide a single large payout. This also simplifies payouts where fractional dollar amounts (e.g., $12.70) are won. Payouts of fractional amounts would seem quite unusual in machines having the appearance of slot wagering devices. This can be referred to as wager dividing mode, where the winning wager is paid out in increments. As noted above, should the player attempt to leave while this actual winning is distributed, a pseudo-bonus mode may be identified and entered. Fractional amounts may also be used in carryovers or placed into a rebate mode. The most important modes of operation are the result-based mode, where the payout is being determined or awarded by actual play in a pari-mutuel pool, and the other mode is the rebate mode that has already been thoroughly discussed.

Players may be paid by cash, vouchers, or crediting accounts, smart cards, magnetic cards, or any other acceptable form. Cancelled horse money (actual rebate) may also be awarded in this manner. The pari-mutuel race contestant terminal may use themed icons or a themed icon to determine payoffs based on live pari-mutuel payouts or live pool pari-mutuel bet types. Themed icons may be used to represent a bet type or bet types. Different icons or symbols may be used with different wagering formats, such as horses for wins, jockeys for place, saddles for show, tracks for perfectas, card hands for daily doubles, and the like. The themed icons representing a bet type or bet types may also be shown on a display and may be represented on a payline as well. The pari-mutuel terminal may provide winning or losing wagers based on a payline, as described above, as where the outcome of a wager is presented by a payline. The rebate or winning outcome may be presented on a payline and added to a win meter or credit meter. The pari-mutuel race contestant wagering terminal may use language to name horses on the user interface and otherwise no language use appears on the user interface.

By these procedures and minor variations thereon as described above, the pari-mutuel wagering race contestant terminal may allow a to can win exact odds representing a race contestant before the race contestant has run or the race has been declared official, by flattening, smoothing or otherwise adjusting pools and distributing wagers. The terminal or machine may also have two or more different race contestant selectors or quick picks, both the standard industry Quick-pick and the Quick-Pick-rotator described in detail herein that is actually handicapped or adjusted to even pools and the like, as by use of an algorithm.

The pari-mutuel race contestant wagering terminal or network may use or take a percentage of the takeout of every wagering dollar processed through the system to create a rebate pool and may have one or more rebate programs, based on any useful basis such as birthdays, player qualities, player frequency, number of losses, amount of losses, etc. The pari-mutuel race contestant terminal may rebate players when they have winning results or icons on the payline or effect rebates by particular icons or symbols being placed on the payline.

It is also desirable to have internal and/or external notification of credits available for immediate withdrawal, credits won, credits under play, and any other characterization of play, as normal terminology does not always apply to the treatment of credits in a pari- mutuel system as compared to credits in a slot wagering machine. The pari-mutuel race contestant wagering terminal may automatically credit winning bet types when the player hits a play or enter icon on the keyboard or user interface. The terminal can enable direct payment of cash to players when they win, without necessarily debiting any account. Additionally, the terminal can enable play of games on the terminal through the totalisator pool without debiting any credit based upon a pari- mutuel wagering game on the terminal when the player inserts player's cards, cash, vouchers, or winning tickets. It is of interest to note that many different treatments of cash, vouchers, or credit may be used in the play of the game. The two most important of the various modes shall be described as standard credit mode, and immediate debiting mode. In the standard credit mode, cash, credit or vouchers are entered into the terminal and a credit equivalent to the value on those entries is identified by the terminal. For example, a $20 bill is inserted in the terminal and a credit is shown on the machine as twenty dollars. Wagers are placed from the terminal only upon direction by the player for a wager to be made. Those individual wagers are treated by the wagering system according to the various techniques described herein. Individual wagers are played out through the pari-mutuel wagering and wins and closes credited and debited on the system. Another method is the immediate debiting mode, where entry of cash, credit or vouchers into the terminal is immediately wagered in pari-mutuel pools. This advances the placement of the wagers on events, can queue the wagers in various pools and on various totalisator systems, and then usually enter a rebate mode or other form of free play mode until results are official. There are advantages and disadvantages to each system. The first methodology places the player into greater immediate control of the assets in the terminal, enabling the player to withdraw whatever funds have riot been placed at actual risk. There will tend to be more actual dead time in game play over the course of time, as actual award play from a successful wager will occur only after the first successful wager, and playing the credits one at a time will require more time for a win to occur then providing a large number of plays initially. The immediate debiting mode can place many different wagers (e.g., on an initial $20 credit and splitting the wagers into as little as $0.25 units, eighty wagers can be placed) can be immediately placed, even on the same event, and the likelihood of an immediate win to feed payouts and additional play are highly likely, even with an initial dead time in actual pool outcomes and the need for some initial rebate time. There is always a possibility that even each of the eighty wagers will be losers, and where the initial credit amount is split into fewer and larger wagers, the possibility increases for a lack of winners. This places the system into a circumstance where all credits have actually been used and the player cannot withdraw or be paid. The wagered funds, in advance of race event conclusions, are not accessible nor can they be withdrawn. This can create a situation with economic tension between the player and the machine/terminal operator. Unless the player understands that funds entered into the terminal system are immediately dedicated to play and payouts may be available only upon at least some successful outcomes, there can be some disaffection for the system exhibited by the players. This can be moderated by incremental wagering (e.g., wagering $5.00 of the $20.00 immediately, indicating the debiting out of the total amount initial wagered, and then entering other increments along with notice to the player. There can be a more complete monitoring or notification system to the players. This can be done with meters that identify at least some number of different auditable events such as credits entered, credits committed to wagers, credits in play, credits being awarded, credits withdrawable, and the like.

A pari-mutuel race contestant terminal according to the invention may use live pari-mutuel bet type pools and rebate algorithms and can rebate a player without the need of random actuators (although those can be used). By providing sets of symbols, templates, series of sets of symbols, and other machine directed event effects (e.g., a required payout of $17.30 won on wagers in pari-mutuel pools), the players are rewarded, but no actual game play is performed by random number actuation. Although random number generation may be used to select the order of symbols sets provided to a player, that is not actual game event random number control. For example, if a pattern or set of reel symbol combinations are predetermined to effect a payout on a successful wager (such as the forty reel outcomes provided in the Table above), a random number generator may be used to select the reel symbol sets, one-by-one until exhaustion. That does not actually affect game play, as the total payout has been predetermined and the order of paying out that set does not vary the total amount won by a player. This method of payout can be used in pari-mutuel payout mode (also referred to herein as a “result mode”) or rebate payout mode.

The meter displays may be affected by events that are not apparent to the players. For example, the pari-mutuel race contestant terminal may lower the credit meters only after an official result is realized. At the same time, rebates, free play, or idle play may be engaged, and the default of the system may be for such play based on the minimum wager, or based on the average value of play of the player, or on a mix of wager sizes. The pari-mutuel race contestant wagering terminal may allow a player to win before, during and after a live race event, as in rebate play, immediate payback on winning events, and subsequent distribution of winnings in the stretched out payment of wins. The pari-mutuel race contestant wagering terminal may or may not use any racetrack names or racetrack codes in the screen displays or other information provided to the player. The wagering into the pari-mutuel pools by this method and apparatus can actually mask from the player the actual source of funds and the fact that race wagering is the underlying structure for wagering. The machines and terminals may be completely devoid of any display or language indicating that there are wagers in race events, and no mention of race locations, race events, contestants, wager formats (win, place, show, daily double, etc.), wager amounts on individual race events and the like.

It is also possible to use old race events rather then entering live pools. This can be a very interesting attribute of the system and can provide a legal way of using a system that is akin to late pool closing. As the selection of wagers is preferably made on the basis of handicapping algorithms that in real time events, separated from knowledge of outcomes, it is equally possible to provide all of the information that was available to handicapping systems at post time in races that have been completed, and by segregating race results from the handicapping algorithm, use the race results after wagers have been placed to determine winners. This can be used in private pools only, or by creating new commingled pools, but of course cannot use the original pools from the race. This offers many potential advantages, such as being able to fix payout rates (the odds at post time are known, or specific odds may be assigned to each contestant as wagering can be flattened or appropriately distributed to stabilize the odds), being bale to provide a library of events so that there is no dead time, using the old results in a private pool to provide or reduce rebate play, and many more events. As a desirable ancillary benefit of the present system is to enable increased revenue to smaller race tracks, it is possible to pay license fees to tracks that provide the handicapping and race information to the terminal designer and operator. As events from smaller tracks are used from the library, a percentage or fixed fee can be paid to the small tracks providing the information or to a consortium of tracks that package the information.

It is important to realize that with a library of even one event, the system can operate in an equitable manner, that one exhausted race event providing the capability for determination of at least one win, place, show, exacta and perfecta wager. It is desirable from an outside viewers perspective to be able to provide a true library of a multiplicity (more than one) set of race handicapping information and race results so that payouts can be varied. The use of larger numbers (e.g., at least 2, at least 5, at least 10, at least 20, at least 50, at least 75, at least 100, and at least 500) of sets of information (handicapping and results) would have a more aesthetic appeal to regulators and to the industry, at least from the standpoint of being able to involve more than one track in a share of the fees for the information. It is preferable that such “late pool closing” wagers be used only during dead time, as it is still desirable to use live pools where greater returns to the player (e.g., greater than 100% return, as mentioned earlier) may be available.

The handicapping system of the present invention may also be provided on the terminal with alternative race selection means, including the conventional quick-pick selector, which may automatically pick a contestant randomly or spread wagers over all contestants. The player may have the opportunity to select the handicapping means from among variously generically identified choices.

Handicapping selections from previous events or non-wagerable events (e.g., the race has already begun), may be displayed on the screen to give a player an estimate of the effectiveness of the various handicapping systems. The terminals may rebates or pay out with cash vouchers. By using a rebate mode, players may play without cash vouchers or credit or cash input. By wagering on different events, paytables may vary from wager to wager. For example, the displayed symbol icons of five shamrocks may represent a daily double play wager. Such a wager may vary as a payout from $16.00 to $500.00 in a single race. The display may indicate a range of possible payouts for the reels showing that symbol, may display a statistically average payout amount, or the like, with those values changing from race event to race event. Similarly, the terminal may show losing, refund or rebate icon sets on a payline for losing contestant tickets in the various play formats of the invention.

The terminals of the invention may also provide unique capabilities that are not provided by any OTC or other pari-mutuel wagering facilities. As there are cash receiving terminals, the terminals may also pay off on vouchers, tickets or accounts when appropriate identification, security or the like is provided. For example, with a player account, money may be paid out of the account, paid into the account, paid to the player, and the like. Where vouchers or tickets are issued by the terminal, they may be reinserted into an accepting portion of the terminal, scanned or otherwise read, and cash provided to the player from winning tickets. Ticket issuing systems such as those of U.S. Pat. No. 6,056,289 as well as smart card technology, bar code technology, reader/scanner technology and any other system that prints and reads tickets and can afford some security. The terminal and the displays associated therewith may have the ability to have no “stoppage” in play whereby the win meter or credit meter can be credited immediately after the icons settle on the payline and/or automatically adds winning credits or dollar amounts to a win meter or credit meter without reinserting a winning voucher or ticket. The pari-mutuel race contestant terminal may also increase a win meter or credit meter before a race is official, as in the rebate or refund mode.

One significant benefit of the present system, which has also been significantly described an enabled, is the ability to place fractional wagers, that is, wagers that are fractions of the minimum amounts usually allowed into commingled pools. For example, a $2.00 wager is usually a minimum wager. By accepting many wagers from many clients, the wagers for the individual clients may be broken down into fractions (e.g., $0.10, $0.25, $0.50, $0.75, $1.00 and the like), wagers from various clients compiled into a minimum wager in a commingled pool (or private pool), and the winnings apportioned according to the amount placed by each player. In this manner, the likelihood of winning events is increased for the player. This can be assisted by a fractional dollar processor, which can create two or more individual bets from a single or multiple dollar amounts, and associate those fractional amounts to each player, and place a minimum wager from joined fractions into a commingled pool.

Another way the game can be played is using fractional betting where a betting dollar is split up or divided according to the number of available bet types. For example, if a player inserted a dollar into the machine or another monetary instrument to receive a credit and if there were four available bet types for a racetrack event and the combined pari-mutuel takeout was 4% (government taxes, horseman's fees, track operator fees) thereby leaving 96% of the dollar to enter four live bet type pools (96÷4=16 cents per pool). The amount or percentage allocated to each pool may vary in an embodiment, however in this example the dollar after the combined takeout is divided equally (96 cents÷4 betting bet type pools=24 cents per pool) whereby 24 cents enters each respective pool.) By doing this method of fractional betting, it enables a player to enter every five bet type pools for an individual racetrack contest or race rather than making four individual wagers to enter four live bet type pools which involves four times the bet functions and four times the wager amount since most pools have a $1 minimum wager amount. Once the funds or wager dollars are divided among bet types, the race contestants can be chosen or selected by the quick pick rotator or a handicapping formula which may be third party or in the race providing system itself.

If the race contestants are chosen via the quick pick rotator the race contestants or race contestant combos whereby exotic wagers are chosen based on total wager amounts per race contestants or a combo of specific contestants were a combo of race contestants represents one betting interest or an individual race contestant represents one betting interest. The objective of the quick pick rotator is to produce equal betting dollars on each race contestant or combo of race contestants for each respective bet type pool. By using the quick pick rotator, a static paytable is created which is advantageous from a player standpoint since the prizes or payoffs do not fluctuate from when the pool is open to when the race event is declared official. The player can decide whether to hit or press the play function based on the static paytable above which is beneficial knowing that the price won't change. For example, in regular pari-mutuel wagering a race contestant can technically be in one example 20 to 1 “×” minimum before post time and 5 to 1 when the pool is closed which is a decrease of points or 75% decrease in payoff or prizes.

Another method of choosing a race contestant for a terminal that uses multiple bet types and fractional amounts or weighted amounts for each bet type is to choose the race contestants for each bet type by a handicapping formula and posting or displaying the selected race contestant for a future race on the paytable for a future or prospective player to see or analyze. If the player is satisfied with the race contestants chosen or the prizes or payoffs offered he might then choose the play function.

If the quick pick rotator or handicapping formula fails to choose the correct official race contestants or race contestant for a winning bet type or multiple bet types the fractional amount will be carried over into the next respective bet type pool. For example, if the quick pick rotator fails to allocate a winning superfecta combo to a specific dollar or fractional dollar amount, the respective dollar amount or fractional dollar amount will be carried over to the next superfecta bet type pool in the simulcast menu or the next superfecta pool for a specific track code. Pool carryovers can apply to all bet types.

The reason why the paytable for a pari-mutuel race contestant terminal can remain static is because, for example, if there are a hundred players playing a win machine (a machine that only offers win bets) and each player is using the fixed denomination buttons or icons on the touchscreen or machine keyboard such as in one embodiment $2, $5, $10, $20. The quick pick rotator will smooth out the money on each race contestant by adding the player's denomination to either a race contestant whereby in one example a player chooses $10 and the $10 denomination is added to #4 horse 100% or the $10 may be added to five race contestants whereby $2 is wagered on five different race contestants such as #2, #3,#5, #7, and #8. In an example where fractional betting is used, a player may choose a $1 denomination and 10 cents is added to each race contestant's individual win pool if there are 10 race contestants in the field. ($100÷10 race contestants=10 cents per race contestant). In another example, to smooth out pools even more evenly where race contestant #1 has $5, race contestant #2 has $4, race contestant #3 has $3 and race contestant #4 has $2 and race contestant #5 has $1 in its respective win pool. In order to even out this win pool $4 must be wagered on #5 to equal the same amount wagered on race contestant #1 (race contestant #5 has $1 and must add $4 to equal $5). Race contestant #4 must add $1 to equal $5. Race contestant #3 must add $2 to equal the maximum betting interest dollar amount of $5 which is race contestant $1 in this case. Race contestant $4 must add $3 to even the same betting dollars as #5. And, finally, race contestant #5 must add $4 to equally race contestants #1, #2, #3, #4, which would totally even out the respective win pool. Therefore, if a player hit a $9 denomination icon or button the denomination would be $4 on #5, $3 on #4, $2 on #3 and $1 on #2.

In summary, several different numbers of race contestants can be in an individual race event and various amounts of whole dollars or fractional dollar amounts can be applied to each race contestant to even out a bet type pool in order to have an equal amount on each contestant or whereby an equal amount is on each combo of race contestants whereby a combo of race contestants represents a single betting interest. For example, there may be 24,024 different combos in a superfecta where there are 14 race contestants (14×13×12×11=24,024) whereby in one example 4, 3, 10, 9 in the respective order represents one of the 24,024 different singular betting interests or superfecta combos. The main objective of the quick pick rotator is to keep the amount wagered on each race contestant or combo of race contestants representing one betting interest as even as possible, therefore, even when a respective player chooses a very low denomination such as 20 cents in one example, 2 cents could be added to each race contestant or 4 cents could be added to five different bet types such as win, place, show, exactor, triactor whereby in one example 1 cent could be added to four different betting interests in each of the five different bet types just mentioned. Even though in reality it would be difficult to have exact amounts of equal dollars on each race contestant for each bet type pool a static paytable may still be achieved because, for example, in a $1,000 win pool whereby there is $202 wagered on race contestant #3, the odds on race contestant #3 are still 5 to 1 due to rounding of betting dollars (1000÷202=4.95) or even if there were $198 on race contestant #3 (1000÷198=5.05) the odds would still be 5 to 1 due to rounding. Therefore, a static paytable may be achieved due to the leeway that enables a number to be rounded up or rounded down which is called pari-mutuel breakage. Whether the numbers are rounded up or down either to one or two digits to the right of the decimal place is determined state pari-mutuel legislation or state model rules on how the breakage is to be determined and who (government, H.B.P.A., charities, etc.) is to receive the breakage.

We have just mentioned that the quick pick rotator can place equal amounts on each race contestant to produce an equal payoff for each race contestant or combo of race contestants. An example of an equal amount on each combo of race contestants would be to have an equal amount wagered on 132 different exactor combos of a racetrack event whereby the race event had 12 race contestants (12 race contestants×11 race contestants =132 different exactor combos). However, the quick pick rotator can also establish fixed prices on the paytable by only choosing certain race contestants in a racetrack event and only allocating certain or specific amounts on each race contestant for that specific racetrack event. For example, if there are 10 race contestants and the quick pick rotator decides to only use two of the 10 race contestants whereby a total win betting pool of 1000 is established thereby producing $500 on each of the two race contestants causing a win odd of 500 to 1 for race contestant #1 and $500 for race contestant #2. Thereby, a prize of $500 can represent an icon or group of icons on the paytable by only showing race contestant #1 or race contestant #2 on the paytable or show race contestant #1 and race contestant #2 whereby each race contestant is represented by a group of icons or a specific icon on the paytable. If, for example, race contestant #1 or #2 do not win, the win bet type pool is carried over (in this case the win pool is a $1000) to the next race in the simulcast menu or the next race at a specific racetrack. Thereby if $1000 is put into the pool initially in one example and another 1000 is wagered, the quick pick rotator would use four different race contestants whereby the new win bet type pool of 2000 (1000 from the previous pool plus 1000 from wagers derived into the new pool) is divided by four race contestants in the new racetrack event (2000 new win pool÷4 race contestants=500 to 1 for each of the four race contestants). If one of the four race contestants wins, the players will spin a horse icon or group of horse icons or any type of icon or icons that represent or have a payout of $500 attached to them. If none of the four race contestants win, the win bet type pool would be carried over to the next race in the simulcast schedule or next specific race at a specific racetrack. If the win bet type pool gets too large for the number of race contestants (for example a 6000 win pool for only 10 race contestants whereby there is $600 (6000 total pool÷10 race contestants =$600 per race contestant) wagered on each race contestant which exceeds the 500 paytable amount which is bellyglass or a substrate that cannot fluctuate such as an L.C.D. panel (an L.C.D. is more expensive than a substrate such as bellyglass which may be used in one embodiment). In this situation, the carried over win bet type pool would be carried over to a new terminal that had a bellyglass payout of $600 versus a bellyglass payout of $500 from the terminal before or the 6000 win pool total would be leveraged against a certain race contestant or number of race contestants. For example, 500 would be placed on race contestant #1 and the rest of the race contestants or a race contestant would receive the balance of the win bet type pool (6000 total win pool−500 placed on race contestant #1=550 total pool balance) which is 5,500 whereby a player could not use the other race contestants thereby keeping the 5,500 betting pool intact. The 5,500 may also be carried over into a different bet type pool whereby in one example a bet type that required a player to choose 8 winners in a row over 8 respective races creating enormous odds and payouts due to the number of possibilities.

Also, in an embodiment the terminal or machine could standardize the paytable by using a color scheme of four colors since four positions (1^{st} place, 2^{nd} place, 3^{rd} place, 4^{th} place) determines all the bet type outcomes. (A superfecta is the first four positions to determine a winner versus win, which can only using the 1^{st} place horse etc.) For example, in one embodiment, red could represent the handicapping formulas 1^{st} pick or the quick pick rotators 1^{st} pick for all machines or an individual machine. Therefore, in order to win a win bet, two things must happen. First, the actual horse that the quick pick rotator or handicapping formula selected must actually win a live race event and second the red horse or red race contestant must appear on the payline whereby the win meter or credit meter goes up the amount that is on the respective paytable. Where red in one embodiment can represent the first place horse in any bet type that requires a first place horse such as a win, exactor, trifecta, superfecta requires a first place pick and first place result whereby this first place is only required in regards to win betting where the other bet types mentioned require additional placings. These additional placings (2^{nd}, 3^{rd}, and 4^{th}) can be color coded as well. For example, in one embodiment blue can represent second place, which can represent third place and green can represent a fourth place betting interest or finisher. Therefore, a superfecta wager can be represented as a red, blue, white, green colored icons on a paytable which represents the machine selections which are chosen via the quick pick rotator or a handicapping formula from a third party or built into the race providing system. Another example of a bet type representation on the paytable would be an exactor bet type represented by a red icon followed by a blue icon since only the first two finishers are required for an exactor bet type. As mentioned above these icons are represented on the paytable in regards to future payouts which can represent a “rebate” mode or the icons on the paytable can represent a winning result or losing result when the machine is in “result” mode. This color code scheme which represents any number of the first four finishers or whatever amount of finishers required for any bet type can also be represented on the payline in any order from “left to right” or “right to left” or interchangeably with other icons any order on the payline to represent winning results. One of the reasons for using a color scheme to represent winners or possible winners is that believe it or not is that people do not know in some instances whether they (players) won or lost after the race has been declared official because pari-mutuel race contestant wagering requires viewing a “tote board” where results are posted on a result screen on a T.V. set or display mechanism via satellite from the host track. Not only must the player find this respective tote board or result display, but also be able to read it which requires knowing bet type terminology which is usually abbreviated (For example, WPS for win/place/show) in order to save “real estate” on the display mechanism. Therefore a player can determine whether he won or not through matching system via a payline and paytable which are both on the same terminal.

Another possible way of creating static prizes on a paytable other than using the quick pick rotator to establish specific odds for two or more race contestants would e to use the race providing system odds information to choose a race contestant that had the same live real time odds as the graphics on the static paytable which is usually made of bellyglass like most slot machines use. For example, if the paytable said the exactor or icons representing an exactor pays $40, the processor would find the closest exactor or an exactor which exactly pays $40 and enter the $40 payoff wager into a live exactor bet type pool. The same could be done for all bet types whether the odds are “massaged” by the quick pick rotator or directly chosen via the odds information provided by a race providing system or a group of race providing systems working together to formulate real-time odds.

The quick pick rotator also has the ability to “lay off” carryover money on to horses that are not available to be chosen by the player since the race contestants where the money is being “layed off” on are not posted on the bellyglass or paytable and are not in the quick pick rotator rotation or in the handicapped formula of either a third party or in the race providing system race contestant selector. For example, if a win bet type pool exceeded $10 and there were 10 race contestants in the race whereby the paytable was showing win odds or icons representing win odds of 10 to 1 and the win pool total was $11, $2 would have to be layed off on a race contestant that is not part of the process where race contestants are chosen or selected via a quick pick rotator or handicapping formula. However, the layed off money from the carryover is still used to balance the pool or to balance the pool according to the static paytable. In the example above, the $2 that was layed off on an unavailable race contestant was derived initially from a carryover of a previous race where a winner was not chosen by the quick pick rotator or handicapping formula. The wagering terminal will not allocate “new” money or “live” money which is wagered for the first time by a player on to a “layed off” race contestant whereby the player has no chance at all because his money never was processed through the complete cycle of the race providing system. In other words, the players' money was just used to balance a pool. Once again, the layed off money only applies to carryover money where the race providing system or player failed to choose a winner.

If there is insufficient money in a particular bet type pool such as a superfecta pool. The bet type pool (in this case a superfecta pool) can be seeded from carryover money. If the superfecta bet type on the paytable is supposed to pay 10,000 on the static bellyglass or paytable and there is only 8,000 in the superfecta bet type pool, $2000 of “seed” money would be required. The seed money may be from a carryover of a previous race or the “seed” money may be funded by an out-of-pocket cost by racetrack management.

Another important aspect of the present technology is the ability to provide a static or fixed payment on a pari-mutuel table. This is important, even where the selection is being made by a handicapping automated function, as by the Quick-Pick rotator. This enables the same odds on a particular contestant in a particular race to maintained, even as other wagers are being placed into the pool. Because a private pool can be established, the odds can be artificially supported by spreading the wagers according to the wager distribution/handicapping algorithm. Pools may also be seeded for the individual pools (win, place, show, etc.), and there may be laying off of funds from other pools. Carryover money from that pool or other pools may be added to pools on each race and on each horse to support odds.

The pari-mutuel race contestant terminal that enables a player to enter two or more live bet type pools via a single play or enter function, by the splitting of wagers and by the selection of wagers on the same event (in the same or different pools) that distributes the wagers and provides a greater likelihood of at least some winning events. The pari-mutuel race contestant wagering terminal may divides wagering dollars or credits by the amount of bet types available. The pari-mutuel race contestant wagering terminal may enter fractional amounts into a live wagering pool. The pari-mutuel race contestant wagering terminal may allocate specific percentages of each wager, such as “×” percentage of each dollar, into every bet type pool that is offered by a specific racetrack event. The system may provide paytables that are static for only specific types of wagers, such as a paytable that is static for win and place and show wagers. The pari- mutuel race contestant wagering terminal may use fractional dollar amounts for numerous bet types at the same time, or that chooses horses for each available bet type per race event via a single play or enter function. The race event selector may choose multiple race contestants for multiple bet types at the same time for a specific racetrack event and may display chosen race contestants or handicapped race contestants for each bet type on a future race event paytable. Actual icons specifically relating to race contestant selections may be displayed on a paytable. The terminal may enter displayed race contestant selections into a live betting bet type pool when a player chooses the play function, with all wagering and play performed by the terminal and associated terminal. The system may carry over fractional dollar amounts to their respective pools. If there is insufficient money available for a wager on a first player wager, the wager or a portion of the wager may be carried over for a subsequent wager in the same or different pool. This can be done by carrying over fractional dollar amounts or dollars to the next respective or same bet types in the simulcast menu. In contrast, it is also possible to lay off carryover money onto a race contestant that is not chosen by a player or by laying off money onto unavailable race contestants in order to create a static paytable. The system may also enter layoff money into a bet type pool whereby a race contestant or group of race contestants are used to layoff the money but these respective race contestants are not used to produce bar-coded tickets for the betting public, but only terminal software racetrack management. To build up pools, the system may at times lay off wagers on horses that have only high odds. Carryover money may be used to “seed” bet type pools or carryover money may be used from a previous race to balance pools. A play or enter function may be provided that enters the same or different wagering amounts into two or more bet type pools. A Quick pick rotator may use different race contestants and add fractional wagering amounts to each race contestant or combo of race contestants representing one betting interest. The quick pick rotator may allocate fractional dollar amounts or whole dollar amounts in order to create equal amounts wagered on a race contestant or group of race contestants whereby one betting interest is represented. The static paytable may be designed so that it does not change from when a betting pool is declared open for a specific racetrack event to when the race is official for a specific racetrack event. The pari-mutuel race contestant terminal may provide losing icons on a payline which are not in the correct respective order or do not match the icons on respective paytables as the represented icons on the paytable. The system may carry over fractional dollar wagering amounts into future bet type pools which were associated with unsuccessful race contestants from a previous race. The processor may allocates each individual race contestant combo to an individual bet or individual wager where the dollars wagered or fractional dollars wagered are less or equal to in numeration than the race contestant combinations available. The system may allocate wagers into exotic wagers, spreading the risk and fractionalizing wagers. The displays in reel or image format may show individual winners or winning combinations in icon form. The paytable may also use rounded up payoffs or odds or rounded down payoffs or odds in order to create a static paytable or simplify payments to players. A paytable may establish fixed prizes via a quick pick rotator processor for a respective racetrack event from whence the bet type pool is open to when the bet type pool is declared official for that respective racetrack event. The system may enable using carryover pool money from a previous race whereby a winning race contestant or group of race contestants in the correct respective order were not selected correctly by an individual player, therefore, creating a “seeded” or “pre-funded” bet type pool for a future racetrack event. It is likely that in start-up modes or start-up location that a pre-funded or seeded bet type pool can be established. For example, a pre-funded or seeded pool may use “carry overed” funds to seed or pre-fund the respective bet type pool. To build up pools, as indicated earlier where wagers may be weighted towards high-odds contestants, a quick pick rotator may not necessarily use every race contestant in a racetrack event. A quick pick rotator may be used that does not allow a single or fractional dollar amount to be wagered on a race contestant or group of race contestants in order to increase the chance or possibility to produce a carryover. For building customer acceptance of the system, a standardized color scheme to represent the 1^{st} selection, 2^{nd} selection, 3^{nd} selection, 4^{th} selection and 5^{th} selection may be provided. For example, the HDW handicapped selections and winners are always in a specific color for the order of selection. This provides the player with a capability of comparing various handicapping quality. This can be done most easily in a private fund, rather than a commingled fund. A standardized color scheme may be used where at least the 1^{st} selection is standardized, where 1^{st} and 2^{nd} selection are standardized, where the 1^{st} selection, 2^{nd} selection, 3^{rd} selection are standardized, and/or where the 1^{st} selection, 2^{nd} selection, 3^{rd} selection, 4^{th} selection are standardized. The standardized color scheme for race contestant selections are presented on the paytable and presented on the respective payline when the selections represented by the standardized color scheme are winning race contestants for a bet type pool. The standardized color scheme may represent any number of race contestant selections from one race contestant to 30 race contestants. The pari-mutuel race contestant terminal may use groups of icons available in the slot user interface before the race and same icon of group of icons available in the slot user interface after the race to determine a result and may use the same group of themed icons in a specific terminal for each race in the simulcast program for a specific terminal. The pari-mutuel race contestant terminal can apply odds shopping or a financial return on investment analysis between two or more different race contestant selectors, e.g., by using the quick-pick rotator or selector and the handicapping formulae described herein or in the prior art. The algorithm provided may select between available formulae, using risk analysis, and specifically avoid negative or minus pools. The pari-mutuel race contestant terminal may not require pari-mutuel race event tickets that have track code, race number, bet type, amount of wager, race contestants, date. The pari-mutuel race contestant terminal can be designed to play via player's card only whereby the account card is debited and credited, or use a bill acceptor to load money onto a player card or account wagering card, whereby the terminal can then e-mail that the bank signaling that money is secure in the terminal, or can electronically transfer funds to a third party such as a bank, or use a bill acceptor to load money onto an account wagering card. It is not necessary, because of the pseudo video game play, for the race contestant betting network to show any tape recorded races or live races. The pari-mutuel race contestant network need not adopt any outside state or country pari-mutuel model rules or legislation adopting only the host state model rules and legislation and does not commingle bets from O.T.B. or racetrack outside its own state or country, and need not adopt any outside state minimum commingling wager amounts. The pari-mutuel race contestant betting network may be positioned at one race location and use race results only from its own track, only from other racetracks, or from a combination of the two. The pari-mutuel race contestant betting network may use only pool closing times and race results of other racetracks in order to conduct a multi racetrack simulcast betting network, and/or may divide whole dollar wagering amounts that enter a live bet type pool into fractional amounts when a user hits a fractional denomination icon or button on the respective terminal. The race event selector may select race contestants by how much money is wagered on a race track contestant or group of race contestants whereby a group of race contestants represents one betting interest. A standardized color code of race contestants selections or race result placings may be displayed which represents winning icons on a paytable or payline. The pari-mutuel race contestant terminal may enter a wager or multiple wagers into a bet type pool or several bet type pools and then displays continuous winning or losing results until all credits are played.

There are many additional functions that may be built into the operation of the system as options. The pari-mutuel race contestant wagering terminal may increase takeout as the wager amount decreases and decreases takeout when the wager amount increases.

It would be beneficial to have a pari-mutuel race contestant wagering terminal or race providing systems that increases takeout as the wager amount decreases and decreases takeout when the wagering amount increases. The reason being is that a player should be rewarded for entering more wagering dollars into live bet type pools and small wagers should have a higher takeout to cover the fixed costs of a pari-mutuel race contestant wagering operation. If fixed overhead and variable costs exceed racetrack or O.T.B.'s or pari-mutuel race contestant wagering hub wagering commissions, the respective facilities will lose money. The present system enables apparent slot machine hardware or software that does not use a random actuator to determine winning spins, but may or may not have random actuators that determine the rate or manner of payback to a player that has received a winning event. The slot machine may also function by taking a percentage of every dollar wagered, as is normally done in wagering pools. The pseudo slot machine may use rebate algorithms to determine payoffs and winning spins. The slot machine, hardware or software may use a pari-mutuel race contestant bet type or two or more pari-mutuel race contestant bet types to formulate a paytable. The pseudo slot machine, hardware or software may use one or more pari-mutuel race contestant bet type to reprint winning spins on a payline, and may show paylines with actual horseracing results, as by showing icons that identify the specific horses and their positions or winning associations in the race. The pseudo slot machine, hardware or software may use icons that represent live race contestants in a race track event, and may use color codes live race contestants based on total amount wagered on each race contestant in a video or mechanical slot wheel.

The system may also provide rebate money to an account wagering card that is in a pari-mutuel race contestant wagering terminal, use one or more rebate programs whereby prizes are added to an account wagering card that is inserted in the machine, simultaneously close a live comingled bet type pool and making a pari-mutuel race contestant paytable static, verifying winning icon or icons on a payline by using live race event bet type results, and verifying winning icons or an icon on a payline by algorithm rebate program. The pari-mutuel race contestant terminal does not have to show a player live race event bet type results in order to find out if the player won or lost. The function of terminals may be specifically designed to be able to only deduct a player's credit balance when the race is official. A rebate program may be provided whose prizes are equivalent to live pari-mutuel race contestant payoffs at a certain point in time. A user interface may be used that only changes credit balance when switched between modes when money inserted, preferably only when the system shifts from rebate to play mode. The pari-mutuel race contestant wagering terminal may switch modes as a response to when a live race event is declared official. The pari-mutuel race contestant wagering terminal may switch modes when the player inserts a monetary instrument into the machine or when a player credit balance equals zero, e.g., switching to the rebate mode. The system may display pre-selected race contestants on a paytable that were selected by a quick pick rotator. A hub or network may be established that sends each terminal up to “X” terminals depending on how many “X” race contestants in the racetrack event different pre-selected race contestants to the paytable and play or enter function. (For example, if there were five race contestants each terminal up to five terminals would receive different win selections via the quick pick rotator.) It is possible to show only the pre-selected race contestants on the paytable that were chosen by either a quick pick rotator or handicapping formula. It may also be a provision of the system to not display odds of race contestants that were not chosen by the quick pick rotator or a handicapping formula on the paytable of a pari-mutuel race contestant terminal. The pari-mutuel race contestant terminal may create or allocate funds from each wagering dollar or from certain wagering dollar entered into the terminal or rebate pool, and may allocate money to two or more different pools or rebate programs.

A major problem in simulcast wagering today where racetracks adopt the host tracks takeout rate in order to commingle betting pools is consolidation of racetracks. Since today's simulcast procedures are too cost prohibitive to bring in world wide race events whereby the satellite racing program and betting information in some instances must be double bounced at market rates of $500 an hour per simulcast signal thereby leaving not enough product certain times of the year at certain times of the day since a racetrack in North America, for example, can only use signals from its own continent. Some tracks or betting corporations seeing the need for racing product in order to cover “dead time” between races have tried to bring in more foreign product, however, these foreign separate pools do not have a large betting pool for each bet type pool and are subject to imbalanced payoffs or small payoffs because the pools cannot take a large wager. Some racetracks are even exposed to minus pools since the pari-mutuel betting laws may require a minimum of 5% return to the player and the broadcast fee which goes to the host track in one example may be 6% and 8% may contractually go to the horsemen's benevolent and protection programs (unions) and 1% may go to the host state's taxes in order to commingle and a state simulcast fee of 1% may go to non-host state government. This total (1%+1%+6%+8%=16% whereby the host track's commingling rate may only be 18% thereby only leaving 3% to the non-host racetrack where the player is actually physically playing. This 3% does not cover the minimum 5% minimum payoff required by the non-host simulcast track. If a player were to wager $100,000 successfully on the correct race contestant to win, for example, and there was only $100,000 in the win pool, the racetrack that is taking the broadcasted race in this situation would require to pay the $100,000 win bet type player 5,000 thereby losing $2,000 since the racetrack only made $3,000 (3%) in betting commissions after the legislative or contractual simulcast fees. These minus pools are happening more and more today due to increased broadcast fees by large racetrack consolidators that tend to bundle or package the simulcast product to other smaller individual racetracks that only have one racing simulcast signal to uplink to other racetracks. However, if a racetrack were to create its own separate betting pools whereby the simulcast track did not commingle betting pools or show the broadcast of the host track but only used pool closing times and official race results to conduct a multi-racetrack simulcast network thereby reduces network costs (betting information and video feed of the race are not required from the host track) and broadcast fees that the host track is charging thereby leaving more of every wagering dollar to the track that is simulcasting the racetrack event.

It would be ideal for a pari-mutuel race contestant terminal to have bet types where a player or race contestant selector must choose the first 5 or 6, or 7 or 8 or 9 or 10 or 11 or 12 or 13 or 14 or 15 or 16 or 17 or 18 or 19 or 20 or 21 or 22 or 23 or 24 or 25 or 26 or 27 or 28 or 29 or 30 race contestants in respective order.

A 5 race contestant winning selection would be represented by a five color standardized race contestant color scheme which would represent the first five selections from 1^{st} place to 5^{th} place would be represented by the entire middle line of icons on a 3×5 icon interface if the 5 selections were winning selections. A 6 race contestant winning selection would be represented by a six color standardized race contestant color, scheme which would represent the first six selections from 1^{st} place to 6^{th} place which would be represented by the entire middle line of a 3×6 icon interface if the six selections were winning selections. Any number of race contestants can be aligned on the payline whether vertically, horizontally or diagonally to show a winning icon or combo of icons that represent a rebate or live racing result.

In pari-mutuel race contestant wagering today it would be ideal to be able to wager multiple bet types or similar bet types that have the same wager amount or denomination value whereby the player only had to set a payline line meter to determine the amount of bet types and amount of different paylines. For example, if the player chose to set the payline meter to five on a pari-mutuel race contestant terminal, the user terminal interface would have five physical paylines whereby five bet types of the same dollar amount enter a live bet type pool or multiple live bet type pools. This is advantageous because it can eliminate many unnecessary bet type functions. For example, the five paylines on a wager in an embodiment may represent a win bet, place bet, trifecta bet, show bet and superfecta bet. Currently today pari-mutuel race contestant terminals would require the player to enter five bet type icons or buttons, five wager amount icons or buttons, five play or enter icons or buttons, five track code icons or buttons and five race contestant selections whereby the race contestants are selected manually for each bet type or the race contestants be selected by a random race contestant selector which can be called a “quick pick”. Therefore it would be nice to have the 20 or more icons that represent these functions mentioned above to be implemented by a payline meter function and a play function in conjunction with wagering amount icons which are pre-set to suit all five paylines or bet types. A player can enter a number to determine the paylines or use a scrolling function to determine the amount of paylines. The play button or enter button would choose the race contestants, bet type or bet types, enter the enter into a live bet type pool and possibly use the minimum denomination on the keyboard or user interface, if the player did not pre-set a specific wagering amount button or icon. A pari-mutuel race contestant payline meter can increase the minimum denomination button or wagering amount 2×, 3×, 4×, 5×, 6×, etc. and the maximum wagering or 2×, 3×, 4×, 5×, 6×, etc. or any wagering amount icon or button on the pari-mutuel race contestant terminal 2×, 3×, 4×, 5×, 6×, etc. without having hundreds of different individual wagering amount buttons or icons on the keyboard or user interface of the pari-mutuel race contestant wagering terminal. In other words, the terminal has more flexibility and capacity in regards to wagering amounts. The player can also enter more bet types on two or more of the same bet type as the payline meter is increased. By increasing the payline meter the total amount of bet types or bet type is increased thereby increasing the total wager amount or credits each time the play hits or touches the play function thereby increasing the total monetary dollars through a pari-mutuel race contestant wagering terminal. Also, the variety of bet types and individual amounts is increased. For example, a player may choose a 5 cent button or icon whereby the payline meter is 1× or 1 producing a 5 cent individual bet type wager or choose a $20 button or icon whereby the payline is set at 30 producing 30 individual bets using one or more bet types for a total dollar value of ($20×30 bet type=$600) $600. All this can be done without congesting or clogging up the user interface or keyboard with hundreds or more buttons or icons.

One of the problems with pari-mutuel race contestant wagering is that the majority of the wagers are done by cash payment or voucher payment whereby these monetary instruments cannot identify a player thereby racetrack management does not know the names or addresses or behavioral patterns of their players. If a customer has been attending your racetrack every day or four times a week for the last 10 years and you don't know their name, you have a problem.. Thereby it would be ideal to have player tracking and player bonusing to acknowledge or let your players know that you care about them. It would also be ideal to use pre-determined bet type or bet types that can be loaded up on a player card via magnetic stripe card or smart card or cash credits downloaded onto a player's card in a machine or debit or credit a player's card account. Different play patterns using different credit amounts as different bet types could be programmed in order to stimulate lay. For example, in an embodiment such a $5 pattern of wagers may be a $1 show bet type followed by a $1 place bet type, followed by a $1 win bet type, followed by a $1 exactor bet type and finally a $1 triactor bet type on a pre-determined bet type, wagering amount pattern may just have five respective show bets in order to increase the chances of a winning spin or ticket just to make the player feel like a winner.

A pari-mutuel race contestant player account may be able to receive downloaded credits or cash via a central server, or can download pre-determined bet types on a player card or account. A pre-determined bet type and wagering amount program that can be “loaded” onto a player's card. A pari-mutuel race contestant terminal may be provided that contains a payline meter with an indication of the number and types of paylines being played, such as win payline, place payline, show payline, trifecta payline, etc. The pari-mutuel race contestant terminal may be able to multiply dollar or wager amounts via a payline meter, or to multiply or decrease individual bet type or bet types via a payline meter. The system should be able to decrease the total wagering dollar or credits via a payline meter. The pari-mutuel race contestant wagering terminal may be able to receive credits or cash directly via the credit meter or win meter from an electronic file. The player may be provided with a player card that has pre-determined play pattern in regards to bet types and wagering amounts to assist the selection of available algorithms and styles of play. The system may provide a, pre-determined wager amount that can be set by touching or pressing an individual wager amount button or icon on a user interface or keyboard to represent all future bet types until set otherwise. It is also possible to use a pre-determined wagering amount for a future bet type until the pre-determined amount is changed or re-set to another wagering amount for all bet types until told otherwise. Pay lines need not be the standard linear left-to-right paylines, but may be diagonal pari- mutuel race contestant paylines, horizontal pari-mutuel race contestant paylines, vertical pari-mutuel race contestant payline, multidirectional paylines as can be found within 45 line payline video gaming systems, diagonal horizontal pari-mutuel race contestant paylines, and the like. The pari-mutuel race contestant may have a server/hub race providing system associated with the terminal that uses an algorithm to calculate dead time versus play time over the course of the simulcast menu. The pari-mutuel race contestant server/hub race providing system may be provided with a terminal that uses an algorithm to calculate player turnaround time. The pari-mutuel race contestant server/hub race providing system may be provided with a terminal that uses an algorithm to calculate the total amount of dead time between events. The pari-mutuel race contestant server/hub race providing system may be provided with a terminal that uses an algorithm to calculate average capital wagering or average wagers per player. The pari-mutuel race contestant server/hub race providing system may be provided with a terminal that uses an algorithm to calculate play time versus total player attendance. The pari-mutuel race contestant server/hub race providing system may be provided with a terminal 1 that uses an algorithm to calculate result mode versus rebate mode. The pari-mutuel race contestant server/hub race providing system may be provided with a terminal that uses an algorithm to calculate takeout rate when comparing play time and dead time between races. The pari-mutuel race contestant server/hub race providing system may be provided with a terminal that uses an algorithm to calculate takeout rate when comparing attendance versus play time. The pari-mutuel race contestant server/hub race providing system may be provided with a terminal or network that uses variable takeout rates on an “X” time by “X” time basis for all bet types and “X” or greater amount of terminals. The system may be provided with hardware and/or software acting as a fractional denomination processor that divides whole dollar minimum commingling amounts so the player can play fractional amounts but still comply to minimum state commingling requirements. The fractional denomination processor may divide minimum amounts or larger amounts into minimum or grater commingling wager amounts but does not directly enter wagers into a race providing system or totalizator system. The terminal may be provided with a credit balance meter that can deduct fractional wagering amounts. The pari-mutuel race contestant terminal may not give only cash vouchers, but instead may add credits directly to the players win meter or credit meter if the respective bet was a winner.

The most popular forms of gaming in terms of revenues and the amount of individual play are lotteries and slot machines. Granted, lotteries have a great distribution system (variety stores, etc.), but they still generate enormous handle, as is exemplified by such lottery companies as the multistate Powerball™ lottery. In Pennsylvania there are 24 off-track betting sites and both telephone-account wagering and internet wagering which provides even greater distribution than the state lotteries. Yet, comparing Pennsylvania race contestant pari-mutuel handle to the state lottery handle, the pari-mutuel handle is significantly smaller. This situation exists because betting terminology is not required with the state lottery; it is only a numbers game. For example, keying two horses and wheeling two horses is equivalent to 24 superfecta combos. A lottery player just asks for a “24 number combo” whereas a pari-mutuel race contestant player must hot only identify race contestant numbers, but also tell a teller or self serve betting machine where to place the race contestant numbers in bet type form such as superfecta and bet type within a bet type lingo such as key #4 and #2 for 1^{st} and 2^{nd} and wheel #3 and #10 for the third and fourth positions respectively. Not only must the player identify the bet type (e.g., Superfecta), bet type within a bet type (key and wheel), but also must identify the race contestants for the bet type and place the race contestants within the bet type by using bet type within a bet type terminology (e.g., Key #4 for 1^{st} and wheel #3 for third and fourth, etc.)

Therefore, it would be ideal to have a pari-mutuel race contestant wagering terminal or pari-mutuel race contestant website that required no understanding of complex betting terminology, yet would enable complex wagering for both novice and expert players. For example, the pari-mutuel race contestant player could instruct a teller for 10 combos or quick picks just as a lottery player would instruct a variety store clerk for 10 randomly selected quick picks. This pari-mutuel race contestant lottery type platform could be achieved by using several processors and or/and results boards and or/and ticket formats. The processors required would be a bet type processor (which would decide the bet type for the player) and denomination processor (which would decide how to use the money when using a bet type within a bet type and the denomination if not chosen by the player), and a race event selector (the race event selector would select a specific race track event) and a race contestant selector (which would select race contestants) and a play or enter function (which would authorize the wager and then tell the race providing system to print the ticket). All these functions or processors would work in conjunction with a race providing system or known as a totalizator system such as Amtote, Inc. Once the wager or race contestant quick pick has been entered into a race providing system along with a printed and/or formatted ticket that corresponds to a and/or result board.

An “and/or” ticket has only the name of the track, race number and race positions indicated on it. Additionally, race contestant numbers may be under the corresponding race position number. For example, if the player or race contestant selector selected #4 to win on race #3 at Philadelphia Park, a #4 would be under the 1^{st} column only. If race contestant #4 were bet to place, a #4 would be in the 1^{st} column and the 2^{nd} column since #4 in order to win money could finish 2^{nd} or 1^{st} to win money. If #8 were bet to show, a #8 would be in the 1^{st}, 2^{nd}, 3^{rd} column, since 8 could run in 3^{rd}, 2^{nd} or 1^{st} to win on a show bet. All place/show wagers would use the word “or” in between the 1^{st}, 2^{nd}, 3^{rd} columns depending on the bet types. For example, a place bet would be for race contestant #4 1^{st} or 2^{nd}.

#4 #4

A show bet would be 1^{st} or 2^{nd} or 3^{rd}. All exotic wagers such as exactor, triactor and superfecta

#4 #4 #4

would use the word and in between the 1^{st}, 2^{nd}, 3^{rd}, 4^{th} columns depending on the bet type. For example, an exactor bet would only require an “and” in between the 1st and 2^{nd} column (e.g., 1^{st} and 2^{nd}) whereby a

#4 #3

triactor would require an “and” between the 1^{st}, 2^{nd}, 3^{rd} columns respectively. For example, 1^{st} and 2^{nd} and 3^{rd}. A superfecta would require an “and’ between 1^{st}, 2^{nd}, 3^{rd}, 4^{th} columns. For example, 1^{st} and 2^{nd} and 3^{rd} and 4^{th}. The reason for using “and” is boolean logic

#4 #3 #2 #10

because, in order to win an exotic wager such as a triactor, exactor or superfecta, every race contestant is contingent upon another race contestant. For example #4 must win and #3 must finish second and #2 must finish 3^{rd} and #10 must finish fourth in one example in order to win money. The use of “or” in place and show wagering pertains to Boolean logic as well. For example, to represent a place bet by placing race contestant #4 under the 1^{st} column or under the 2^{nd} column says that #4 could finish 1^{st} or 2^{nd} to win money. To represent race contestant #4 in a show bet, the ticket format would be placing #4 under the 1^{st} or 2^{nd} or 3^{rd} columns respectively. Therefore #4 could finish 1^{st} or 2^{nd} or 3^{rd} to win money. And/or result boards are used in conjunction with and/or ticket formatting. And and/or result board is exactly the same as an and/or ticket but uses a pay column to the right of the and/or ticket format. By having the and/or tickets in the same format as the and/or result boards it causes less confusion or less of a learning curve for the player. In pari-mutuel race contestant wagering today a ticket is different from a result board or graphic table (a result graphic table on a TV set is usually used to show payoff and results in simulcasting). For example, a triactor ticket be Fairgrounds triactor race 3 key 2 for 1^{st} and wheel #4 and #5 with a result board showing the following:

FG.R3 tri2,4,5 pags $1,280.00

In other words, tickets and result boards are not congruent enough thereby causing a high learning curve for the player.

This type of system enables a pari-mutuel race contestant result board that uses no betting terminology, and may describe events in more readily understandable Boolean terms or common terminology, such as first second or third. The ticket may also be provided in such language, without conventional betting terminology. The pari-mutuel race contestant ticket may use race position columns to align race contestant selections, and the pari-mutuel race contestant result board may use race position columns to align race contestant results. For example, the pari-mutuel race contestant ticket may use Boolean logic via the “and” symbol to determine exotic wagers, or even use Boolean logic on the ticket or board via the “and” and/or “or” symbol to determine place and show wagers. The pari-mutuel race contestant result board that uses Boolean logic via the “and” symbol to display winning exotic wager results. The pari-mutuel race contestant result board may use Boolean logic via the “or” symbol to represent winning place/show wager results. The pari-mutuel race contestant terminal may also provide and/or read tickets with no betting pari-mutuel race contestant terminology on the ticket, and the pari-mutuel race contestant terminal may use no betting terminology and may use two or more bet types that are determined by a random bet selector or a handicapped bet type selector. The pari-mutuel race contestant terminal may use no conventional betting terminology and use only one bet type per machine. The pari-mutuel race contestant wagering terminal may have a denomination selector processing which can select between two or more bet types within a bet type that have the same cost. As with earlier described hardware, software and terminals, the pari-mutuel race contestant wagering terminal that automatically selects race contestants, bet type, bet type within a bet type, race event, denomination amount, bet type within a bet type when some denomination amounts are the same and may use tickets with no bet type terminology. The pari-mutuel race contestant ticket may use no betting terminology and uses “or” Boolean logic for tickets that represent place/show wagers. The pari-mutuel race contestant ticket may be provided without any betting terminology thereon and use Boolean logic via the “and” symbol for exotic wagers, which may be portrayed on the tucket.

What is claimed:

1. A wagering account set-up facility to register with and/or communicate with a wagering account holder, the facility comprising:
a display that identifies capability to accept one or more information requests to establish a wagering account;
a reader to read a wagering account application;
a user interface to capture a an identification source of a holder of the wagering account and to capture input from the user in response to the one or more information requests on the display; and
a processor to process a) the wagering account holder's identification source, b) the input, c) where an application has been submitted to the reader, information from the wagering account form, and d) set-up the wagering account.

2. The wagering account set-up facility of claim 1, wherein the facility is a kiosk further comprising a wagering card dispenser to issue a wagering card on the set-up wagering account.

3. The wagering account set-up facility of claim 1, further comprising a card reader to read a card that enables at least one interaction selected from the group consisting of identifying a wagering account holder; and read a card that can deposit value into the wagering account.

4. The wagering account set-up facility of claim 1, further comprising a connection to a credit database to validate set-up of the wagering account.

5. The wagering account set-up facility of claim 1, wherein the processor instructs a wagering account set-up confirmation to be sent to the wagering account holder.

6. A wagering terminal in communication with a race providing system that facilitates wagering on race events and provides information regarding the race events, the terminal comprising:
a display to present information regarding selected race events;
a user interface enabling a user to place a wager on an elected race event of automatically processor-selected race events displayed or on a single automatically processor-selected race event;
a card reader to receive a card having information pertaining to a user account and to enable identification of available wager amounts for wagers on the elected race event;
at least one currency receiver or credit receiver to receive currency or credit, respectively,
wherein currency or credit provided to the currency receiver or credit receiver may be deposited to the user account.

7. The wagering terminal of claim 6, comprising a currency dispensing device to dispense currency and wherein currency dispensed is withdrawn from the user account.

8. The wagering terminal of claim 6, further comprising digital communication access to a race event selector to select race events, wherein the selected race events are next race events for wagering.

9. A wagering terminal in communication with a race providing system that facilitates wagering on race events and provides information regarding the race events, comprising:
a race event selector to select next race events for wagering, the race event selector using an algorithm to select next race events by analyzing one or more factors selected from the group consisting of estimated start of race event; estimated duration of race event; nature of the race event; actual start of the race event as affected by delays, and playability;
a display to display information regarding the selected race events;
a user interface by which a user may place a wager on an elected race event of the selected race events displayed or a single race event selected; and
a wagering value selector to select a wager amount for the wager on the elected race event.

10. The wagering terminal of claim 9, wherein at least two of the factors are weighted and can be adjusted automatically to configure selection of the next race event.

11. The wagering terminal of claim 9 wherein the wagering value selector enables either player selection of wagering amounts or automatic selection of wager amounts.

12. A wagering terminal in communication with a race providing system that facilitates wagering on race events and provides information regarding the race events, comprising:
a display to present information regarding selected race events, the information including race contestant wagering information displayed according to a profile of a user of the wagering terminal;
a user interface enabling placement of a wager on an elected race event of the selected race events displayed or a single race event selected; and
a wagering value selector to provide a wager amount for the wager on the elected race event.

13. The wagering terminal of claim 12, wherein the profile is a risk/reward profile and there is a manual control on the wagering terminal through which a user may select a profile.

14. The wagering terminal of claim 12, wherein the race contestant wagering information is generated from matching handicapping data showing estimated probability of race contestants finishing in specific positions against current odds to find wagering opportunities according to at least one algorithm using the handicapping data and the current odds.

15. The wagering terminal of claim 12, wherein the user interface displays icons corresponding to race contestants in a race event and a color or other indicator of the icons represents the race contestant wagering information.

16. The wagering terminal of claim 12, wherein the race contestant wagering information comprises at least one of a specific wager, a race contestant selection and a wager amount in accordance with the user profile.

17. A wagering terminal in communication with one or more race providing systems that facilitates wagering on race events and provides information regarding the race events, the wagering terminal comprising:
a display to present information regarding selected race events;
a user interface to place a wager on an elected race event of the selected race events displayed;
a wagering value identifier to provide a wager amount for the wager on the elected race event; and
a portable module providing a library of at least two protocols for accessing different API's for different tote-providers to support interoperability of the wagering terminal with more than one race providing systems.

18. The wagering terminal of claim 17, wherein the module defines an application programming interface for the wagering facilitated by the wagering terminal and an application programming interface for networking services of the race providing systems.

19. The wagering terminal of claim 17, wherein the portable module is adapted to accept one or more plug-in modules, each defining the interoperability to a specific race providing system.

20. A wagering terminal in communication with a race providing system that a) facilitates wagering on race events and b) provides information regarding the race events, comprising:
a display to present information regarding selected race events;
a processor in communication with the wagering terminal;
a user interface to place a wager on an elected race event of the selected race events displayed; and
a wagering value mechanism to provide a wager amount for the wager on the elected race event,
wherein software executed by the processor requires a user identifier to be provided in association with the wager to limit access to wagering or credit accounts so as to protect the identity of a user that made the wager when winning wagers are disclosed.

21. The wagering terminal of claim 20, wherein, if the wager was a winning wager, a results board displays the user identifier associated with the wager.

22. The wagering terminal of claim 21, wherein, if the wager was a winning wager, a results board displays a winning amount associated with the wager.

23. The wagering terminal of claim 20, wherein, if the wager was a winning wager, an audio signal is activated at the end of a selected race event when a winning wagers has been played on the wagering terminal and an amount of money has been won on the wagering terminal.

24. A user interface for a wagering terminal, comprising:
a spinning reel animation;
selection system for selecting at least one race location and at least one contestant in a race event;
communicative connection to a race information provider that carries information of the at least one race contestant selected to the race information provider to enter a wager on the at least one selected contestant on a wager in the race event;
and
when the spinning reel animation is completed, a screen presenting identification of the at least one race contestant in the race event selected for a wager.

25. The user interface of claim 24, wherein the one or more race contestants comprise one or more quick pick race contestants automatically selected on at least the basis of handicapping data.

26. The user interface of claim 24, wherein the one or more race contestants comprise one or more quick pick race contestants in which quick pick selection is based on handicap data and odds data.

27. A wagering terminal in communication with a race providing system that * facilitates wagering on race events and provides information regarding the race events, comprising:
a display to display information regarding selected race events;
a user interface to place a wager on an elected race event of the selected race events displayed;
a wagering value mechanism to indicate a wager amount for the wager on the elected race event; and
a wagering processor to automatically provide one or more bonus picks in association with the wager.

28. The wagering terminal of claim 27 wherein the wagering processor provides bonus picks when a wager results in a predetermined event.

29. The wagering terminal of claim 28 wherein the predetermined event comprises a payout equal to or in excess of a predetermined amount.

30. The wagering terminal of claim 27, wherein the bonus pick is an automatic selection of a race contestant from remaining race contestants in a race event not included in the wager or other bonus picks.

31. The wagering terminal of claim 30, wherein the selection of the race contestant for the bonus pick is random.

32. The wagering terminal of claim 27, wherein a pool out of which the bonus prize(s) for a winning bonus pick(s) is paid out is funded by one or more of: a set-aside of a percentage of wagering handle; an additional contribution by one or more race event tracks and a wager surcharge.

33. The wagering terminal of claim 29, wherein the pool is underwritten by an insurance policy to ensure that a bonus prize can be paid.

34. The wagering terminal of claim 29, wherein a payout of a bonus prize for a winning bonus pick is determined by one or more of a size of the entire bonus pool; straight odds of winning the bonus pick; an effective payout or odds of winning the wager; an actuarial determination of the bonus prize; and a pari-mutuel determination with a jackpot and reserve similar to a lottery system.

35. The wagering terminal of claim 34, wherein a separate ticket is issued from a ticket for the wager, the separate ticket incorporating details of the wager and providing the one or more bonus picks.

36. The wagering terminal of claim 35, wherein the separate ticket is provided with a bar code to track and facilitate payout of a bonus prize for a winning bonus pick.

37. The wagering terminal of claim 34, wherein the one or more bonus picks are provided on a same ticket of the wager in association with which the one or more bonus picks are provided.

38. The wagering terminal of claim 34, wherein a time for display of the audio or video of a next race event is determined by estimating a run time of the next race event and adding extra time for delayed starts and slow race events.

39. A method of placing a wager on a race event comprising a player accessing a wagering system, the player authorizing a wager to be placed, the wagering system automatically selecting at least one race location and race event upon which a wager may be placed, and a wager on the automatically selected race location and race event being placed through the wagering system.

40. The method of claim 39 wherein the wagering system automatically selects a wagering format on the selected race location and race event.

41. The method of claim 39 wherein the player selects a wagering format on the wagering system.

42. The method of claims 40 or 41 wherein the wagering systems selects a race contestant for a wager based at least in part upon handicapping principles.

43. The method claim of claim 42 wherein the handicapping principles include at least two factors selected from the group consisting of handicapping parameters and/or tote odds or wager odds.

44. The method of claim 39 wherein the race location and race location as automatically selected by the wagering system by considering sufficiency of time until running of the race event enabling at least a minimum amount of time within which a wager can be placed.

45. The method of claim 39 wherein the race location and race location as automatically selected by the wagering system by considering sufficiency of a range of time until running of the race event enabling at least a minimum amount of time within which a wager can be placed.

46. The method of claim 39 wherein the race location and race location as automatically selected by the wagering system by considering sufficiency of a range of time until running of the race event enabling at least a minimum amount of time within which a wager can be placed and a maximum amount of time so that wagering rates can be maintained at a frequency level.

47. The method of claim 39 wherein a user accesses the wagering system through a user betting interface.

48. The method of claim 39 wherein information concerning race track codes of selected race locations are displayed to a user.

49. The method of claim 47 wherein information concerning race track codes of selected race locations are displayed to a user.

50. The method of claim 39 wherein a user inputs partial selection information on a wager and the wagering system completes the selection information to place a wager.

51. The method of claims 39, 40, 44, 45, 46, 47, 48, 49 or 50 wherein a wager is placed through the wagering system into a pari-mutuel pool at the race location.

52. The method of claim 43 wherein a wager is placed through the wagering system into a pari-mutuel pool at the race location.

53. The method of claim 48 wherein race and track codes are combined with a race event selector and are displayed to the user.

54. The method of claim 39 wherein when an award occurs that exceeds a predetermined amount or exceeds a predetermined odds, a first bonus wager on a race event is awarded to the player, the bonus wager being automatically selected by the wagering system.

55. The method of claim 39 wherein if the player wins the first bonus wager, a second bonus wager is automatically selected by the wagering system for the player.

56. The method of claim 55 wherein if the player wins the second bonus wager, a third bonus wager is automatically selected by the wagering system for the player.

57. The method of claim 55 wherein if a predetermined number of consecutive bonus wagers are won by the player, a jackpot is awarded to the player.

58. The wagering terminal of claim 9 having communication with a wager amount/bet type selector that calculates the wager amount for a particular bet type and displays the amount calculated and bet type on a user icon or button on the user interface.

59. The wagering terminal of claim 9 wherein a user interface icon or button enables selection pf a combination wager amount/bet type within a bet type selector that chooses bet type and race contestants.

60. The wagering terminal of claim 9 wherein a quick pick rotator function is in the wagering system that rotates race contestants on the basis of placing a same dollar amount on each respective race contestant.

61. The wagering terminal of claim 9 wherein a quick pick rotator function is in the wagering system that tries to even out amounts of wagering dollars wagered on each race contestant.

62. The wagering terminal of claim 9 wherein a quick pick rotator function is in the wagering system that is programmed to choose at least some less desirable race contestants which have high odds or low speed ratings.

63. The wagering terminal of claim 9 wherein a quick pick rotator function is in the wagering system that operates in a separate betting pool from the race location pool.

64. The wagering terminal of claim 9 wherein a quick pick rotator function is in the wagering system that operates in a separate betting pool that does not commingle with any third parties or commingle with any outside race providing system and operates in conjunction with the quick pick rotator.

65. A private pari-mutuel betting pool network that has a separate pool for each racetrack, race and bet type.

66. The paramutuel betting pool network of claim 65 that has a program to effect a quick pick rotator that attempts to have approximately equal amounts of money wagered on each race contestant.

67. The private pari-mutuel separate pool betting network of claim 65 that has only one minimum wagering amount.

68. The private pari-mutuel separate pool betting network of claim 65 that has only one standard takeout rate for each bet type.

69. The private pari-mutuel separate pool betting network of claim 65 that has only one simulcast menu of specific racetrack events.
